(19) United States
(12) Patent Application Publication
(10) Pub. No.: US 2023/0348659 A1
(43) Pub. Date: Nov. 2, 2023

(54) BRANCHED AND HYPERBRANCHED IONOMERIC POLYMERS AND USES THEREOF

(71) Applicant: Simon Fraser University, Burnaby (CA)

(72) Inventors: Michael Adamski, Burnaby (CA); Emmanuel Balogun, Burnaby (CA); Simon Cassegrain, Burnaby (CA); Peter Mardle, Burnaby (CA); Steven Holdcroft, Burnaby (CA)

(73) Assignee: Simon Fraser University, Burnaby (CA)

(21) Appl. No.: 18/296,343

(22) Filed: Apr. 5, 2023

Related U.S. Application Data
(60) Provisional application No. 63/327,479, filed on Apr. 5, 2022.

(51) Int. Cl. C08G 61/10; C09D 165/02; B01J 39/19; H01M 8/1039; H01M 4/92; H01M 8/1004

(52) U.S. Cl. CPC C08G 61/10; C09D 165/02; B01J 39/19; H01M 8/1039; H01M 4/926; H01M 8/1004; H01M 2008/1095

(57) ABSTRACT

Described herein are branched and hyperbranched anionic phenylene polymers, produced with controlled incorporation of anionic substituents. Applications of such branched ionomeric polymers are also described herein. The branched ionomeric polymers are prepared by a convenient and well-controlled method, permitting tailored properties of catalyst ink formulations, ionomeric polymer membranes, and other applications. Such branched ionomeric polymers have applications in water purification, fuel cells, and battery products.

### CROSS-REFERENCE TO RELATED APPLICATION

This application claims the benefit of U.S. Provisional Application No. 63/327,479, filed on Apr. 5, 2022, the contents of which are hereby expressly incorporated by reference in their entirety.

### BACKGROUND

Hydrocarbon-based proton exchange membranes (PEMs) and ionomers, intended for electrochemical applications (e.g., fuel cells, electrolyzers, and water treatment), are actively sought after as alternatives to traditional perfluorosulfonic acid (PFSA) ionomers due to their ease of synthesis, low cost, low gas crossover, high T_{g}, and fewer environmental concerns.

Many different ion-containing polymers have been investigated, with significant focus on those incorporating aromatic groups in the polymer main chain, such as sulfonated derivatives of poly(arylene ether)s, poly(arylene ether ketone)s, poly(arylene sulfone)s, poly(imide)s and poly(benzimidazole)s. However, hydrocarbon-based ionomers to date are often inhibited by a greater sensitivity to oxidative degradation either ex situ (e.g., Fenton's Reagent test) and/or in situ (e.g., in PEM fuel cells). Recent attention has therefore focused on the rational design of hydrocarbon ionomers with enhanced chemical and mechanical stabilities.

Polyphenylenes, such as those reported by Stille and Mullen, have inherent chemical stability and mechanical strength. Sulfonated phenylated polyphenylenes (sPPPs) have been of particular interest as PEMs due to the inherent chemical and mechanical stability of a fully aromatic backbone. Sulfonated polyphenylenes are typically prepared by post-sulfonation of polyphenylenes and have recently been examined for use in proton exchange membrane fuel cells (PEMFCs).

However, work in this area has been limited by the challenge of synthesizing well-defined polymer backbones composed of sterically-encumbered, rigid, aryl-aryl linkages, having controllable sulfonation, and exhibiting high molecular weight. An additional challenge includes limited solubility in polar solvents. Functionalization (e.g., sulfonation) of polyphenylenes results in irregular distribution of functional groups among monomeric units and throughout the macroscopic polymeric structure, and consequently produces structurally ill-defined polymers (see, e.g., Fujimoto, C. H.; Hickner, M. A.; Cornelius, C. J.; Loy, D. A. Macromolecules 2005, 38, 5010).

Precise control of the polymer structure and accurate placement of ionic functionality along the polymer backbone can enhance short- and long-range order of ionic channels and thus ionic conductivity. Polymer properties can be tailored by the controlled incorporation, placement, and arrangement of sulfonic acid groups in a polymer. Such arrangement is impacted by the polymer backbone structure itself, wherein such structures can be linear, branched, hyperbranched, or have some other higher-order structure. Such polymeric structures and their consequent properties impact the use of such polymers in end-use applications.

Hydrogen-related fuel cell technologies are targeted for green and sustainable energy systems. Among the different types of fuel cells, proton exchange membrane fuel cells are considered economically viable, but manufacturing and capital costs remain high. For example, a Membrane-Electrode-Assembly (MEA) constitutes up to 50% of the capital cost of a PEMFC stack, of which >80% is associated with the precious group metal (PGM) catalysts employed. Great effort is therefore made in reducing the PGM content, although progress has been slowed by increases in mass transport resistance strongly dependent on the morphology of a catalyst layer (CL).

Fuel cell catalyst layers are commonly prepared from catalyst inks. Within a catalyst ink, Pt-supported carbon catalyst particles coalesce into agglomerates which aggregate into larger aggregates and form larger secondary pores. Such secondary pores facilitate diffusion of gases and transport of water within the CL, as described by agglomerate models. Polyelectrolytes, such as perfluorosulfonic acid (PFSA) ionomers, typically referred to by the trademarks Nafion® or Aquivion©, can be included in an ink dispersion to encapsulate and bind the Pt/C agglomerates, providing proton conductive pathways within the CL. The content and type of ionomer within a catalyst ink can greatly influence the mass transport resistance in a resulting CL.

Significant drawbacks to use of PFSA ionomers exist. Despite intense research surrounding PFSA ionomers, there are growing concerns over the use of potentially hazardous chemical feedstocks. Additionally, the complex synthesis of PFSA ionomers limits production because very few chemical manufacturing companies having the capability to produce such PFSA ionomers, adding to their expense. Further, the 2030 target of operating PEMFCs at an elevated 120° C. temperature may be limited by the relatively low thermal transitions of PFSAs of about 100° C.

To address the shortcomings of PFSA-based ionomers, thermochemically stable fluorine-free hydrocarbon ionomers are needed. Characteristic poor electrochemical kinetics, high ionic resistance, and high mass transport resistance within a catalyst layer are chief among parameters that cause poor performance of proton exchange membrane fuel cells (PEMFCs) which utilize hydrocarbon-based proton-conducting ionomers. In addition, strategies for the controlled synthesis of oligophenylenes and polymers, comprising controlled incorporation, position, and frequency of anionic (e.g., sulfonated) functionality in such fluorine-free hydrocarbon ionomers are needed. The present disclosure seeks to fulfill these needs, and provides further advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a branched ionomeric polymer comprising an anionic comonomer and a branching comonomer. Such branched ionomeric polymers comprise a repeating unit of Formula (I):

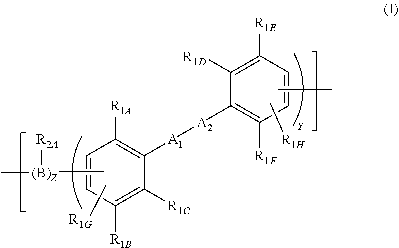

wherein:
R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation;
A₁ is arylene, heteroarylene, aralkylene, or heteroaralkylene, each optionally substituted with 1, 2, 3, or 4 substituents independently selected from halo, nitro, cyano, aryl, and heteroaryl; and
A₂ is absent, arylene, or heteroarylene, wherein said arylene and heteroarylene are each optionally substituted with 1, 2, 3, or 4 substituents independently selected from halo, nitro, cyano, aryl, and heteroaryl;
B is a branching comonomer;
R_{2A} is a bond; and
wherein a first repeating unit of Formula (I) is bound to a second repeating unit of Formula (I) at R_{2A} to form a branched structure.

The branching comonomer (B) can comprise Formula (II):

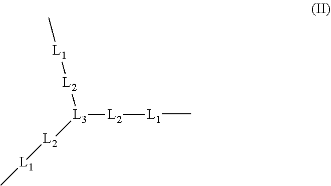

wherein:
L₃, at each occurrence, is an optionally substituted multivalent heteroatom (e.g., N, P, B), multivalent aryl, multivalent heteroaryl, multivalent aralkyl, or multivalent heteroaralkyl, wherein said multivalent aryl, multivalent heteroaryl, multivalent aralkyl, and multivalent heteroaralkyl are each optionally substituted with 1, 2, or 3 substituents independently selected from C₁₋₆ alkyl, halo, nitro, cyano, aryl, and heteroaryl;
L₂ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl; and
L₁ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl.

The present disclosure additionally features a method of making the branched ionomeric polymer of the present disclosure.

In another aspect, the present disclosure features a catalyst ink formulation comprising the branched ionomeric polymer of the present disclosure.

In a further aspect, the present disclosure features an ionic polymer membrane comprising the branched ionomeric polymer of the present disclosure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows the 3D representation of the chemical structure of HB-sPPT-H⁺;

FIG. 1B shows an example of HB-sPPT-H⁺ (a hyperbranched ionomeric polymer) observable by optical microscopy with a UV filter, before mechanical grinding,

FIG. 1C shows an example of HB-sPPT-H⁺ observable by optical microscopy with a UV filter, after mechanical grinding;

FIG. 1D shows the measured water absorption characteristics of HB-sPPT-H⁺ and linear sPPB-H⁺ polymers at 80±0.5° C.;

FIG. 1E shows an image of HB-sPPT-H⁺ in water;

FIG. 1F shows the chemical structure of the hyperbranched sulfonated, phenylated-poly(phenylene) terphenyl (HB-sPPT-H⁺) used as the catalyst layer binder;

FIG. 2A shows the polarization and power curves of CCMs prepared using catalyst layers comprising 15 wt % linear sPPB-H⁺, 5 wt % HB-sPPT-H⁺+10 wt % linear sPPB-H⁺, 7.5 wt % HB-sPPT-H⁺+7.5 wt % linear sPPB-H⁺, and 10 wt % HB-sPPT-H⁺+5 wt % linear sPPB-H⁺, with data obtained at 80° C., 100% RH, and 1 atm pressure, at H₂/O₂ operation; and

FIG. 2B shows the polarization and power curves of CCMs prepared using catalyst layers comprising 15 wt % linear sPPB-H⁺, 5 wt % HB-sPPT-H⁺+10 wt % linear sPPB-H⁺, 7.5 wt % HB-sPPT-H⁺+7.5 wt % linear sPPB-H⁺, and 10 wt % HB-sPPT-H⁺+5 wt % linear sPPB-H⁺. Data were obtained at 80° C., 100% RH, 1 atm pressure, at H₂/air operation with membrane thickness: 35±5 μm (sPPB-H⁺);

FIG. 3A shows polarization and power curves of CCMs prepared using catalyst layers comprising 30 wt % Nafion®, 25 wt % HB+5 wt % Nafion®, 20 wt % HB+10 wt % Nafion®, 15 wt % HB+15 wt % Nafion®, 10 wt % HB+20 wt % Nafion® and 5 wt % HB+25 wt % Nafion®, with data obtained at 80° C., 100% RH, 1 atm pressure, and H₂/O₂ operation;

FIG. 3B shows polarization and power curves of CCMs prepared using catalyst layers comprising 30 wt % Nafion®, 25 wt % HB+5 wt % Nafion®, 20 wt % HB+10 wt % Nafion®, 15 wt % HB+15 wt % Nafion®, 10 wt % HB+20 wt % Nafion® and 5 wt % HB+25 wt % Nafion®, with data obtained at 80° C., 100% RH, 1 atm pressure, and H₂/air operation, with membrane thickness: 25±5 μm (Nafion® NR-211);

FIG. 4A shows polarization and power curves of CCMs prepared using catalyst layers comprising linear sPPB-H⁺, 5 wt % HB+10 wt % linear sPPB-H⁺, and 10 wt % linear sPPB-H⁺ at H₂/O₂ operation with constant 1 slpm flow rates, obtained at 80° C., 100% RH, 1 atm pressure and membrane thickness: 33±5 μm (sPPB-H⁺);

FIG. 4B shows polarization and power curves of CCMs prepared using catalyst layers comprising linear sPPB-H⁺, 5 wt % HB+10 wt % linear sPPB-H⁺, and 10 wt % linear sPPB-H⁺ at H₂/air operation, obtained at 80° C., 100% RH, 1 atm pressure and membrane thickness: 33±5 μm (sPPB-H⁺);

FIG. 4C shows the Tafel relationship, with the inset showing the linearized region where the Tafel equation is valid, obtained at 80° C., 100% RH, 1 atm pressure and membrane thickness: 33±5 μm (sPPB-H⁺);

FIG. 4D shows Nyquist plots with 0.5 slpm H₂/1.0 slpm O₂ at 0.8 V, obtained at 80° C., 100% RH, 1 atm pressure and membrane thickness: 33±5 μm (sPPB-H⁺);

FIG. 4E shows CV scans with catalyst loading: 0.4 mgPt cm⁻² with 0.5 slpm H₂/0 slpm N₂, Scan rate: 50 mV s⁻¹, obtained at 80° C., 100% RH, 1 atm pressure and membrane thickness: 33±5 μm (sPPB-H⁺);

FIG. 4F shows Nyquist plots with 0.5 slpm H₂/0.5 slpm N₂, with inset showing an expansion of the high-frequency region, obtained at 80° C., 100% RH, 1 atm pressure and membrane thickness: 33±5 μm (sPPB-H⁺);

FIG. 5A shows polarization and power curves of CCMs prepared using catalyst layers comprising 30 wt % Nafion®, 5 wt % HB-sPPT-H⁺+25 wt % Nafion®, and 25 wt % Nafion®, H₂/O₂ operation with constant 1 slpm flow rates, obtained at 80° C., 100% RH, 1 atm pressure and membrane thickness: 25±5 μm (Nafion® NR—N211);

FIG. 5B shows polarization and power curves of CCMs prepared using catalyst layers comprising 30 wt % Nafion®, 5 wt % HB-sPPT-H⁺+25 wt % Nafion®, and 25 wt % Nafion®, H₂/air operation, obtained at 80° C., 100% RH, 1 atm pressure and membrane thickness: 25±5 μm (Nafion® NR-N211);

FIG. 5C shows the Tafel relationship, with the inset showing the linearized region where the Tafel equation is valid, obtained at 80° C., 100% RH, 1 atm pressure and membrane thickness: 25±5 μm (Nafion® NR-N211);

FIG. 5D shows Nyquist plots with 0.5 slpm H₂/1.0 slpm O₂ at 0.8 V, obtained at 80° C., 100% RH, 1 atm pressure and membrane thickness: 25±5 μm (Nafion® NR-N211);

FIG. 5E shows CV scans with catalyst loading: 0.4 mg Pt/cm² with 0.5 slpm H₂/0 slpm N₂, Scan rate: 50 mV s⁻¹, obtained at 80° C., 100% RH, 1 atm pressure and membrane thickness: 25±5 μm (Nafion® NR-N211);

FIG. 5F shows Nyquist plots with 0.5 slpm H₂/0.5 slpm N₂, with inset showing an expansion of the high-frequency region), obtained at 80° C., 100% RH, 1 atm pressure and membrane thickness: 25±5 μm (Nafion® NR-N211);

FIG. 6A shows polarization and power curves of CCMs prepared using catalyst layers comprising 15 wt % linear sPPB-H⁺ (CCM 1), 5 wt % HB-sPPT-H⁺+10 wt % linear sPPB-H⁺ (CCM 2), 30 wt % Nafion® (CCM 3), and 5 wt % HB-sPPT-H⁺+25 wt % Nafion® CLs (CCM 4) at H₂/O₂ operation with constant 1 slpm flow rates, obtained at 80° C., 100% RH, 1 atm pressure. Membrane thickness: 33±5 μm (sPPB-H⁺) for CCM 1 and CCM 2; 25±5 μm (Nafion® NR-N211) for CCM 3 and CCM 4;

FIG. 6B shows polarization and power curves of CCMs prepared using catalyst layers comprising 15 wt % linear sPPB-H⁺ (CCM 1), 5 wt % HB-sPPT-H⁺+10 wt % linear sPPB-H⁺ (CCM 2), 30 wt % Nafion® (CCM 3), and 5 wt % HB-sPPT-H⁺+25 wt % Nafion® CLs (CCM 4) at H₂/air operation with constant 1 slpm flow rates, obtained at 80° C., 100% RH, 1 atm pressure. Membrane thickness: 33±5 μm (sPPB-H⁺) for CCM 1 and CCM 2; 25±5 μm (Nafion® NR-N211) for CCM 3 and CCM 4;

FIG. 6C shows the Tafel relationship, and the inset shows the linearized region where the Tafel equation is valid, obtained at 80° C., 100% RH, 1 atm pressure. Membrane thickness: 33±5 μm (sPPB-H⁺) for CCM 1 and CCM 2; 25±5 μm (Nafion® NR-N211) for CCM 3 and CCM 4;

FIG. 6D shows Nyquist plots with 0.5 slpm H₂/1.0 slpm O₂ at 0.8 V, obtained at 80° C., 100% RH, 1 atm pressure. Membrane thickness: 33±5 μm (sPPB-H⁺) for CCM 1 and CCM 2; 25±5 μm (Nafion® NR-N211) for CCM 3 and CCM 4;

FIG. 6E shows CV scans with catalyst loading: 0.4 mgPt cm⁻² with 0.5 slpm H₂/0 slpm N₂, Scan rate: 50 mV s⁻¹, obtained at 80° C., 100% RH, 1 atm pressure. Membrane thickness: 33±5 μm (sPPB-H⁺) for CCM 1 and CCM 2; 25±5 μm (Nafion® NR-N211) for CCM 3 and CCM 4;

FIG. 6F shows Nyquist plots with 0.5 slpm H₂/0.5 slpm N₂, wherein the inset shows an expansion of the high-frequency region, obtained at 80° C., 100% RH, 1 atm pressure. Membrane thickness: 33±5 μm (sPPB-H⁺) for CCM 1 and CCM 2; 25±5 μm (Nafion® NR-N211) for CCM 3 and CCM 4;

FIG. 7A shows cross-sectional SEM for 15 wt % linear sPPB-H⁺ ionomer, (CCM 1);

FIG. 7B shows cross-sectional SEM for 5 wt % HB-sPPT-H⁺+10 wt % linear sPPB-H⁺ (CCM 2);

FIG. 7C shows cross-sectional SEM for 30 wt % Nafion® ionomer (CCM 3);

FIG. 7D shows cross-sectional SEM for 5 wt % HB-sPPT-H⁺+25 wt % Nafion® (CCM 4);

FIG. 7E shows cross-sectional SEM for N₂ adsorption isotherms (converted to STP and relative to the mass of carbon), V_{ads}, vs. relative pressure/saturation pressure (P/Po) of the compared CCMs FIG. 7F shows cross-sectional SEM for pore size distributions determined from the adsorption isotherms;

FIG. 8 shows t-plots, from which micropore volume (<2 nm pores), and mesopore+macropores volume (2-50 nm+>50 nm) were determined;

FIG. 9A shows a schematic illustration of the catalyst layer structure in the presence of Nafion® within the PEMFC CL;

FIG. 9B shows a schematic illustration of the catalyst layer structure in the presence of linear sPPB-H⁺ ionomer within the PEMFC CL;

FIG. 9C shows a schematic illustration of the catalyst layer structure in the presence of HB-sPPT-H⁺ particles within the PEMFC CL;

FIG. 10 shows the synthesis paths of the hyperbranched sulfonated phenylated-poly(phenylene) homopolymer (HB-sPPT-H⁺);

FIG. 11A shows SEM micrographs showing the surface roughness from 5 wt % HB-sPPT-H⁺+10 wt % linear sPPB-H⁺ at 1000× magnification;

FIG. 11B shows SEM micrographs showing the surface roughness from 7.5 wt % HB-sPPT-H⁺+7.5 wt % linear sPPB-H⁺ at 1000× magnification;

FIG. 11C shows SEM micrographs showing the surface roughness from 10 wt % HB-sPPT-H⁺+5 wt % linear sPPB-H⁺ at 1000× magnification;

FIG. 11D shows SEM micrographs showing the thickness of catalyst coated membranes prepared from 5 wt % HB-sPPT-H⁺+10 wt % linear sPPB-H⁺ at 1000× magnification;

FIG. 11E shows SEM micrographs showing the thickness of catalyst coated membranes prepared from 7.5 wt % HB-sPPT-H⁺+7.5 wt % linear sPPB-H⁺ at 1000× magnification;

FIG. 11F shows SEM micrographs showing the thickness of catalyst coated membranes prepared from 10 wt % HB-sPPT-H⁺+5 wt % linear sPPB-H⁺ at 1000× magnification;

FIG. 12A shows a plot of the mass and specific activity of CCMs made from 15 wt % sPPB-H⁺, 5 wt % HB-sPPT-H⁺+10 wt % linear sPPB-H⁺, and 10 wt % sPPB-H⁺, obtained at 80° C., 100% RH, 1 atm pressure;

FIG. 12B shows a plot of the mass and specific activity of CCMs made from 30 wt % Nafion®, 5 wt % HB-sPPT-H⁺+25 wt % Nafion®, and 30 wt % Nafion®, obtained at 80° C., 100% RH, 1 atm pressure;

FIG. 13A shows performance plots of MEAs indicating the polarization and power curves under H₂/O₂ with the Pt catalyst loading on the anode and cathode at 0.4 mgPt/cm² and operating conditions at 80° C., 100% RH, and 1 atm pressure; and

FIG. 13B shows performance plots of MEAs indicating the polarization and power curves under H₂/air operation with the Pt catalyst loading on the anode and cathode at 0.4 mgPt/cm² and operating conditions at 80° C., 100% RH, and 1 atm pressure.

### DETAILED DESCRIPTION

It will be appreciated that, although specific embodiments of the disclosure have been described herein for purposes of illustration, various modifications may be made without deviating from the spirit and scope of the disclosure.

Sulfonated poly(arylene ether)s and sulfo-phenylated polyphenylene ionomers can exhibit improved chemical stability relative to PFSAs. In an illustrative example, a biphenyl comonomer (sPPB-H⁺) provides improved stability at a cost of reduced ion conductivity.

Additionally, molecular branching of ionomeric polymers was explored to reduce dimensional swelling and improve the mechanical integrity of this class of hydrocarbon ionomers when cast as PEMs. Notably, with lower water uptake of the branched ionomeric polymers described herein, conductivity increased.

Herein, the design and addition of non-dimensionally swellable, non-conformal, hyperbranched sulfo-phenylated poly(phenylene) ionomer particles (HB-sPPT-H⁺) is reported to introduce a direct pathway for proton conduction in hydrocarbon ionomer-based catalytic layers (CLs).

### Definitions

At various places in the present specification, substituents of compounds of the disclosure are disclosed in groups or in ranges. It is specifically intended that the disclosure include each and every individual subcombination of the members of such groups and ranges. For example, the term “Cl-6 alkyl” is specifically intended to individually disclose methyl, ethyl, C3 alkyl, C4 alkyl, C5 alkyl, and C6 alkyl. As an example, the term “optionally substituted with 1, 2, 3, 4, or 5” is intended to individually disclose optional substitution with 1, 2, 3, or 4; 1, 2, or 3; 1 or 2; or 1 substituents.

It is further intended that the compounds of the disclosure are stable. As used herein “stable” refers to a compound that is sufficiently robust to survive isolation to a useful degree of purity from a reaction mixture.

It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

It is intended that divalent groups, such as linking groups (e.g., alkylene, arylene, etc.) between a first and a second moiety, can be oriented in both a forward and a reverse direction with respect to the first and second moieties, unless specifically described.

“Optionally substituted” groups can refer to, for example, functional groups that may be substituted or unsubstituted by additional functional groups. For example, when a group is unsubstituted, it can be referred to as the group name, for example alkyl or aryl. When a group is substituted with additional functional groups, it may more generically be referred to as substituted alkyl or substituted aryl.

As used herein, the term “substituted” or “substitution” refers to the replacing of a hydrogen atom with a substituent other than H. For example, an “N substituted piperidin-4-yl” refers to replacement of the H atom from the NH of the piperidinyl with a non-hydrogen substituent such as, for example, alkyl.

As used herein, the term “about” can be understood to include values within 10% of the stated value.

As used herein, the term “alkyl” refers to straight or branched hydrocarbon groups. In some embodiments, alkyl has 1 to 10 carbon atoms, 1 to 8 carbon atoms, 1 to 6 carbon atoms, 1 to 3 carbon atoms, 1 or 2 carbon atoms, or 1 carbon atom. Representative alkyl groups include methyl, ethyl, propyl (e.g., n-propyl, isopropyl), butyl (e.g., n-butyl, sec-butyl, and tert-butyl), pentyl (e.g., n-pentyl, tert-pentyl, neopentyl, isopentyl, pentan-2-yl, pentan-3-yl), and hexyl (e.g., n-hexyl and isomers) groups.

As used herein, the term “alkylene” refers to a linking alkyl group.

As used herein, the term “cycloalkyl” refers to non-aromatic carbocycles including cyclized alkyl, alkenyl, and alkynyl groups. Cycloalkyl groups can include mono- or polycyclic (e.g., having 2, 3 or 4 fused rings) ring systems, including spirocycles. In some embodiments, cycloalkyl groups can have from 3 to about 20 carbon atoms, 3 to about 14 carbon atoms, 3 to about 10 carbon atoms, or 3 to 7 carbon atoms. Cycloalkyl groups can further have 0, 1, 2, or 3 double bonds and/or 0, 1, or 2 triple bonds. Also included in the definition of cycloalkyl are moieties that have one or more aromatic rings fused (i.e., having a bond in common with) to the cycloalkyl ring, for example, benzo derivatives of pentane, pentene, hexane, and the like. A cycloalkyl group having one or more fused aromatic rings can be attached though either the aromatic or non-aromatic portion. One or more ring-forming carbon atoms of a cycloalkyl group can be oxidized, for example, by having an oxo or sulfido substituent. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcamyl, adamantyl, and the like.

As used herein, the term “cycloalkylene” refers to a linking cycloalkyl group.

As used herein, the term “perfluoroalkyl” refers to straight or branched fluorocarbon chains. In some embodiments, perfluoroalkyl has 1 to 10 carbon atoms (e.g., 1 to 8 carbon atoms, 1 to 6 carbon atoms, 1 to 3 carbon atoms, 1 or 2 carbon atoms, or 1 carbon atom). Representative alkyl groups include trifluoromethyl, pentafluoroethyl, etc.

As used herein, the term “perfluoroalkylene” refers to a linking perfluoroalkyl group.

As used herein, the term “heteroalkyl” refers to a straight or a branched chain alkyl groups and where one or more of the carbon atoms is replaced with a heteroatom selected from O, N, or S. In some embodiments, heteroalkyl alkyl has 1 to 10 carbon atoms (e.g., 1 to 8 carbon atoms, 1 to 6 carbon atoms, 1 to 3 carbon atoms, 1 or 2 carbon atoms, or 1 carbon atom).

As used herein, the term “heteroalkylene” refers to a linking heteroalkyl group.

As used herein, the term “alkoxy” refers to an alkyl or cycloalkyl group as described herein bonded to an oxygen atom. In some embodiments, alkoxy has 1 to 10 carbon atoms (e.g., 1 to 8 carbon atoms, 1 to 6 carbon atoms, 1 to 3 carbon atoms, 1 or 2 carbon atoms, or 1 carbon atom). Representative alkoxy groups include methoxy, ethoxy, propoxy, and isopropoxy groups.

As used herein, the term “perfluoroalkoxy” refers to a perfluoroalkyl or cyclic perfluoroalkyl group as described herein bonded to an oxygen atom. In some embodiments, perfluoroalkoxy has 1 to 10 carbon atoms (e.g., 1 to 8 carbon atoms, 1 to 6 carbon atoms, 1 to 3 carbon atoms, 1 or 2 carbon atoms, or 1 carbon atom). Representative perfluoroalkoxy groups include trifluoromethoxy, pentafluoroethoxy, etc.

As used herein, the term “aryl” refers to an aromatic hydrocarbon group having 6 to 10 carbon atoms. Representative aryl groups include phenyl groups. In some embodiments, the term “aryl” includes monocyclic or polycyclic (e.g., having 2, 3, or 4 fused rings) aromatic hydrocarbons such as, for example, phenyl, naphthyl, anthracenyl, phenanthrenyl, indanyl, and indenyl.

As used herein, the term “arylene” refers to a linking aryl group. For example, the term “phenylene” refers to a linking phenyl group.

As used herein, the term “aralkyl” refers to an alkyl or cycloalkyl group as defined herein with an aryl group as defined herein substituted for one of the alkyl hydrogen atoms. A representative aralkyl group is a benzyl group.

As used herein, the term “aralkylene” refers to a linking aralkyl group.

As used herein, the term “heteroaryl” refers to a 5- to 10-membered aromatic monocyclic or bicyclic ring containing 1-4 heteroatoms selected from O, S, and N. Representative 5- or 6-membered aromatic monocyclic ring groups include pyridine, pyrimidine, pyridazine, furan, thiophene, thiazole, oxazole, and isooxazole. Representative 9- or 10-membered aromatic bicyclic ring groups include benzofuran, benzothiophene, indole, pyranopyrrole, benzopyran, quinoline, benzocyclohexyl, and naphthyridine.

As used herein, the term “heteroarylene” refers to a linking heteroaryl group.

As used herein, the term “heteroaralkyl” refers to an alkyl or cycloalkyl group as defined herein with an aryl or a heteroaryl group as defined herein substituted for one of the alkyl hydrogen atoms. For example, a representative aralkyl group is a benzyl group.

As used herein, the term “heteroaralkylene” refers to a linking heteroaralkyl group.

As used herein, the term “halogen” or “halo” refers to fluoro, chloro, bromo, and iodo groups.

As used herein, the term “copolymer” refers to a polymer that is the result of polymerization of two or more different monomers. The number and the nature of each constitutional unit can be separately controlled in a copolymer. The constitutional units can be disposed in a purely random, an alternating random, a regular alternating, a regular block, or a random block configuration unless expressly stated to be otherwise. A purely random configuration can, for example, be: x x y z x y y z y z z z . . . or y z x y z y z x x . . . . An alternating random configuration can be: x y x z y x y z y x z . . . , and a regular alternating configuration can be: x y z x y z x y z . . . . A regular block configuration (i.e., a block copolymer) has the following general configuration: . . . x x x y y y z z z x x x . . . , while a random block configuration has the general configuration of, for example: . . . x x x z z x x y y y y z z z x x z z z . . . , or for example, . . . x-x-x-y-y-y-y-x-x-y-y-y-x-x-x-y-y . . . .

As used herein, the term “constitutional unit” of a polymer refers to an atom or group of atoms in a polymer, comprising a part of the chain together with its pendant atoms or groups of atoms, if any. The constitutional unit can be a repeating unit. The constitutional unit can also refer to an end group on a polymer chain. For example, the constitutional unit of polyethylene glycol can be —CH₂CH₂O— corresponding to a repeating unit, or —CH₂CH₂OH corresponding to an end group.

As used herein, the term “repeating unit” corresponds to the smallest constitutional unit, the repetition of which constitutes a macromolecule (or oligomer molecule or block).

As used herein, the term “end group” refers to a constitutional unit with only one attachment to a polymer chain, located at the end of a polymer. For example, the end group can be derived from a monomer unit at the end of the polymer, once the monomer unit has been polymerized. As another example, the end group can be a part of a chain transfer agent or initiating agent that was used to synthesize the polymer.

As used herein, the term “terminus” of a polymer refers to a constitutional unit of the polymer that is positioned at the end of a polymer backbone.

As used herein, the term “terminal group” refers to a functional group positioned at the end of a polymer backbone.

As used herein, the term “cationic” refers to a moiety that is positively charged, or ionizable to a positively charged moiety under physiological conditions. Examples of cationic moieties include, for example, amino, ammonium, pyridinium, imino, sulfonium, quaternary phosphonium groups, etc.

As used herein, the term “anionic” refers to a functional group that is negatively charged, or ionizable to a negatively charged moiety under physiological conditions.

Examples of anionic groups include carboxylate, sulfate, sulfonate, phosphate, etc.

As used herein, the term “branched” refers to a polymer that includes side chains or “branches” growing out from a main polymeric segment (e.g., a polymer backbone). The branching is composed of the same repeating unit as the main segment. A branched ionomeric polymer comprises branching comonomers at a relatively low abundance in the ionomeric polymer relative to hyperbranched ionomeric polymers, which have a higher abundance of branching comonomers in the ionomeric polymer. Branched ionomeric polymers can include a mixture of linear and branched segments.

As used herein, the term “hyperbranched” refers to a polymer that includes a three-dimensional polymeric structure that is differs from regular dendrimer structures, and which can include a mixture of linear and branched segments. Hyperbranched ionomeric polymers comprise a relatively high abundance of branching comonomers in the ionomeric polymer than exists in branched ionomeric polymers. For example, a polymer composition can comprise branching monomer between about 20 mol % and about 40 mol %, between about 20 mol % and about 30 mol %, between about 20 mol % and about 25 mol %, between about 18 mol % and about 22 mol %, or about 20 mol %. Hyperbranched ionomeric polymers typically comprise few or no linear segments. Hyperbranched ionomeric polymers described herein can be denoted HB-sPPT-H⁺.

Branched and hyperbranched ionomeric polymers are distinguished from crosslinked polymers in that a branched or hyperbranched ionomeric polymer does not include connections between the polymeric chain(s) or pre-existing polymeric chain(s).

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### Branched Ionomeric Polymers and Hyperbranched Ionomeric Polymers

Polymers of the present disclosure can be branched and/or hyperbranched. Without wishing to be bound by theory, in some embodiments, branched and/or hyperbranched ionomeric polymers can have improved properties over their linear polymer analogues. Branched and/or hyperbranched ionomeric polymers can comprise a branching comonomer (B), and which is covalently bound to at least three anionic comonomer units. The branched and/or hyperbranched ionomeric polymers can be synthesized through reaction of functionalized branching comonomers (e.g., dienophiles) having three reactive functional groups or more, with functionalized anionic comonomers (e.g., dienes) having two diene functional groups or more. Such composition can effect branching through the dienophile comonomer. Additionally, branched and/or hyperbranched ionomeric polymers can be synthesized through reaction of functionalized anionic comonomers (e.g., dienes) having three reactive diene functional groups or more, with dienophile comonomers having two functional groups or more (e.g., alkynes and/or ketones). Such a composition can effect branching through the diene comonomer. Further, branched and/or hyperbranched ionomeric polymers can be synthesized through reaction of functionalized anionic comonomers (e.g., dienes) having three reactive diene functional groups or more, with dienophile comonomers having three functional groups or more (e.g., alkynes and/or ketones). Such a composition can effect branching through both the diene comonomer and the dienophile comonomer. Embodiments of branching dienophile comonomers and branching dienes include, but are not limited to, 3, 4, 5, and/or 6-way functionality. Scheme 1 depicts a branched ionomeric polymer comprising a trifunctional branching dienophile monomer.

Multivalent linkers (i.e., comonomers) can be incorporated into the polymers using multi-functional aromatic systems terminated by alkynes or protected alkynes, which are then used in reaction with dienophile comonomers to produce a branching point, as per Schemes 1 and 2. The diene comonomer can be a mixture of anionic comonomers and hydrophobic uncharged comonomers. The functionalized branching aromatic systems can be small, such as 1,3,5-triethynylbenzene, or larger, having more than one aromatic group.

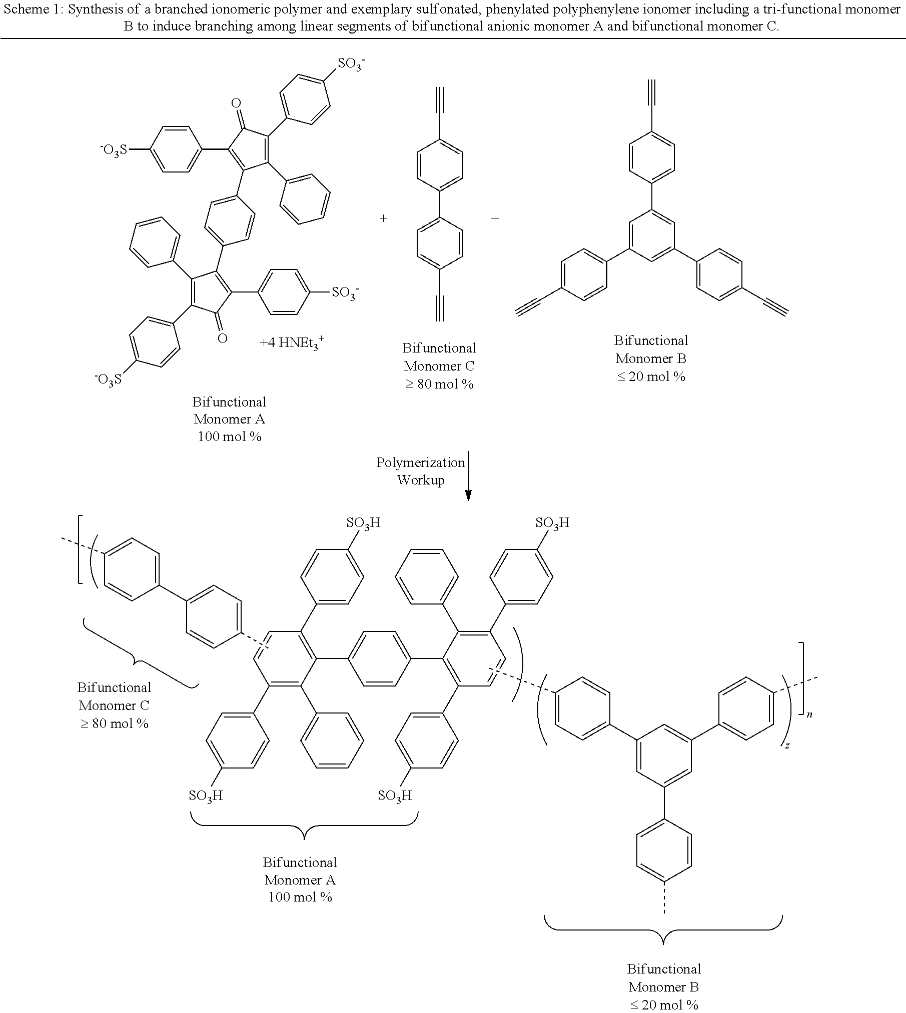

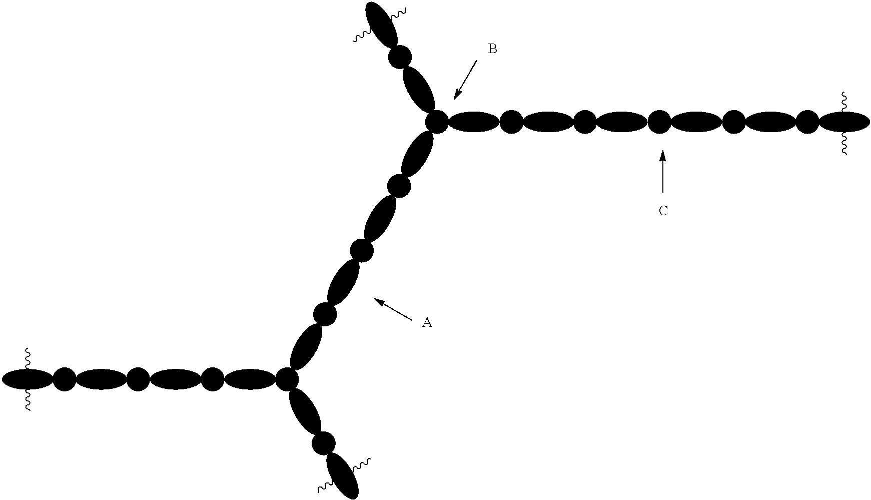

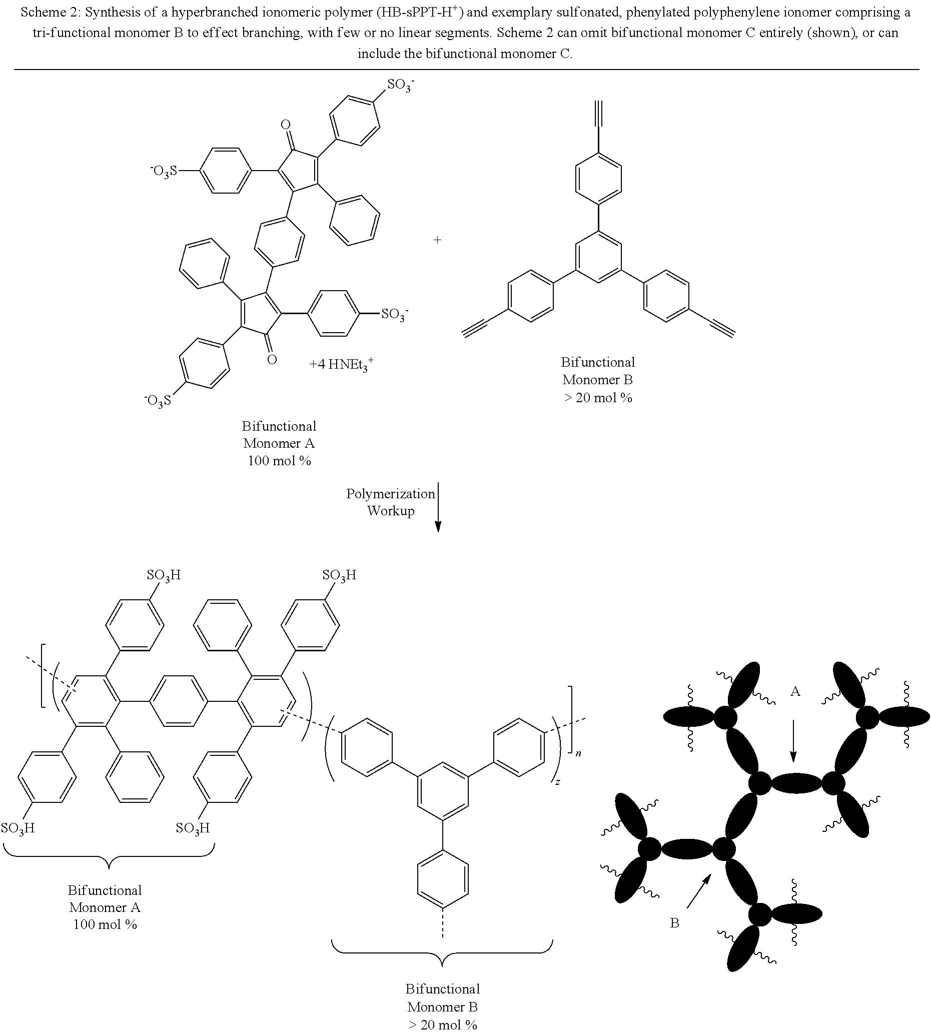

Polymers of the present disclosure include a branched ionomeric polymer comprising a repeating unit of Formula (I):

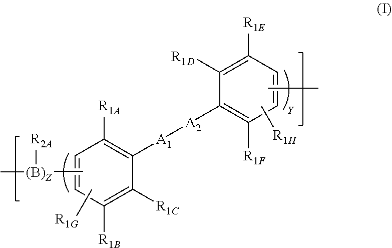

wherein:
   R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
   R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation;
   A₁ is arylene, heteroarylene, aralkylene, or heteroaralkylene, each optionally substituted with 1, 2, 3, or 4 substituents independently selected from halo, nitro, cyano, aryl, and heteroaryl; and
   A₂ is absent, arylene, or heteroarylene, wherein said arylene and heteroarylene are each optionally substituted with 1, 2, 3, or 4 substituents independently selected from halo, nitro, cyano, aryl, and heteroaryl;
   B is a branching comonomer;
   R_{2A} is a bond; and
wherein a first repeat unit of Formula (I) is bound to a second repeat unit of Formula (I) at R_{2A} to form a branched structure.

The branched ionomeric polymer comprising the repeat unit of Formula (I) can comprise an anionic comonomer unit, and a branching comonomer (B) unit.

In some embodiments, the anionic comonomer comprises more than one aryl groups, more than 6 aryl groups, less than 10 aryl groups, exactly 7 aryl groups, or exactly 9 aryl groups, and additionally comprises more than one anionic substituents (e.g. sulfonate, phosphonate, and/or carboxylate), between 2 and 7 anionic substituents, between 2 and 6 anionic substituents, between 2 and 4 anionic substituents, between 4 and 10 anionic substituents, at least two anionic substituents, or 4 or fewer anionic substituents.

The anionic substituents can comprise one or more groups, which are the same or different, and which are anionic at physiological pH, or are neutral at physiological pH but become anionic at a pH greater than the pKa of the substituent. For example, anionic groups can include sulfonate, phosphonate, carboxylate, or a combination thereof.

Each of the anionic substituents (e.g. sulfonate, phosphonate, and/or carboxylate) can be protonated, or have a counterion which is not a proton. As described herein, X⁺ is a counterion and can be H⁺, a cation, an alkali metal ion (e.g. Li⁺, Na⁺, K⁺, Rb⁺, and/or Cs⁺), an ammonium, a substituted ammonium such as an alkyl-, aryl-, or heteroaryl-substituted ammonium, or a combination thereof. For example, the ammonium can be [N(R_{5A})(R_{5B})(R_{5C})(R_{5D})]⁺ wherein R_{5A}, R_{5B}, R_{5C}, and R_{5D} are independently H, C₁₋₆ alkyl, aryl, aralkyl, or heteroaryl.

In a representative embodiment, the anionic comonomer unit comprises a structure according to the structure of Formula (VII):

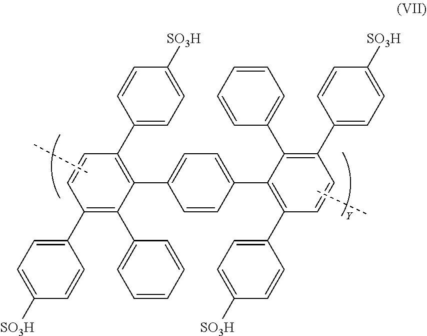

In some embodiments, the branching comonomer (B) unit comprises a structure of Formula (II):

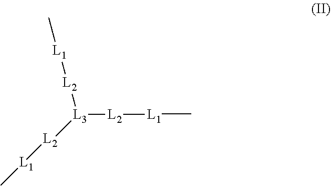

wherein:
   L₃, at each occurrence, is an optionally substituted multivalent heteroatom (e.g., N, P, B), multivalent aryl, multivalent heteroaryl, multivalent aralkyl, or multivalent heteroaralkyl, wherein said multivalent aryl, multivalent heteroaryl, multivalent aralkyl, and multivalent heteroaralkyl are each optionally substituted with 1, 2, or 3 substituents independently selected from C₁₋₆ alkyl, halo, nitro, cyano, aryl, and heteroaryl;
   L₂ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl; and
   L₁ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl.

In an illustrative example, branching comonomer (B) can comprise a structure of Formula (III):

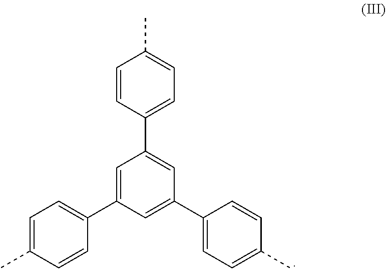

The branched ionomeric polymer comprising the repeat unit of Formula (I) can comprise an anionic comonomer unit having a frequency “Y,” and a branching comonomer (B) unit having a frequency “Z.”

In some embodiments, a molar ratio of Z:Y in the polymer is from about 1:3 to about 1:2, from about 1:4 to about 2:3, from about 1:5 to about 3:4, is about 1:2, or is about 1:3.

The relative molar composition of Z:Y can influence the extent of branching and the structural, material, and electronic properties of the resulting polymer. As such, for values of a molar ratio less than about 1:3 or greater than about 1:2, or less than about 1:3 or greater than about 2:3, or less than about 1:4 or greater than about 1:2, the extent of branching can be too low or too high, respectively, for the polymer to exhibit desired ionomeric performance, as described in Examples 1-4 below.

As described herein, the anionic comonomer and branching comonomer (B) are connected by a covalent bond.

In an embodiment, the repeating unit comprises the structure of Formula (IV):

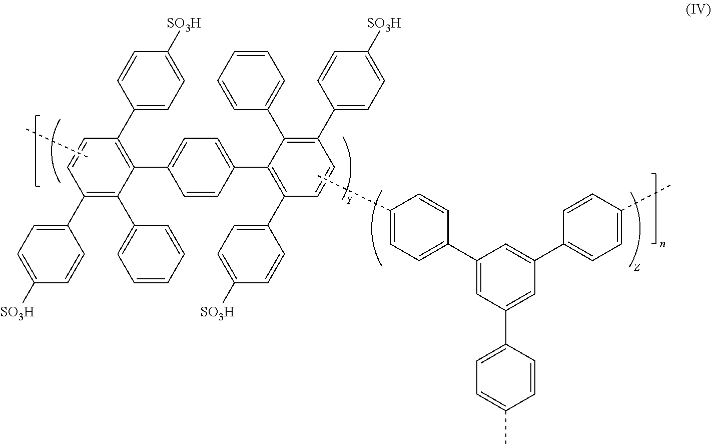

In some embodiments, the polymer is insoluble in a polar solvent. Polar solvents can include water, alcohols (e.g., methanol, ethanol, propanol, isopropanol, n-butanol, and/or tert-butanol). In some embodiments, the polymer is insoluble in a low boiling point alcohol. A low boiling point comprises a boiling point below about 120° C., below about 100° C., below about 90° C., below about 85° C., below about 80° C., below about 70° C., between about 60° C. and about 80° C., between about 60° C. and about 85° C., or between about 60° C. and about 120° C., Examples of low boiling point alcohols include methanol, ethanol, propanol, isopropanol, n-butanol, tert-butanol, and the like.

In some embodiments, the polar solvent comprises an alcohol, water, or a combination thereof. In some embodiments, the polar solvent comprises a combination of more than one component, such as alcohol and water, or more than one different alcohols and water. In embodiments wherein the polar solvent comprises alcohol and water, the composition of the polar solvent can be about a 1:1 volume-to-volume ratio of water to alcohol(s), about a 1:2 volume-to-volume ratio of water to alcohol(s), about a 1:3 volume-to-volume ratio of water to alcohol(s), about a 1:4 volume-to-volume ratio of water to alcohol(s), about a 1:2.5 volume-to-volume ratio of water to alcohol(s), or about a 1:3.5 volume-to-volume ratio of water to alcohol(s).

The branched ionomeric polymer of Formula (I) can be formed by polymerization of a functionalized branching comonomer (B) with a functionalized anionic comonomer. The polymerization can comprise polymerizing Zₘ moles of a functionalized comonomer (B) with Yₘ moles of a functionalized anionic comonomer, in a Diels-Alder addition reaction.

In the polymer synthesis, the functionalized branching comonomer (B) is a dienophile, and can comprise more than one alkyne functional groups, two or more alkyne functional groups, three or more alkyne functional groups, between two and four alkyne functional groups, between two and six alkyne functional groups, exactly six alkyne functional groups, exactly five alkyne functional groups, exactly four alkyne functional groups, or exactly three alkyne functional groups. For example, the functionalized branching comonomer (B) can be a trifunctional comonomer (B) comprising three alkyne functional groups.

In the polymer synthesis, the functionalized anionic comonomer is a diene. The functionalized anionic comonomer can comprise one diene, two dienes, three dienes, or four dienes in the functionalized anionic comonomer reagent.

The molar ratio of the functionalized branching comonomer (B) to functionalized anionic comonomer in the polymer synthesis can be greater than about 0.2, can be greater than about 0.4, can be greater than about 0.5, can be greater than about 0.6, can be greater than about 0.7, can be about 0.5 to about 0.7, or can be about 0.67.

The branching comonomer (B) can be formed from a functionalized comonomer (B), such as a trifunctional comonomer (B). Such functionalized comonomer (B) has the role of a dienophile in the Diels-Alder addition reaction. A representative trifunctional comonomer (B) dienophile is represented by Formula (V):

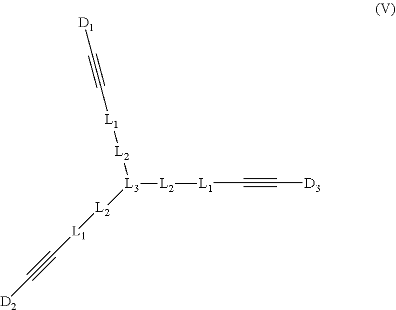

wherein:
   L₃ at each occurrence, is an optionally substituted multivalent heteroatom (e.g., N, P, B), multivalent aryl, multivalent heteroaryl, multivalent aralkyl, or multivalent heteroaralkyl, wherein said multivalent aryl, multivalent heteroaryl, multivalent aralkyl, and multivalent heteroaralkyl are each optionally substituted with 1, 2, or 3 substituents independently selected from C₁₋₆ alkyl, halo, nitro, cyano, aryl, and heteroaryl;
   L₂ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl;
   L₁ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl; and
   D₁, D₂, and D₃ are independently H, R_{1G}, R_{1H}, R_{3G}, R_{3H}, or a protecting group (e.g., silyl protecting group, substituted silyl protecting group, trialkylsilyl protecting group, silyl ether protecting group, trialkyl silyl ether protecting group, trimethyl silyl ether),
   wherein R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and
   wherein R_{3G} and R_{3H} are independently alkyl, aryl, or aralkyl.

The multivalent branching comonomers referred to herein, such as the branching comonomer (B), can be incorporated into the polymers through alkyne functional groups, or protected alkyne functional groups. The alkyne functional groups can be located at a centralized position in a molecule, or at a terminal position in a molecule. The functionalized comonomer (B) can comprise a mixture of functionalized comonomers, or can comprise a pure composition of comonomers having essentially one molecular composition.

The functionalized comonomer (B) can be a relatively small molecule, such as 1,3,5-triethynylbenzene, or a relatively large molecule, such as a molecule comprising more than one aromatic group and three alkyne functional groups. The functionalized comonomer (B) can comprise one or more aromatic ring, one or more heteroaromatic ring, or a combination thereof. Wherein the functionalized comonomer (B) comprises one or more heteroaromatic rings, one or more heteroatoms can be present, wherein the one or more heteroatoms are selected from nitrogen, oxygen, and sulfur. The heteroaromatic rings can be pyridine or pyrazine. Representative trifunctional comonomers (B) can comprise one or more of the following structures:

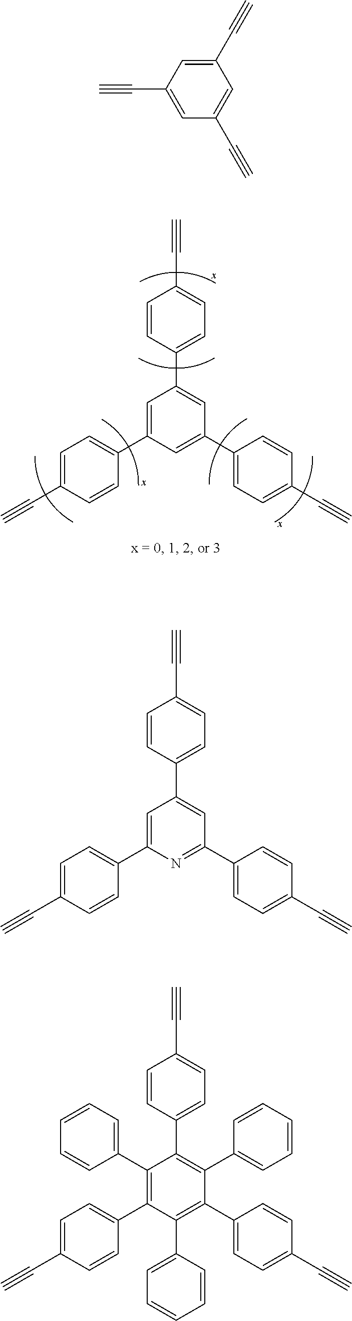

In some embodiments, the functionalized comonomer (B) can include a central atom, such as a nitrogen or carbon, and can comprise one or more of the following structures:

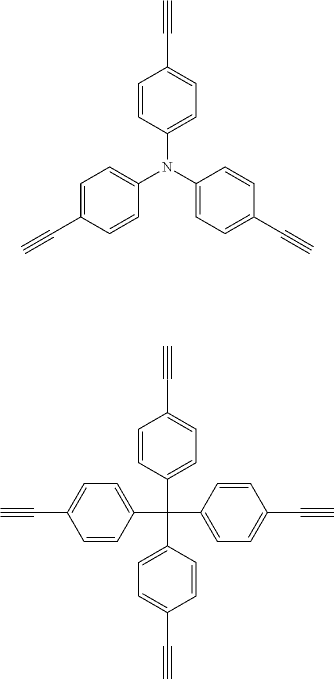

In some embodiments, one or more terminal alkyne groups are replaced by H.

In some embodiments, the functionalized comonomer (B) can comprise five or six functional groups such as five or six alkyne groups. The functionalized comonomer B can comprise five or six functionalized aromatic rings, to comprise hexa- or penta-phenylbenzene dienophile derivatives. Representative hexa- or penta-phenylbenzene dienophiles can include the following, wherein the “R” substituents can be the same or can be different within the molecule, and can comprise an alkyne functional group or a hydrogen:

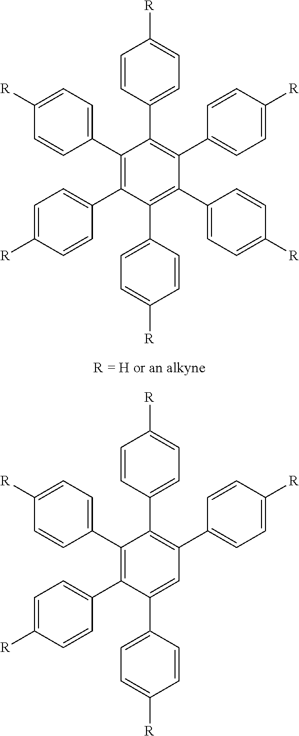

In an embodiment, the multivalent comonomer has a structure according to the functionalized comonomer described herein, such as, for example, the trifunctional dienophile according to Formula (VIII):

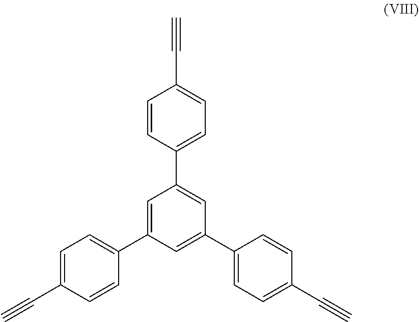 [SMILES: C#Cc1ccc(-c2cc(-c3ccc(C#C)cc3)cc(-c3ccc(C#C)cc3)c2)cc1]

In an embodiment, the functionalized anionic comonomer has a structure according to Formula (VI):

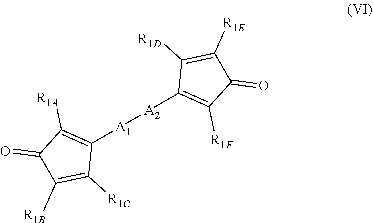

wherein:
R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
A₁ is arylene, heteroarylene, aralkylene, or heteroaralkylene, each optionally substituted with 1, 2, 3, or 4 substituents independently selected from halo, nitro, cyano, aryl, and heteroaryl; and
A₂ is absent, arylene, or heteroarylene, wherein said arylene and heteroarylene are each optionally substituted with 1, 2, 3, or 4 substituents independently selected from halo, nitro, cyano, aryl, and heteroaryl.

As described herein, X⁺ is a counterion and can be H⁺, a cation, an alkali metal ion (e.g. Li⁺, Na⁺, K⁺, Rb⁺, and/or Cs⁺), an ammonium, a substituted ammonium such as an alkyl-, aryl-, or heteroaryl-substituted ammonium, or a combination thereof. For example, the ammonium can be [N(R_{5A})(R_{5B})(R_{5C})(R_{5D})]⁺ wherein R_{5A}, R_{5B}, R_{5C}, and R_{5D} are independently H, C₁₋₆alkyl, aryl, aralkyl, or heteroaryl.

In an illustrative embodiment, the functionalized anionic comonomer of Formula (VI) is:

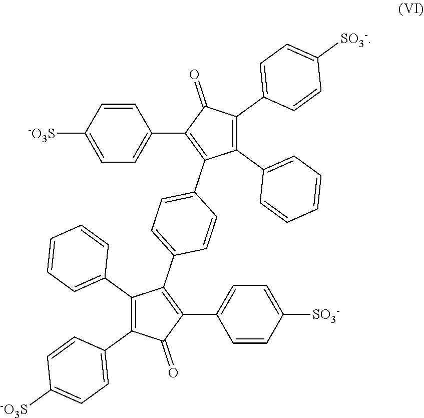

The branched ionomeric polymer of Formula (I) can further comprise a bifunctional linker (C) as shown in Scheme 1. A bifunctional linker can comprise aryl groups or heteroaryl groups, and as used herein are arylene or heteroarylene. In an embodiment, the arylene or heteroarylene can comprise one aryl or heteroaryl group, can comprise more than one aryl or heteroaryl groups, or can comprise a combination of one or more aryl and heteroaryl groups. Wherein a bifunctional linker (C) is present and comprises one or more, or more than one, aryl or heteroaryl groups, the aryl or heteroaryl groups can be the same or different aryl or heteroaryl groups. For example, the one or more, or more than one aryl or heteroaryl can comprise an aryl and an aryl (e.g. phenyl and phenyl to make a biphenyl, or phenyl and naphthyl), or can comprise a aryl and a heteroaryl (e.g. a phenyl and a pyridyl).

In an embodiment, the bifunctional arylene can be phenyl, naphthyl, anthracenyl, biphenyl, terphenyl, and the like, or a combination thereof.

The functionalized comonomers (B), bifunctional comonomers C, and functionalized anionic comonomers described herein can be reacted together in certain ratios to achieve a defined and desired ratio in the branched ionomeric polymer composition. For example, the functionalized comonomer (B) can be present in an amount of 0.001 to 20 mole percent relative to the combination of anionic comonomer and bifunctional comonomer C. In the foregoing, bifunctional comonomer C can be present, or can be absent altogether.

In contrast, hyperbranching results from a higher relative amount of functionalized comonomer (B) when used at a ratio above about 20 mole percent, above about 15 mol percent, above about 13 mol percent, above about 12 mol percent, about 13.3 mol percent, about 13.33 mol percent, or about 13.333 mol percent, relative to the anionic comonomer (e.g., a relative amount of approximately 66-67 mole percent). In an embodiment, a hyperbranched ionomeric polymer comprises an amount of functionalized comonomer (B) at a ratio of about 13.3 mol percent relative to the amount of anionic comonomer. In an embodiment, a hyperbranched ionomeric polymer comprises an amount of functionalized comonomer (B) at a ratio of about 13.33 mol percent relative to the amount of anionic comonomer. In an embodiment, a hyperbranched ionomeric polymer comprises an amount of functionalized comonomer (B) at a ratio of about 13.333 mol percent relative to the amount of anionic comonomer. In an embodiment, a hyperbranched ionomeric polymer comprises an amount of functionalized comonomer (B) at a ratio of about 20 mol percent relative to the amount of anionic comonomer. For example, to achieve hyperbranching, the molar ratio of functionalized comonomer (B) and bifunctional comonomer C, in comparison with the functionalized anionic comonomer, in the Diels-Alder synthesis reaction can be greater than about 0.2 (equivalent to about 20 mol percent), greater than about 0.3 (equivalent to about 30 mol percent), greater than about 0.4 (equivalent to about 40 mol percent), greater than about 0.5 (equivalent to about 50 mol percent), greater than about 0.6 (equivalent to about 60 mol percent), greater than about 0.7 (equivalent to about 70 mol percent), between about 0.2 and about 0.8, between about 0.5 and about 0.75, between about 0.6 and about 0.7, or about 0.67 (equivalent to about 67 mol percent). In the foregoing, bifunctional comonomer C can be present or can be absent altogether.

In an embodiment, the branched or hyperbranched ionomeric polymer of Formula (I) is used in a catalyst ink formulation. A catalyst ink formulation can comprise: (1) a polar solvent, (2) a branched and/or hyperbranched ionomeric polymer having a structure of Formula (I) as described herein, and including any variants, (3) a branched and/or linear ionomeric polymer, and (4) a catalyst. A catalyst ink formulation can comprise: (1) a polar solvent, (2) a hyperbranched ionomeric polymer having a structure of Formula (I) as described herein, and including any variants, (3) a linear ionomeric polymer, and (4) a catalyst. A catalyst ink formulation can comprise: (1) a polar solvent, (2) a branched ionomeric polymer having a structure of Formula (I) as described herein, and including any variants, (3) a linear ionomeric polymer, and (4) a catalyst. A catalyst ink formulation can comprise: (1) a polar solvent, (2) a hyperbranched ionomeric polymer having a structure of Formula (I) as described herein, and including any variants, (3) a branched linear ionomeric polymer, and (4) a catalyst.

The catalyst of the catalyst ink formulation can comprise platinum on carbon supports (i.e., Pt/C) of various Pt particulate sizes in combination with carbon materials of various surface areas and sizes; Pt alloys on carbon supports (e.g., PtCo/C) of various precious metal alloy particulate sizes and alloy ratios in combination with carbon materials of various surface areas and sizes; or M-N—C catalysts, incorporating non-precious-metal ions (e.g., wherein M is iron or cobalt) within a nitrogen-doped carbon support.

The amount of catalyst used can be dependent upon the catalyst identity, the amount of solids content in the catalyst ink, the ionomer to catalyst ratio, and/or other factors. As used herein, the wt % of Pt/C catalyst means the total amount of the Pt/C solids used, including both the Pt and carbon amount. For example, the wt % of Pt/C remains the same for a total mass used whether the Pt/C is 40 wt % Pt and 60 wt % carbon, or a different relative composition.

In an embodiment, the amount of catalyst used can be between about 0.1 wt % and about 2.0 wt % based on solids content.

In an embodiment, the amount of catalyst used can be between about 0.1% w/v to about 25% w/v catalyst (e.g., Pt/C, PtCo/C, and M-N—C catalyst) relative to the catalyst ink solvent volume.

In an embodiment, the catalyst ink composition can comprise between about 1 wt % and about 30 wt % ionomeric polymer, and between about 70 wt % and about 99 wt % of supported catalyst, of total solids content.

In an embodiment, the catalyst ink composition can comprise between about 10 wt % and about 30 wt % ionomeric polymer, and between about 70 wt % and about 90 wt % of supported catalyst, of total solids content.

In an embodiment, the catalyst layer can comprise between about 1 wt % and about 30 wt % ionomeric polymer, and between about 70 wt % and about 99 wt % of supported catalyst or solids content.

The linear ionomeric polymer can comprise a structure of Formula (IX):

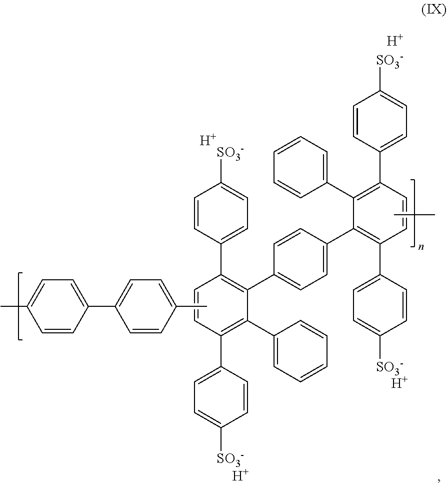

which is a linear sulfonated phenylated poly(phenylene) biphenyl, and is denoted sPPB-H⁺. In another embodiment, the linear ionomeric polymer can comprise a structure of Formula (X):

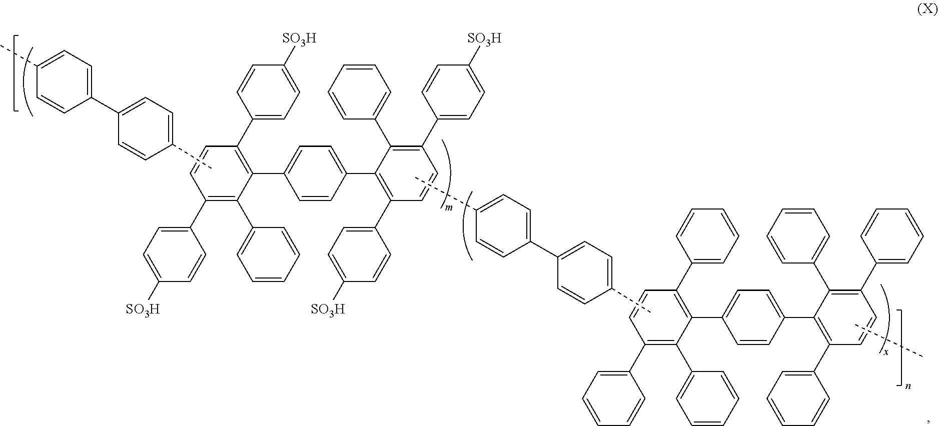

which is a random copolymer comprising sPPB-H⁺ and a hydrophobic unit, denoted RCP-sPPB-H⁺. In an embodiment, the linear ionomeric polymer can comprise commercially available PFSA materials such as, but not limited to, long side chain PFSA ionomers (e.g., Nafion®), short side chain PFSA ionomers (e.g., Aquivion®), and/or similar derivatives thereof (e.g., 3M ionomers). In an embodiment, the linear ionomeric polymer is any linear ionomeric polymer.

The branched or hyperbranched ionomeric polymer can be disposed in the polar solvent, wherein the branched or hyperbranched ionomeric polymer is placed, introduced, or suspended in the polar solvent. The branched or hyperbranched ionomeric polymer can be dispersed in the polar solvent. The branched or hyperbranched ionomeric polymer can have a solubility of about 0% to about 20%, of about 0% to about 15%, of about 0% to about 10%, of about 0% to about 5% in the polar solvent. In an embodiment, the branched or hyperbranched ionomeric polymer has a solubility between about 0% to about 20% in the polar solvent. The branched or hyperbranched ionomeric polymer can be essentially insoluble in the polar solvent.

The linear ionomeric polymer can have solubility in the polar solvent which is greater than the solubility of the branched or hyperbranched ionomeric polymer. The polar solvent is contacted by the linear ionomeric polymer, and the linear ionomeric polymer can disperse into the polar solvent completely (e.g., about 90% to about 100%), essentially completely (e.g. at least about 97%), or mostly (e.g. at least about 90%), to form a solution wherein the linear ionomeric polymer is dispersed in the polar solvent.

Dispersed, as used herein, means the particles of the ionomeric polymer are fairly evenly distributed throughout the polar solvent, or the ionomeric polymer is soluble in the polar solvent and can be evenly distributed throughout the polar solvent upon mixing.

In an embodiment, the linear ionomeric polymer (e.g., sPPB-H⁺) is at least about 97% dispersed in an alcohol (e.g., a low boiling point alcohol as herein described). In an embodiment, the linear ionomeric polymer (e.g., sPPB-H⁺) is at least about 97% dispersed in the combination of water and an alcohol (e.g., a low boiling point alcohol as herein described).

In an embodiment, the combination of sPPB-H⁺ and branched and/or hyperbranched polymer is at least about 97% dispersed in an alcohol (e.g., a low boiling point alcohol as herein described), or at least about 97% dispersed in the combination of an alcohol (e.g., a low boiling point alcohol as herein described) and water, for example when the amount of branching is about 0.5 mol %. In an embodiment, the combination of sPPB-H⁺ and branched and/or hyperbranched polymer is at least about 90% dispersed in an alcohol (e.g., a low boiling point alcohol as herein described), or at least about 90% dispersed in the combination of an alcohol (e.g., a low boiling point alcohol as herein described) and water, for example when the amount of branching is about 1 mol %. In an embodiment, the combination of sPPB-H⁺ and branched and/or hyperbranched polymer is partially dispersed (e.g., less than about 90%, less than about 80%, less than about 70%, less than about 60%, less than about 50%, less than about 40%, less than about 30%, or about 33%) in an alcohol (e.g., a low boiling point alcohol as herein described), or is partially dispersed (e.g., less than about 90%, less than about 80%, less than about 70%, less than about 60%, less than about 50%, less than about 40%, less than about 30%, or about 33%) in the combination of an alcohol (e.g., a low boiling point alcohol as herein described) and water, for example when the amount of branching is about 2 mol % or higher. In some embodiments, the polar solvent can include water, alcohols (e.g. methanol, ethanol, n-propanol, isopropanol, n-butanol, tert-butanol), ketones (acetone, methyl ethyl ketone, methyl isobutyl ketone). In some embodiments, the polar solvent is a low boiling point alcohol. A low boiling point alcohol can comprise a boiling point below 120° C., below 100° C., below 90° C., below 85° C., below 80° C., below 70° C., between about 60° C. and about 80° C., or between about 60° C. and about 85° C. Examples of low boiling point alcohols include methanol, ethanol, isopropanol, n-propanol, tert-butanol, n-butanol, and the like. In a preferred embodiment, the alcohol is methanol or isopropanol.

In some embodiments, the polar solvent comprises an alcohol, a ketone, water, or a combination thereof. In some embodiments, the polar solvent comprises a combination of more than one component, such as alcohol and water; more than one different alcohols and water; or one or more of the same or different alcohols, one or more of the same or different ketone, and water. In embodiments wherein the polar solvent comprises alcohol and water, the composition of the polar solvent can be about a 1:1 volume-to-volume ratio of water to alcohol(s), about a 1:2 volume-to-volume ratio of water to alcohol(s), about a 1:3 volume-to-volume ratio of water to alcohol(s), about a 1:4 volume-to-volume ratio of water to alcohol(s), about a 1:2.5 volume-to-volume ratio of water to alcohol(s), or about a 1:3.5 volume-to-volume ratio of water to alcohol(s).

In some embodiments, the amount of linear ionomeric polymer added is an amount which enables the branched or hyperbranched ionomeric polymer to disperse into the polar solvent.

In some embodiments, the branched or hyperbranched ionomeric polymer can be present in the catalyst ink formulation at an amount of from about 0.01 wt % to about 10 wt % of total solids content.

The amount of the linear ionomeric polymer can be less than, equal to, or greater than the amount by mass of the branched or hyperbranched ionomeric polymer used. For example, the ratio of the mass of the linear ionomeric polymer to the mass of the branched ionomeric polymer can be between about 1:2 to about 3:1, between about 1:1 to about 2:1, between about 1.8:1 to about 2.2:1, between about 1.9:1 to about 2.1:1, or about 2:1. In an embodiment, the ratio of the mass of the linear ionomeric polymer to the mass of the branched ionomeric polymer is about 2:1.

The branched or hyperbranched ionomeric polymer, in combination with the linear ionomeric polymer, can be present in the polar solvent from about 0.01% w/v to about 35% w/v, about 0.01% w/v to about 30% w/v, about 0.01% w/v to about 25% w/v, about 0.01% w/v to about 20% w/v, about 0.01% w/v to about 15% w/v, about 0.01% w/v to about 10% w/v, about 0.01% w/v to about 5% w/v, less than about 20% w/v, or less than about 10% w/v.

In an embodiment, the catalyst ink formulation comprises an amount of branched or hyperbranched ionomeric polymer, and an amount of linear ionomeric polymer, wherein the total amount of the branched, hyperbranched, and linear ionomeric polymer dispersed in the polar solvent is of from about 0.1% w/v to about 25% w/v.

At higher concentrations than the foregoing, stability of the dispersion comprising the insoluble branched or hyperbranched ionomeric polymer can suffer. This can inhibit incorporation of the branched or hyperbranched ionomer into the catalyst ink formulation, and inhibit effective incorporation into polymer membranes, thereby reducing electrical properties and advantages to power density, as described in detail in the Examples below.

Examples of anionic polyphenylene monomers, oligomers, and polymers are provided below. Example 1 describes the controlled synthesis of sulfonated comonomers and their utility in synthesizing sulfonated branched oligophenylenes, as well as the hyperbranched ionomeric polymer (HB-sPPT-H⁺), both with precise control over the position and number of sulfonate groups.

In an embodiment, the branched and/or hyperbranched ionomeric polymers described herein can be incorporated into an ionomeric polymer membrane.

An ionomeric polymer membrane can comprise a mechanical reinforcement, and an ionomeric binder coupled to the mechanical reinforcement.

An ionomeric polymer membrane can comprise a substrate, and an ionomeric binder coupled to the substrate.

The ionomeric binder can be coupled to the mechanical reinforcement or substrate, directly or indirectly, through covalent bonding, ionic bonding, hydrogen-bonding, Van der Waals forces, and/or metallic bonding.

The mechanical reinforcement or substrate can comprise a porous polymeric material. The porous polymeric material can be any polymeric material comprising pores. The porous polymeric material can be, for example, a linear sulfonated phenylated poly(phenylene) ionomer, such as a linear sulfonated phenylated poly(phenylene) biphenyl (sPPB-H⁺) ionomer of Formula (IX), and/or expanded polyethylene (ePE).

In an embodiment, the ionomeric binder can comprise a branched ionomeric polymer of Formula (I), or a hyperbranched ionomeric polymer of Formula (I), and all iterations disclosed herein. The branched or hyperbranched ionomeric polymer of the ionomeric binder can comprise an amount of from about 0.5 wt % to about 99 wt %, about 0.5 wt % to about 50 wt %, about 0.5 wt % to about 25 wt %, or about 0.5 wt % to about 15 wt %.

In an embodiment, the ionomeric binder can further comprise a linear ionomer. For example, the linear ionomeric polymer of the ionomeric binder is a linear sulfonated phenylated poly(phenylene) biphenyl (sPPB-H⁺) ionomer, a random copolymer comprising sPPB-H⁺ and a hydrophobic unit, a PFSA material, or a combination thereof.

In an embodiment, the amount of linear ionomer of the ionomeric binder can be less than, equal to, or greater than the amount by mass of the branched or hyperbranched ionomeric polymer used. For example, the ratio of the mass of the linear ionomeric polymer to the mass of the branched ionomeric polymer can be between about 1:1 to about 3:1, between about 1:1 to about 2:1, between about 1.8:1 to about 2.2:1, between about 1.9:1 to about 2.1:1, or about 2:1. In an embodiment, the ratio of the mass of the linear ionomeric polymer to the mass of the branched ionomeric polymer is about 2:1.

In an embodiment, the branched or hyperbranched ionomer of the ionomeric binder is present in an amount of from about 0.5 wt % to about 10 wt %, and the linear sPPB-H⁺ ionomer of the ionomeric binder is present in an amount of about equal to or greater in mass than the branched or hyperbranched ionomer of the ionomeric binder.

The ionomeric binder can comprise a combination of branched and hyperbranched ionomeric polymer without linear ionomeric polymer; a combination of linear and hyperbranched ionomeric polymer without branched ionomeric polymer; or a combination of branched and linear ionomeric polymer without hyperbranched ionomeric polymer.

The catalyst layer described herein can be applied to an ionomeric polymer membrane to form a catalyst-coated ionomeric polymer membrane.

In an embodiment, the ionomeric polymer membrane described herein can further comprise a catalyst layer, to form a catalyst-coated ionomeric polymer membrane, wherein the catalyst layer is in contact with the ionomeric polymer membrane.

The catalyst layer, or the components of the catalyst layer, can be in contact with the mechanical reinforcement of the ionomeric polymer membrane, with the ionomeric binder of the ionomeric polymer membrane, or both the mechanical reinforcement and the ionomeric binder of the ionomeric polymer membrane. The catalyst layer, or the components of the catalyst layer, can be in contact with the substrate of the ionomeric polymer membrane, with the ionomeric binder of the ionomeric polymer membrane, or both the substrate and the ionomeric binder of the ionomeric polymer membrane.

The catalyst layer can be formed from a catalyst ink. The catalyst layer can be formed from the catalyst ink formulation herein described above and below. Formation of the catalyst layer can comprise applying the catalyst ink formulation and subsequently removing the solvent. Formation of the catalyst layer can comprise printing using the catalyst ink formulation.

The catalyst layer comprises the catalyst ink composition with at least about 90% of the solvent removed, at least about 95% of the solvent removed, at least about 97% of the solvent removed, at least about 99% of the solvent removed, essentially all detectable solvent removed, or about 97% of the solvent removed. In an embodiment, about 97% of the solvent from the catalyst ink formulation has been removed in forming the catalyst layer.

The solvent of the catalyst ink formulation can be removed by techniques known in the art for solvent removal (e.g., ambient temperature and pressure evaporation, elevated pressure or temperature evaporation, extraction of the solvent, filtration, absorption, etc.).

The catalyst layer can comprise a catalyst such as a platinum on carbon supports (i.e., Pt/C) of various Pt particulate sizes in combination with carbon materials of various surface areas and sizes; Pt alloys on carbon supports (e.g., PtCo/C) of various precious metal alloy particulate sizes and alloy ratios in combination with carbon materials of various surface areas and sizes; or M-N—C catalysts, incorporating non-precious-metal ions (e.g., wherein M is iron or cobalt) within a nitrogen-doped carbon support. The catalyst-coated ionomeric polymer membrane can comprise Pt/C, PtCo/C, M-N—C catalyst, or a combination thereof.

The catalyst layer can further comprise additives.

The catalyst layer can comprise a combination of a catalyst; branched ionomeric polymer, hyperbranched ionomeric polymer, linear ionomeric polymer, or a combination thereof; and additives. The catalyst layer can further comprise residual solvent.

As used herein, the catalyst layer ionomeric polymer can comprise a branched ionomeric polymer, hyperbranched ionomeric polymer, linear ionomeric polymer, or a combination thereof.

The amount of catalyst, branched ionomeric polymer, hyperbranched ionomeric polymer, and linear ionomeric polymer in the catalyst layer comprise from about 50 wt % to about 100 wt % of the total weight of the catalyst layer.

The catalyst layer catalyst and catalyst layer ionomeric polymer can comprise at least 90 wt % of the catalyst layer, the catalyst and ionomeric polymer can comprise at least 94 wt % of the catalyst layer, the catalyst and ionomeric polymer can comprise at least 95 wt % of the catalyst layer, the catalyst and ionomeric polymer can comprise at least 96 wt % of the catalyst layer, the catalyst and ionomeric polymer can comprise at least 97 wt % of the catalyst layer, or the catalyst and ionomeric polymer can comprise at least 98 wt % of the catalyst layer.

The catalyst layer can comprise about 10 wt % to about 30 wt % of ionomeric polymer, and about 70 wt % to about 90 wt % of catalyst.

The ionomeric binder of the ionomeric polymer membrane can comprise at least 50 wt % of the weight of the ionomeric polymer membrane, at least 60 wt % of the weight of the ionomeric polymer membrane, at least 70 wt % of the weight of the ionomeric polymer membrane, at least 80 wt % of the weight of the ionomeric polymer membrane, at least 90 wt % of the weight of the ionomeric polymer membrane, or about 60 wt % to about 90 wt % of the weight of the ionomeric polymer membrane.

The linear ionomer of the ionomeric binder can comprise about 0 wt %, 1 wt %, about 5 wt %, about 10 wt %, about 15 wt %, about 20 wt %, about 25 wt %, or about 30 wt %. In an embodiment, a linear sPPB-H⁺ ionomer of the ionomeric binder can comprise about 15 wt % of the weight of the ionomeric binder.

The branched and/or hyperbranched ionomeric polymer of the ionomeric binder can comprise an amount of from about 0.5 wt % to about 25 wt % of the weight of the ionomeric binder, or of from about 0 wt % to about 25 wt % of the weight of the ionomeric binder.

The linear ionomeric polymer of the ionomeric binder is present in an amount of about equal to or greater than the amount of the branched or hyperbranched ionomeric polymer of the ionomeric binder.

Optimization of the wt % of linear ionomer is discussed in more detail in Examples 1-4, and as such, the composition of the ionomeric binder can be guided by the stability of the ionomeric polymer membrane, which includes branched or hyperbranched ionomeric polymers (e.g., reducing delamination of catalyst layers from substrate).

In an embodiment of the branched or hyperbranched ionomeric polymer membrane, the substrate or mechanical reinforcement, the ionomeric binder, and the catalyst layer are essentially free of halogens. “Essentially free” as used herein, means the branched or hyperbranched ionomeric polymer membrane, the ionomeric binder, and the catalyst layer each comprise less than about 1% of halogens, less than about 0.5% of halogens, less than about 0.01% of halogens, or less than about 0.001% halogens. Some measurable level of halogens can be introduced during operation, for example, as a halide salt (e.g., NaCl), as a synthetic or processing impurity, or as a trace gas.

The ionomeric polymer membrane can have a top surface and a bottom surface, such as would exist in a formation such as a sheet, including a sheet which is rolled, folded, or distorted in another manner.

The catalyst layer can be in contact with only the top surface of the ionomeric polymer membrane, only the bottom surface of the ionomeric polymer membrane, or both the top and bottom surface of the ionomeric polymer membrane.

When the catalyst layer is in contact with only the top surface or only the bottom surface of the ionomeric polymer membrane, a bi-layer is formed. The bi-layer can be used as a two-layered membrane electrode assembly.

When the catalyst layer is in contact with both the top surface and the bottom surface of the ionomeric polymer membrane, a tri-layer is formed. The tri-layer can be used as a three-layered membrane electrode assembly.

A bi-layered or tri-layered catalyst-coated ionomeric polymer membrane can be in a form which is planar, such as a sheet. The sheet can be planar, rolled, folded, or distorted in another manner. For example, the catalyst-coated ionomeric polymer membrane can be a sheet which is rolled up, to form a roll which can have dimensions such as 30 cm wide by a length such as 1 to 1000 meters, or a length such as 10 to 100 meters.

In an embodiment, the catalyst layer of the catalyst-coated ionomeric polymer membrane can act as an anode or a cathode. When only one surface of the ionomeric polymer membrane is in contact with the catalyst layer, the catalyst layer is either an anode or a cathode. When both surfaces of the ionomeric polymer membrane are in contact with a catalyst layer, one catalyst layer is an anode and the other catalyst layer is a cathode.

Generally, the anode is the electrode wherein oxidation occurs during an electrochemical reaction. The cathode is the electrode wherein reduction occurs during an electrochemical reaction.

Whether a catalyst layer is an anode or a cathode can be determined by the orientation of the catalyst layer in a product such as a fuel cell. Whether a catalyst layer is an anode or a cathode can be determined by the combination of the orientation of the catalyst layer in a fuel cell and the amount of catalyst present. In a fuel cell, the anode is the electrode where the fuel, such as hydrogen (H₂), is oxidized, releasing electrons and protons (H⁺). The electrons are then drawn through an external circuit to perform useful work, while the protons (H⁺) migrate through an electrolyte to the cathode. In a fuel cell, the cathode is the electrode where oxygen (O₂) is reduced, combining with protons (H⁺) from the electrolyte to form water (H₂O).

In an electrolyzer, an anode is the electrode wherein water (H₂O) is oxidized through an electrochemical reaction to produce oxygen (O₂), protons (H⁺), and electrons (e⁻).

In an electrolyzer, the cathode is the electrode wherein protons (H⁺) are reduced via electrochemical reaction to produce hydrogen gas (H₂).

The branched or hyperbranched ionomeric polymer membrane can have a proton conductivity (e.g., ex situ conductivity, in-plane) of from about 0.001 mS cm⁻¹ to about 1000 mS cm⁻¹, from about 0.001 mS cm⁻¹ to about 750 mS cm⁻¹, from about 0.001 mS cm⁻¹ to about 450 mS cm⁻¹, from about 1 mS cm⁻¹ to about 1000 mS cm⁻¹, of more than about 0.001 mS cm⁻¹, of more than about 1 mS cm⁻¹, or of less than about 1000 mS cm⁻¹, at a relative humidity of from 30% to 100% when measured using AC impedance spectroscopy (electrochemical impedance spectroscopy) at a temperature of between about 20° C. to about 90° C., or between about 50° C. to about 90° C. The ionic polymer membrane can have a proton conductivity (e.g., ex situ conductivity, in-plane) of from about 1 mS cm⁻¹ to about 1000 mS cm⁻¹, or about 50 mS cm⁻¹ to about 450 mS cm⁻¹ at about 80° C. in water when measured using AC impedance spectroscopy (electrochemical impedance spectroscopy).

A branched or hyperbranched ionomeric polymer as described herein can be incorporated into a catalyst layer of a fuel cell, an electrolyzer, or another electrochemical device. A fuel cell, an electrolyzer, or another electrochemical device can comprise a catalyst layer.

For example, the branched or hyperbranched ionomeric polymer can be incorporated into a catalyst layer of a fuel cell, an electrolyzer, or another electrochemical device in an amount of from about 5 wt % to about 45 wt % solids, from about 10 wt % to about 45 wt %, from about 15 wt % to about 45 wt %, from about 30 wt % to about 45 wt %, from about 5 wt % to about 30 wt %, from about 15 wt % to about 45 wt %, from about 30 wt % to about 45 wt %, from about 10 wt % to about 30 wt %, from about 10 wt % to about 20 wt %, or from about 15 wt % to about 30 wt % in the catalyst layer.

In some embodiments, the branched or hyperbranched ionomeric polymer of the present disclosure is incorporated into a cation exchange resin.

The branched or hyperbranched ionomeric polymers described herein can exhibit a mass loss of less than about 20% or less than about 10% when exposed to Fenton's reagent at a temperature of 80° C., at 1 atm, and for a duration of from greater than 0, to 180 minutes, or a duration of from greater than 0, to 90 minutes, or a duration of from greater than 0, to 60 minutes.

The branched or hyperbranched ionomeric polymers described herein can have an ion exchange capacity (IEC) of from about 2 to about 4.5 meq g⁻¹ or from about 2.9 to about 3.7 meq g⁻¹, when evaluated by acid-base titration, for example cation exchange of the acidic, or protonated, form (e.g., —SO₃—H⁺) membranes to their conjugate base sodium counterpart (e.g., —SO₃⁻Na⁺), by immersing samples in pH 7, 1 M NaCl solution for 48 h; then titrating the acidic form to pH 7 using a standardized titrant (e.g., 0.01 M NaOH solution, Sigma Aldrich). IEC can be calculated by using volume and molarity of titrant used, and dry mass of the sample being titrated. A person of ordinary skill in the art would understand that titration can also be performed with other bases (e.g. KOH solution), and the counterion cations can be exchanged, for example by exposure of a sulfonate sodium salt with, for example, KCl to result in complete or partial potassium salt (e.g., —SO₃—K⁺) formation.

### EXAMPLES

### Example 1

### Non-Conformal Particles of Hyperbranched Sulfonated Phenylated Poly(phenylene) Ionomers as Proton-Conducting Pathways in PEMFC Catalyst Layers

Characteristic poor electrochemical kinetics, high ionic resistance, and high mass transport resistance within a catalyst layer (CL) are chief among parameters that cause poor performance of proton exchange membrane fuel cells (PEMFCs) utilizing hydrocarbon-based proton-conducting ionomers.

Within a catalyst ink, Pt-supported carbon catalyst particles coalesce into agglomerates including primary pores having a diameter from about 1 nm to about 30 nm. Upon deposition to form anode and cathode CLs, the agglomerates aggregate into larger aggregates and form larger secondary pores from about 20 nm to about 200 nm in diameter. Secondary pores facilitate diffusion of gases and transport of water within the CL, as described by agglomerate models. Polyelectrolytes, such as perfluorosolfonic acid (PFSA) ionomer, typically referred to by the trademark Nafion®, are also included in the ink dispersion to encapsulate and bind the Pt/C agglomerates, providing proton conductive pathways within the CL.

A thin coating of ionomer can introduce an O₂ permeation barrier between interstitial void space and catalyst particles within the primary pores and on the surface of the secondary pore structure. The permeation barrier introduces mass transport resistances that cannot be explained by the agglomerate model alone. As a result, there has been intense research effort in understanding the O₂ permeation through thin ionomer films, the effect of chemical nature of the ionomer, the impact of porosity of the support, and the influence of catalyst ink composition on mass transport limitations within the CL.

Herein, the design and addition of non-dimensionally swellable, non-conformal, hyperbranched sulfo-phenylated poly(phenylene) ionomer particles (HB-sPPT-H+) is reported to introduce a direct pathway for proton conduction in hydrocarbon ionomer-based CLs, resulting in an eightfold reduction in ionic resistance of the CL, a 71% increase in catalyst mass activity, and a >90% increase in power at 0.6 V (H₂/air) compared to state-of-the-art hydrocarbon ionomer-based CLs.

The benefits of incorporating HB− sPPT− H+ ionomer particles are also shown when employed in perfluorosulfonic acid (PFSA) ionomer-based PEMFCs. These results dispel a commonly-held conception that hydrocarbon ionomers possess limitations of gas permeability and electrochemical activity, and open up previously unexplored avenues of ionomer development for non-fluorous, wholly-hydrocarbon PEMFCs.

Previously-made hydrocarbon substitutes include aromatic units with inherently greater thermochemical resilience. Unlike PFSAs, polyaromatic and polyheterocyclic polymers can be synthesized in a typical organic polymer chemistry laboratory from readily available synthetic chemical feedstocks. Hydrocarbon ion-conducting polymers exhibit relatively low gas permeability in comparison to PFSAs, and hence lower gas crossover when used as a proton exchange membrane (PEM).

Sulfonated poly(arylene ether)s and sulfo-phenylated polyphenylene ionomers can exhibit improved chemical stability relative to PFSAs. In an illustrative example, a biphenyl comonomer (sPPB-H⁺) provides improved stability at a cost of reduced ion conductivity.

Cross-linking and molecular branching of sPPB-H⁺ were also explored as methods to reduce dimensional swelling and improve the mechanical integrity of this class of hydrocarbon ionomers when cast as PEMs. A notable observation was that with lower water uptake, conductivity increased with these materials, suggesting that the increase in proton concentration outweighed any reduction in proton mobility. However, with an excessive degree of branching, the ionomer was insoluble and not suited for PEM formation.

A fully hydrocarbon-based MEA obtained an output power of greater than 1.5 Wcm⁻² (under H₂/O₂, atmospheric pressure), using a linear sPPB-H⁺ as both PEM and a binder for the CL. Notably, it was observed that the performance of this class of hydrocarbon ionomer exceeded that of Nafion® in the mass transport region of a fuel cell polarization plot, owing to high CL porosity. However, the ionic resistance within the hydrocarbon-based CL was three times greater than values reported for Nafion®-based CLs.

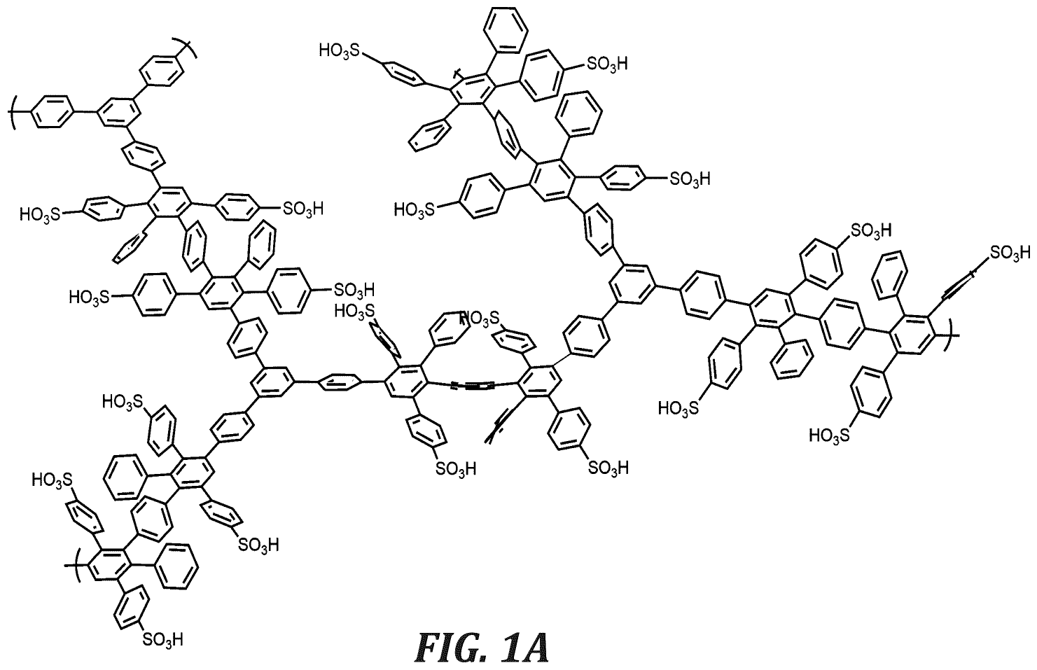

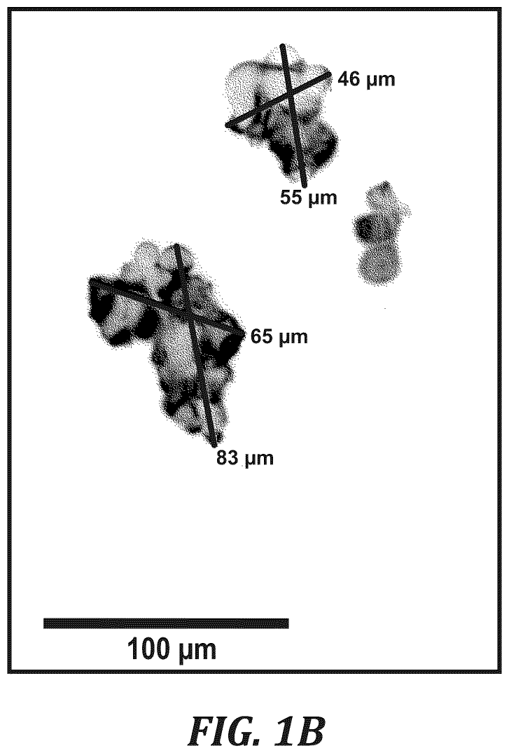

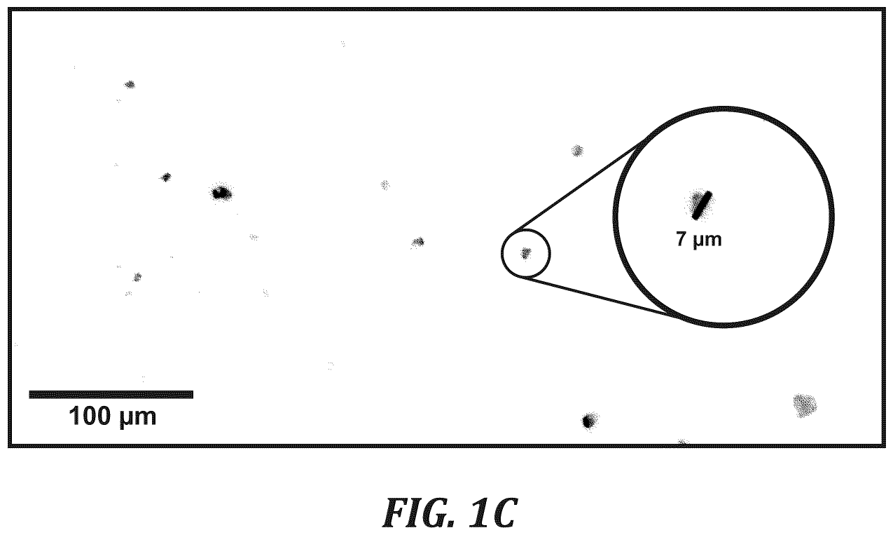

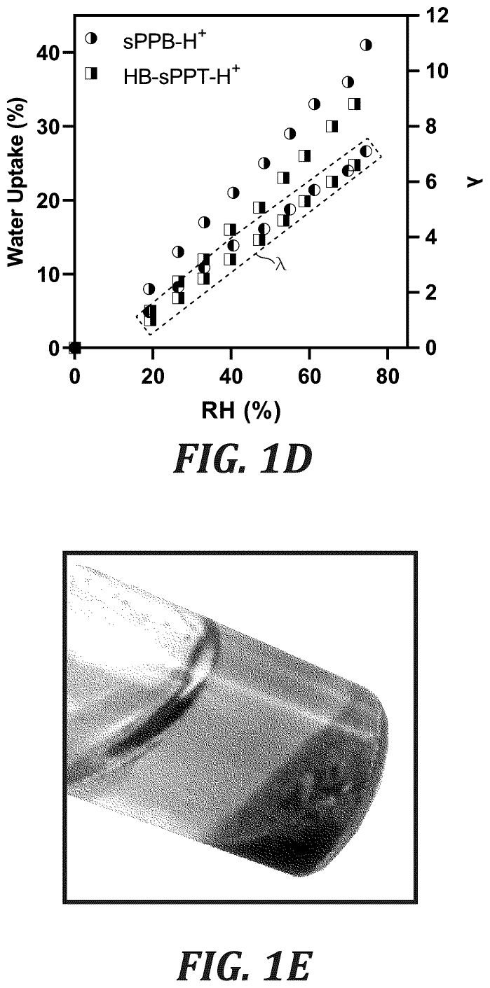

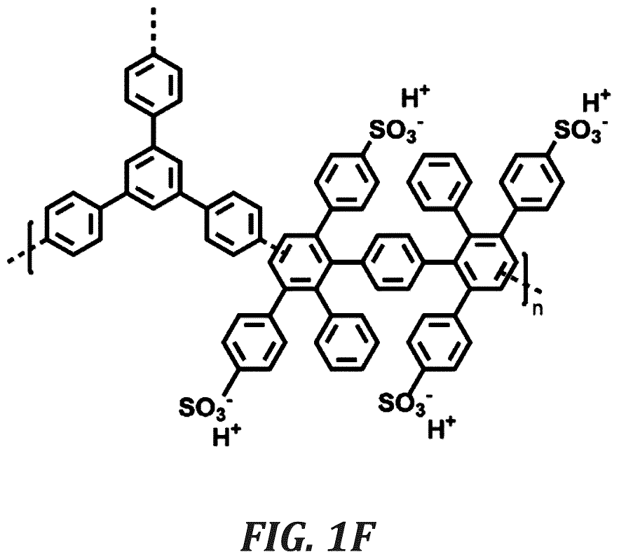

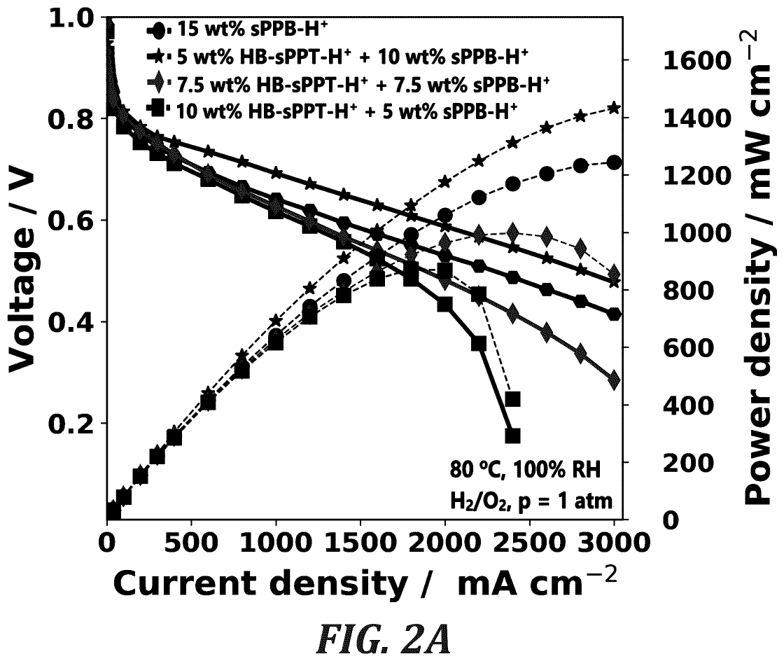

Inspired by the high anion exchange membrane fuel cell (AEMFC) performances achievable with insoluble radiation-grafted ETFE anion exchange materials used in AEMFC CLs, hyperbranched sulfonated polyphenylene with terphenyl comonomer (HB-sPPT-H⁺) particles can be included in the CL with the objective of reducing ionic resistances in the CL, as depicted in FIGS. 1A and 1F.

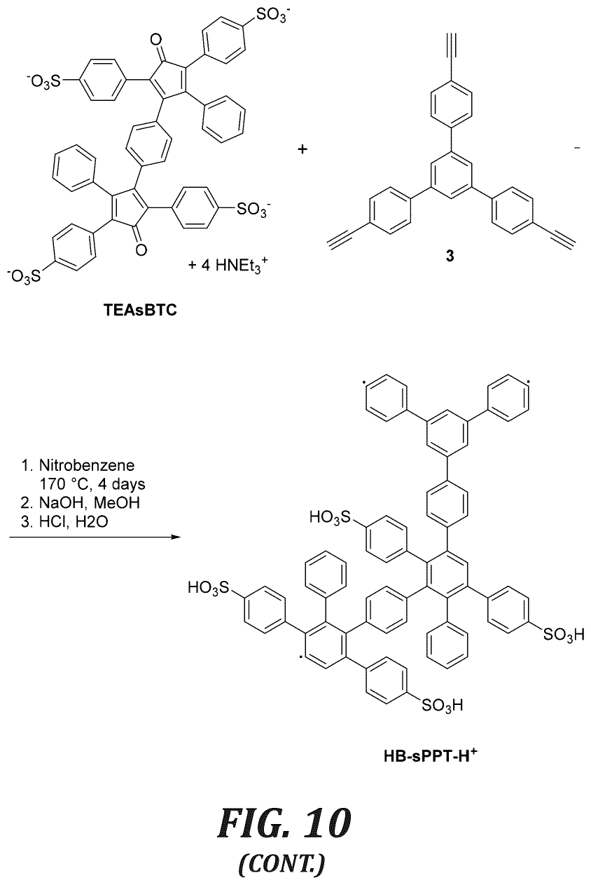

HB-sPPT-H⁺ was obtained through a [4+2] Diels-Alder cycloaddition between the bifunctional diene comonomer TEAsBTC and the trifunctional dienophile comonomer 1,3,5-tris-(4-ethynyl-phenyl)-benzene (3) prepared as shown in FIG. 10. The dienophile comonomer (3) was obtained via three-step synthesis starting from the cyclotrimerization of 4-iodoacetophenone reacted neat with paratoluenesulfonic acid to obtain the intermediate (1) with 82% yield. A Sonogashira coupling between the intermediate (1) and trimethylsilylacetylene was carried out to obtain the second intermediate product (2) with 92% yield after precipitation, which was used without further purification. A deprotection step of the silyl group in mild conditions (MeOH/K₂CO₃) was carried out to obtain (3) with a 73% yield after purification over a plug of silica. TEAsBTC and (3) were reacted together in Ar-degassed nitrobenzene by stirring for 5 days at 170° C. After completion of the polymerization, the precipitate formed was filtered to obtain HB-sPPT-NEt₃⁺. The synthesis scheme and subsequent exchange to the proton form (HB-sPPT-H⁺) is shown in FIG. 10. A 3D representation of the chemical structure of HB-sPPT-H⁺ is shown in FIG. 1A.

HB-sPPT-H⁺ powder exhibited a sand-like quality, as shown in FIG. 1E, even after stirring in common laboratory polar protic solvents, allowing it to be mechanically ground. Photographs of both as-precipitated HB-sPPT-H⁺ and the HB-sPPT-H⁺ used in catalyst ink preparation, obtained by UV optical microscopy, are shown in FIG. 1B. The size of the HB-sPPT-H⁺ particles was measured using ImageJ processing software, and found to be in the 30 to 100 micron range, but appear to be formed at least partially from agglomerates of smaller particles. Dispersal of agglomerates (e.g., by grinding, milling, etc) revealed smaller particles with a mean particle size of 7.0±2.1 μm, as shown in FIG. 1C.

The water uptake of HB-sPPT-H⁺ powder under different relative humidity at 80° C. was measured by dynamic vapor sorption (DVS) measurements and compared to linear sPPB-H⁺ ionomer. An exemplary structure of sPPB-H+ is illustrated in Formula (IX):

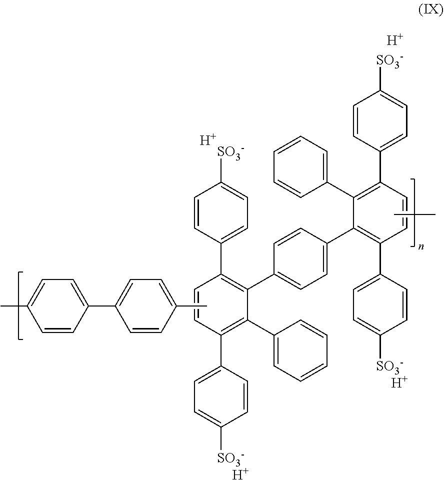

The resultant absorption isotherms are reported in FIG. 1D. At 75% RH, HB-sPPT-H⁺ has a slightly lower water uptake of 32 wt %, compared to linear sPPB-H⁺ (40 wt %). HB-sPPT-H⁺ shows no evidence of dimensional swelling and remains sand-like in boiling water, unlike membranes of linear sPPB-H⁺ which undergo dimensional swelling (145% in volume). Relatively low branching (≤2 mol %) of polymers can reduce water uptake but can increase proton conductivity when cast as membranes, which can result in an increase in conductivity for HB-sPPT-H⁺. However, due to its insolubility, the inherent ionic conductivity of particles was not measured.

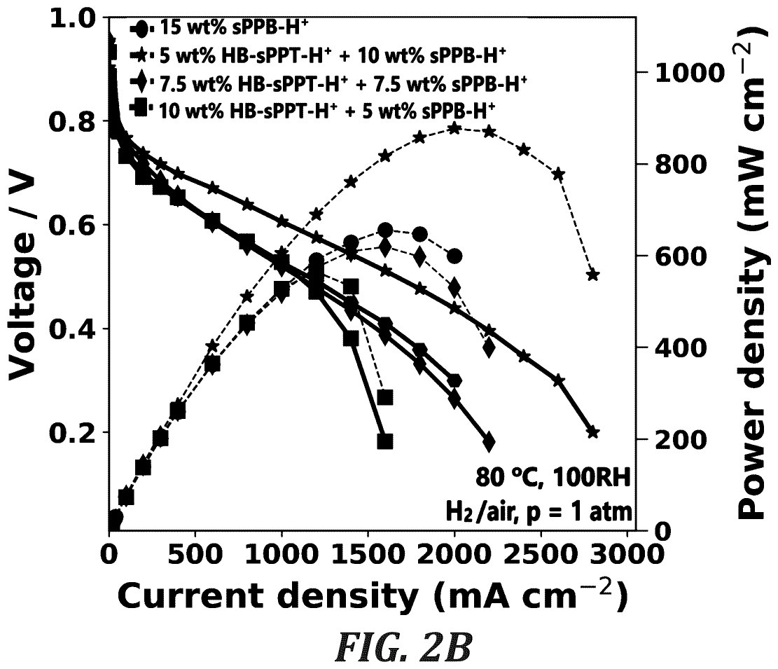

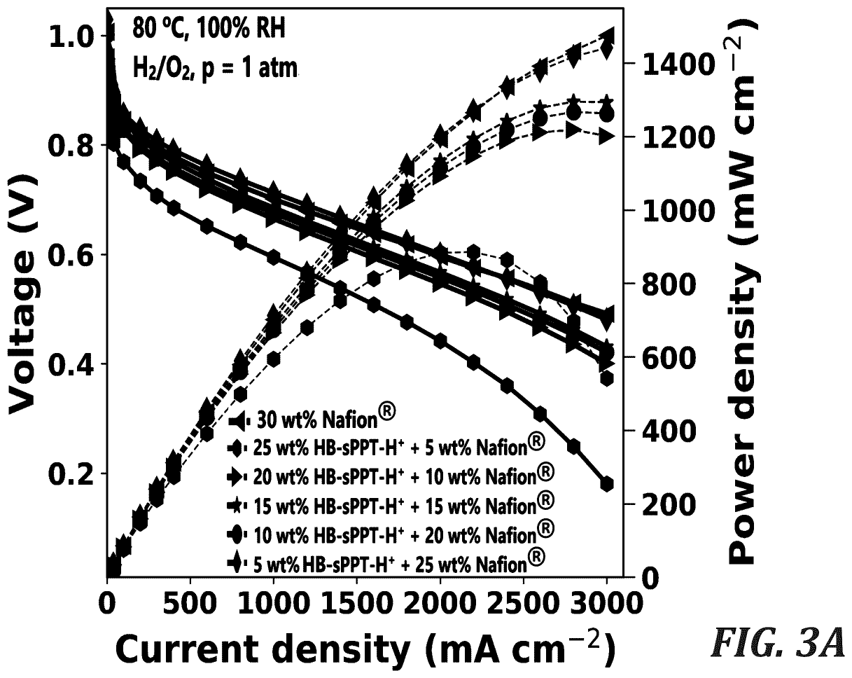

In-situ fuel cell electrochemical characterization was used to examine the impact of HB-sPPT-H⁺ on both hydrocarbon-based and PFSA-based catalyst coated membranes (CCMs). As HB-sPPT-H⁺ ionomer is insoluble in alcohols, use as the sole ionomer within CLs led to rapid delamination of the catalyst from the membrane, and non-functional CCMs. To circumvent this, HB-sPPT-H⁺ was used in conjunction with either linear sPPB-H⁺ ionomer or Nafion® ionomer. Ionomer content in linear sPPB-H⁺ CLs is typically 15 wt %, whereas it is typically 30 wt % ionomer for Nafion®. Therefore, the HB-sPPT-H⁺ to linear ionomer ratio was adjusted to these total wt %. Based on triplicate measurements of triplicate samples, FIGS. 2A and 2B show that a combination of 5 wt % HB-sPPT-H⁺+10 wt % linear sPPB-H⁺ yields the optimum power performance.

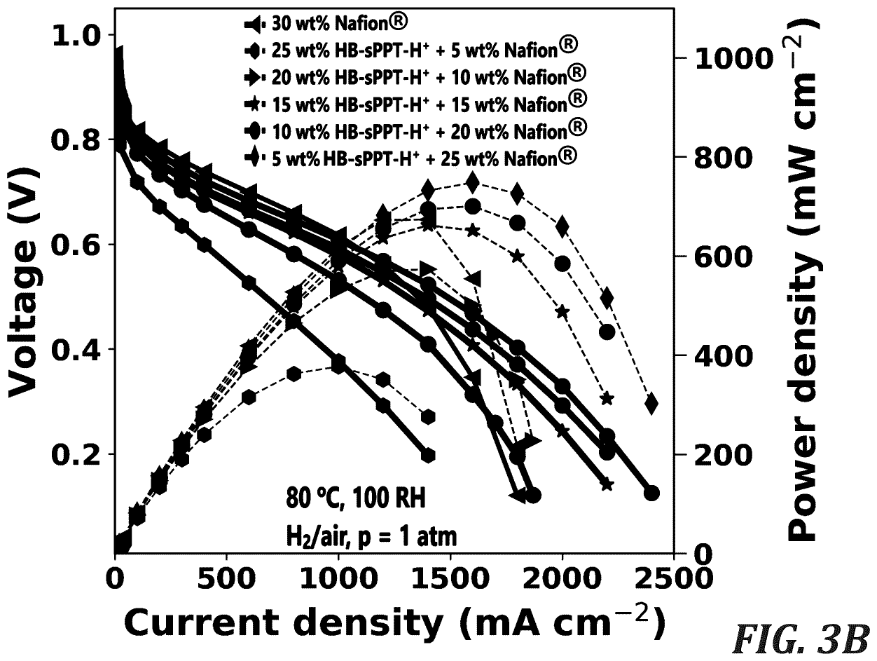

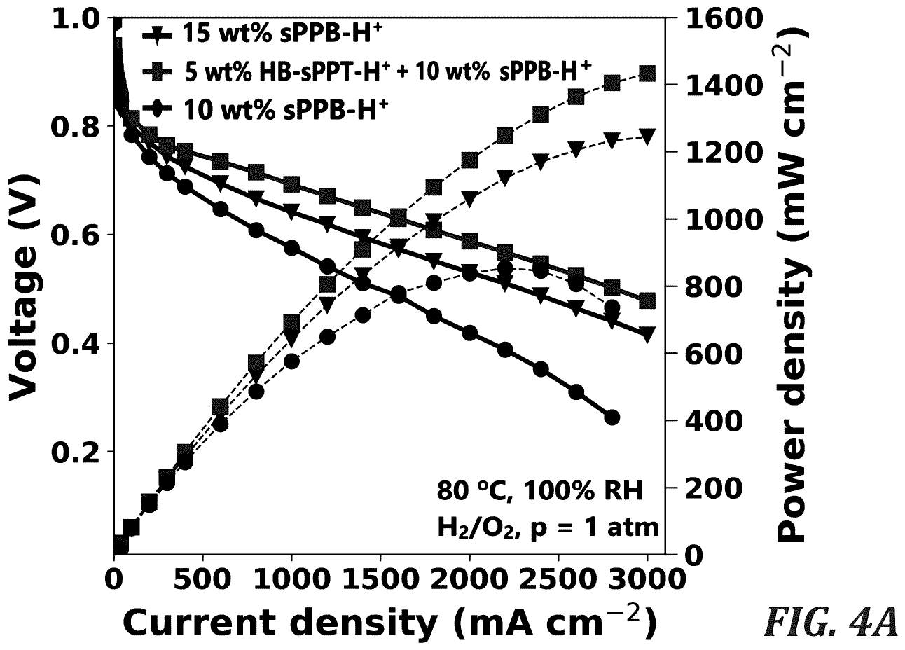

For the PFSA-based CCM shown in FIGS. 3A and 3B, an improved composition of 5 wt % HB-sPPT-H⁺+25 wt % Nafion® ionomer was generated.

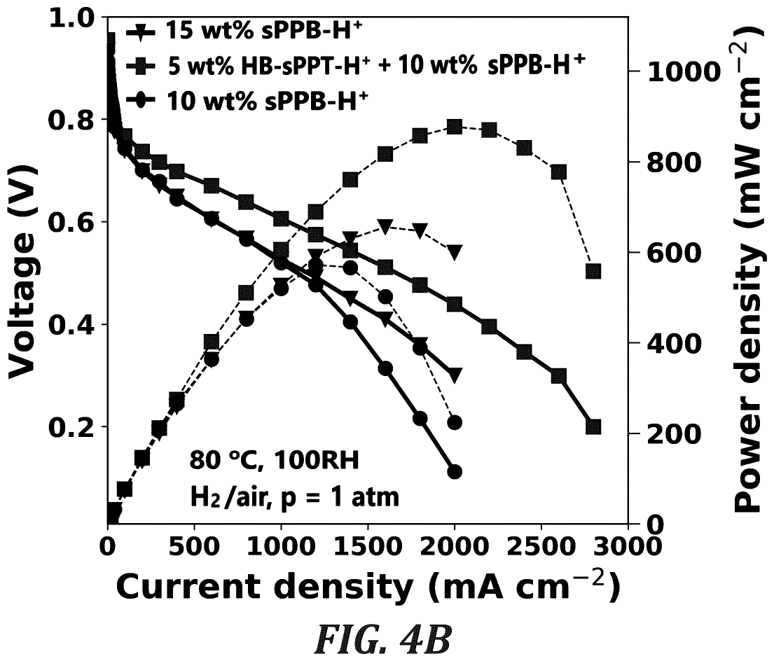

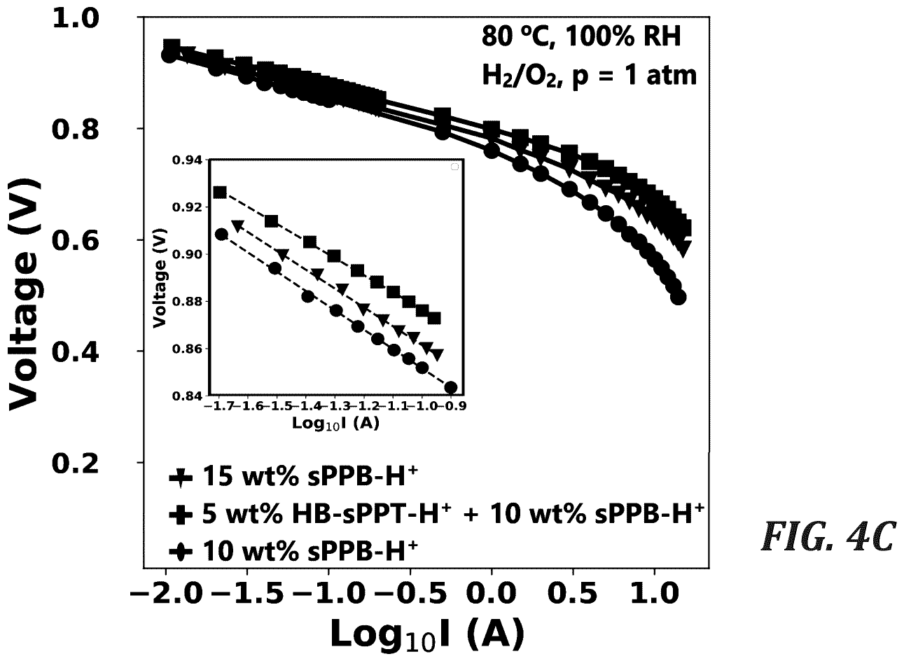

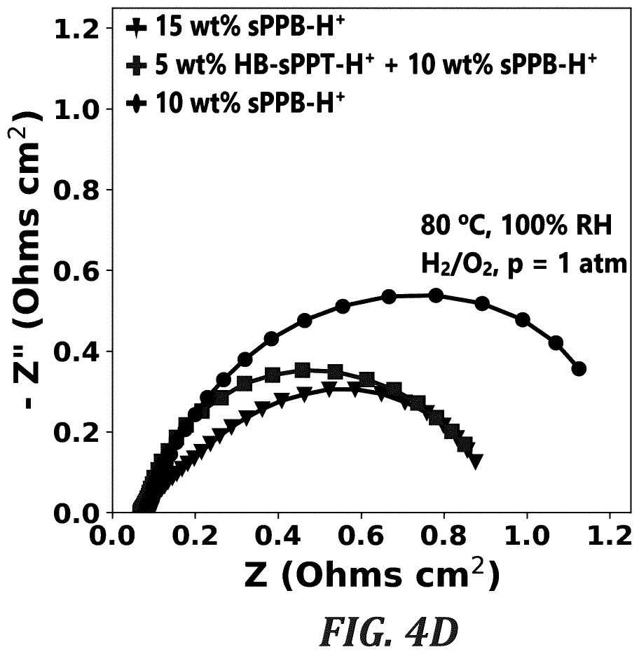

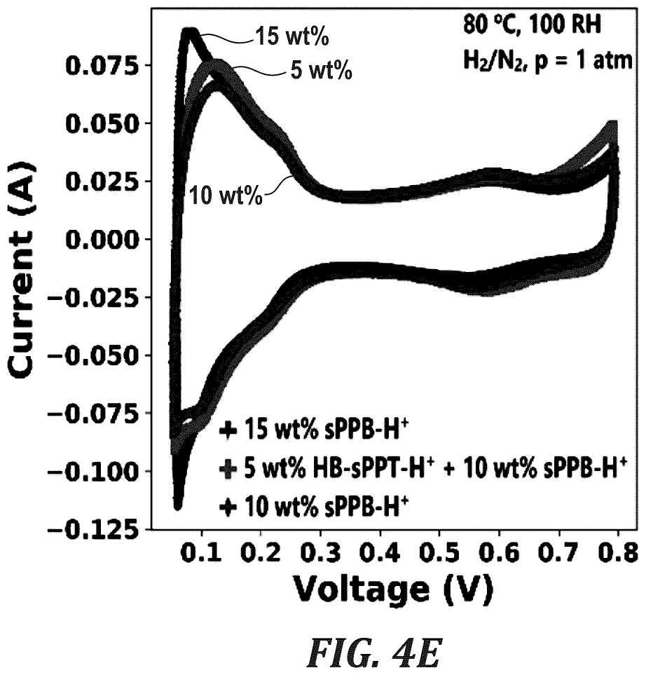

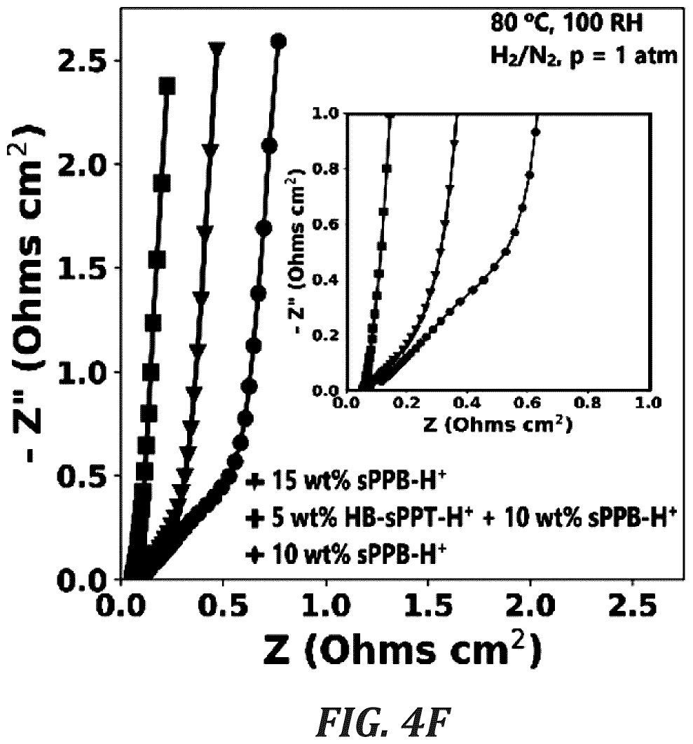

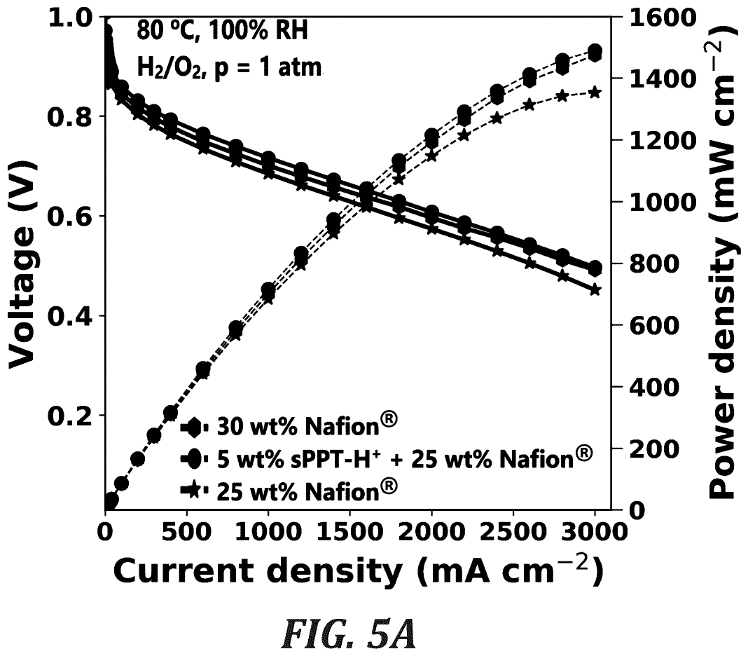

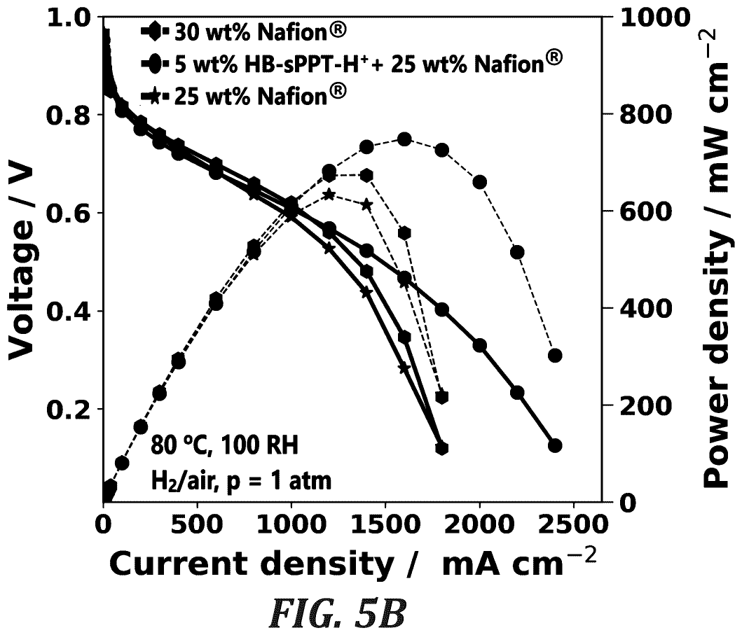

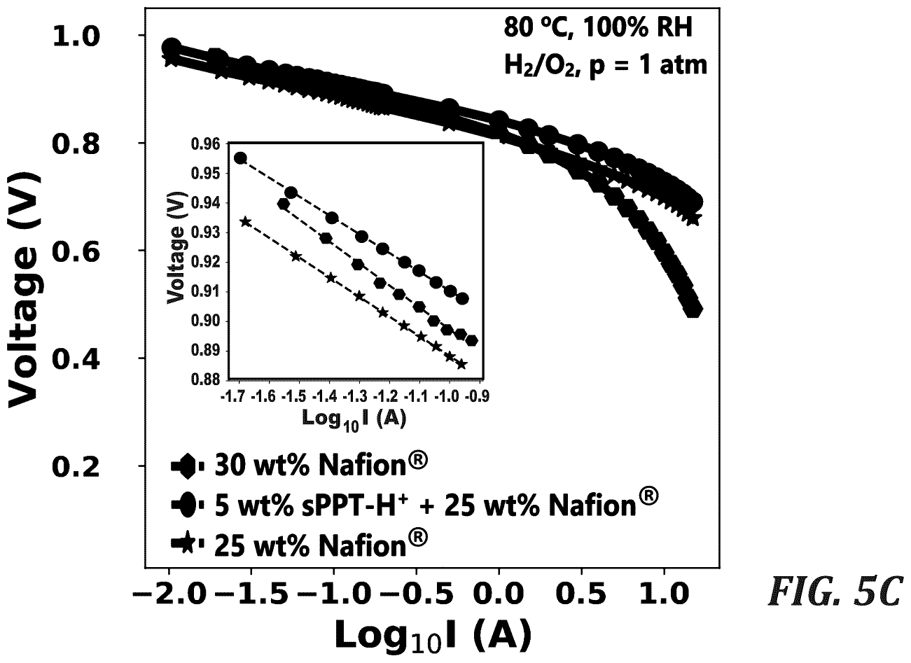

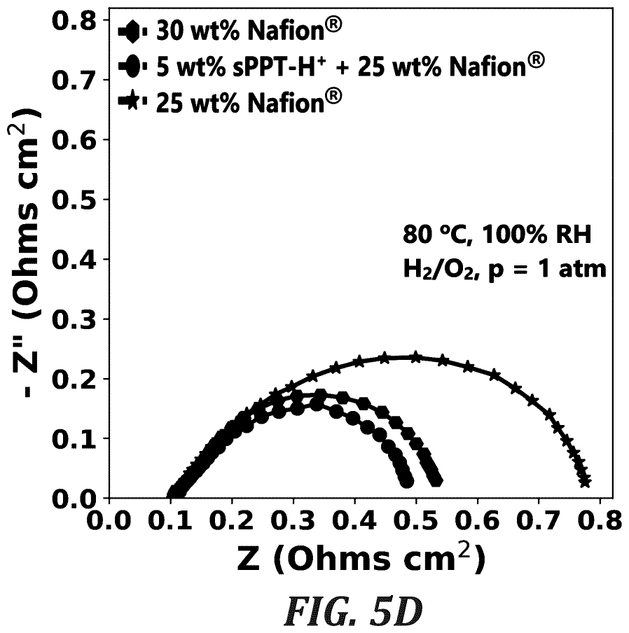

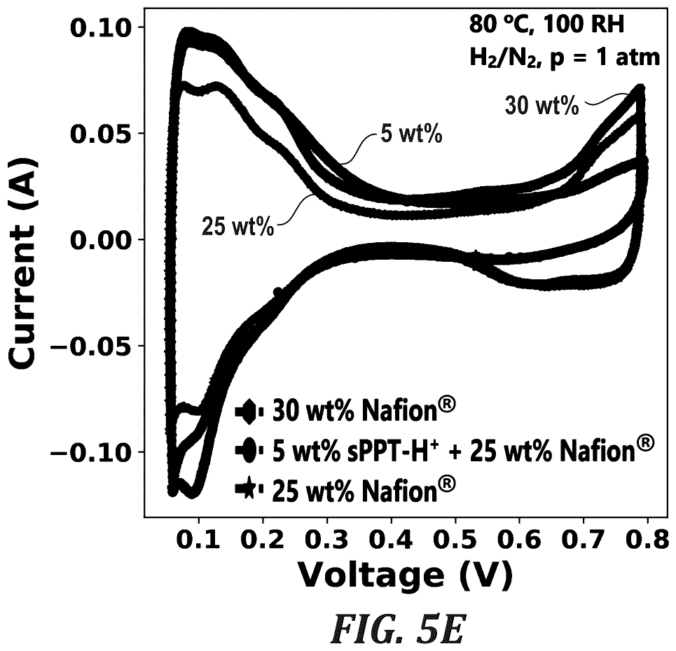

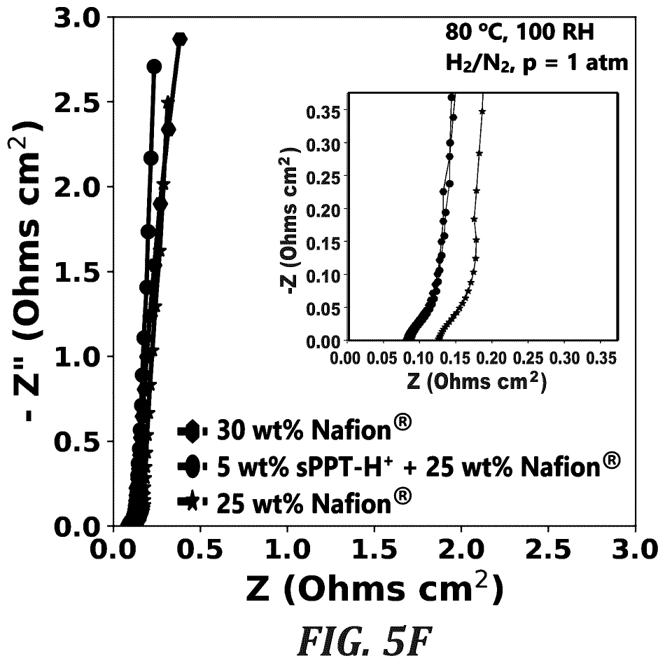

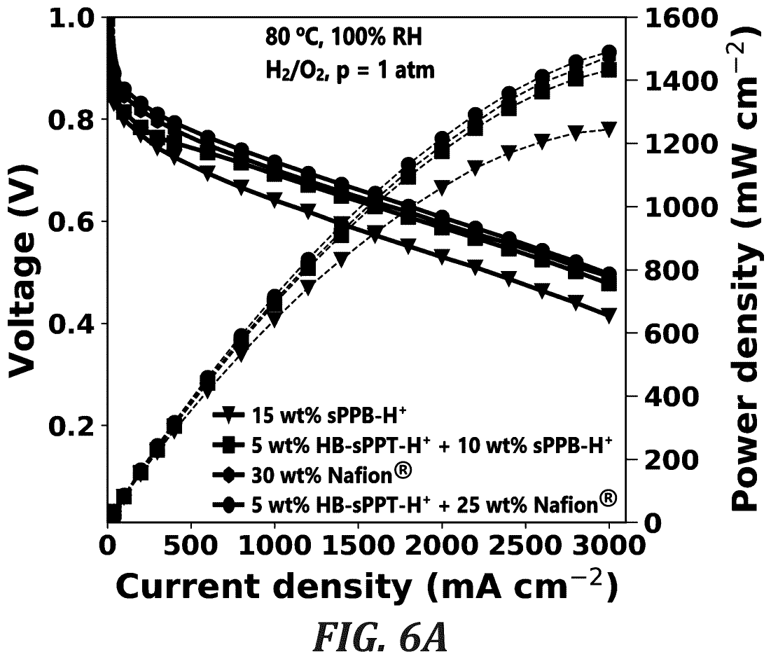

To show that performance enhancements are due to the additional HB-sPPT-H⁺ ionomer, and not because of the reduced mass of linear ionomer, comparisons to CLs containing 10 wt % linear sPPB-H⁺ and 25 wt % Nafion® ionomer are shown in FIGS. 4A-4F, FIGS. 5A-5F, and Tables 1 and 2 below.

TABLE 1
Fuel cell data of CCMs prepared with HB-sPPT-H⁺ and Linear sPPB-H⁺, and Nafion ® ionomers.

| | Membrane | | | | | |
|---|---|---|---|---|---|---|
| | SPPB-H⁺ | | | | | |
| | Ionomer in CL | | | | | |
| | 15 wt % | | 5 wt % HB-sPPT-H⁺ + | | | |
| | Linear sPPB- | | 10 wt % sPPB-H⁺ | | 10 wt % | |
| | (CCM1) | | (CCM 2) | | sPPB-H⁺ | |
| | O₂ | Air | O₂ | Air | O₂ | Air |
| Max. Power Density | 1240 ± 45 | 655 ± 30 | 1430 ± 60 | 876 ± 29 | 853 ± 32 | 572 ± 18 |
| (mW cm⁻²) ^{a} | | | | | | |
| Power density | 820 ± 25 | 356 ± 17 | 1050 ± 50 | 685 ± 29 | 478 ± 36 | 349 ± 29 |
| (mW cm⁻²) at 0.6 V ^{b} | | | | | | |
| Membrane thickness (μm) | 34 ± 4 | | 33 ± 5 | | 34 ± 3 | |
| OCV/V | s0.986 ± 0.007 | | 0.999 ± 0.005 | | 0.979 ± 0.009 | |
| Tafel slope | −80 ± 9 | | −74 ± 6 | | −82 ± 9 | |
| (mV dec⁻¹) ^{c} | | | | | | |

| | | | |
|---|---|---|---|
| I_{m(0.9 V)} (mA mg⁻¹_{Pt}) ^{d} | 17 ± 1 | 29 ± 5 | 10 ± 1 |
| I_{s(0.9 V)} (μA cm⁻²_{Pt}) ^{e} | 159 ± 45 | 283 ± 52 | 117 ± 45 |
| R_{ionic -CL} (mΩ cm²) ^{g} | 598 ± 57 | 73 ± 10 | 1421 ± 55 |
| ECSA (m² g⁻¹_{Pt}) ^{h} | 44 ± 4 | 41 ± 3 | 35 ± 4 |
| R_{HFR} (mΩ) ⁱ | 74 ± 6 | 72 ± 5 | 73 ± 4 |
| R_{ct (0.8 V)} (mΩ cm²) ^{j} | 885 ± 34 | 839 ± 19 | 1297 ± 47 |

^{a} = Peak power density on the power density curve,
^{b} = Power density corresponding to 0.6 V on the polarization curve,
^{c} = Tafel slope in mV per decade,
^{d} = Mass activity is derived from the effective current density (corrected for H₂ cross-over and ohmic loss) at 0.9 V and catalyst loading,
^{e} = Specific activity derived from the effective current density (corrected for H₂ cross-over and ohmic loss) at 0.9 V and ECSA,
f = Ionic resistance within the CL derived from the low-frequency resistance linear intercept with the x-axis equal under H₂/N₂,
^{g} = Electrochemical surface area determined by cyclic voltammograms,
^{h} = Intercept of the HFR with the x-axis under H₂/O₂,
ⁱ = Charge transfer resistance, the diameter of the Nyquist plot semi-circle under H₂.

TABLE 2
Fuel cell data of CCMs Hyperbranched sPPB-H⁺ and Nafion ® ionomers.

| | Membrane | | | | | |
|---|---|---|---|---|---|---|
| | NR- 211 | | | | | |
| | Ionomer in CL | | | | | |
| | | | 5 wt % HB- + | | | |
| | 30 wt % | | 25 wt % | | | |
| | Nafion ® | | Nafion ® | | 25 wt % | |
| | (CCM 3) | | (CCM 4) | | Nafion ® | |
| | O₂ | Air | O₂ | Air | O₂ | Air |
| Max. Power Density | 1470 ± 40 | 673 ± 30 | 1490 ± 47 | 748 ± 26 | 1356 ± 37 | 633 ± 31 |
| (mW cm⁻²) ^{a} | | | | | | |
| Power density | 1100 ± 55 | 640 ± 20 | 1215 ± 43 | 698 ± 24 | 995 ± 42 | 591 ± 23 |
| (mW cm⁻²) at 0.6 V ^{b} | | | | | | |

| | | | |
|---|---|---|---|
| Membrane thickness (μm) | 28 ± 2 | 27 ± 3 | 28 ± 2 |
| OCV/V | 1.01 ± 0.009 | 1.03 ± 0.006 | 0.998 ± 0.003 |
| Tafel slope (mV dec⁻¹) ^{c} | −73 ± 7 | −63 ± 7 | −66 ± 7 |
| I_{m(0.9 V)} (mA mg⁻¹_{Pt}) ^{d} | 57 ± 7 | 70 ± 5 | 51 ± 5 |
| I_{s(0.9 V)} (μA cm⁻²_{Pt}) ^{e} | 351 ± 68 | 424 ± 58 | 298 ± 40 |
| R_{ionic -CL} (mΩ cm²) ^{g} | 115 ± 13 | 98 ± 25 | 150 ± 20 |
| ECSA (m² g⁻¹_{Pt}) ^{h} | 62 ± 3 | 60 ± 3 | 52 ± 5 |
| R_{HFR} (mΩ) ⁱ | 64 ± 5 | 65 ± 5 | 62 ± 6 |
| R_{ct (0.8 V)} (mΩ cm²) ^{j} | 455 ± 26 | 421 ± 23 | 724 ± 39 |

Direct comparisons are made between the improved CCMs of: 15 wt % linear sPPB-H⁺ ionomer, (hereafter referred to as CCM 1), 5 wt % HB-sPPT-H⁺+10 wt % linear sPPB-H⁺ (CCM 2), 30 wt % Nafion® ionomer (CCM 3) and improved 5 wt % HB-sPPT-H⁺+25 wt % Nafion® ionomer based CCM (CCM 4).

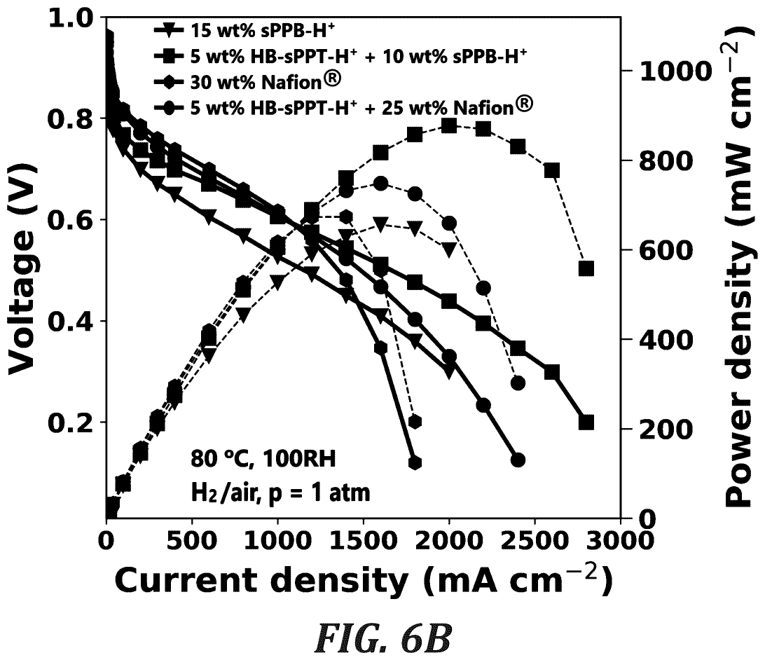

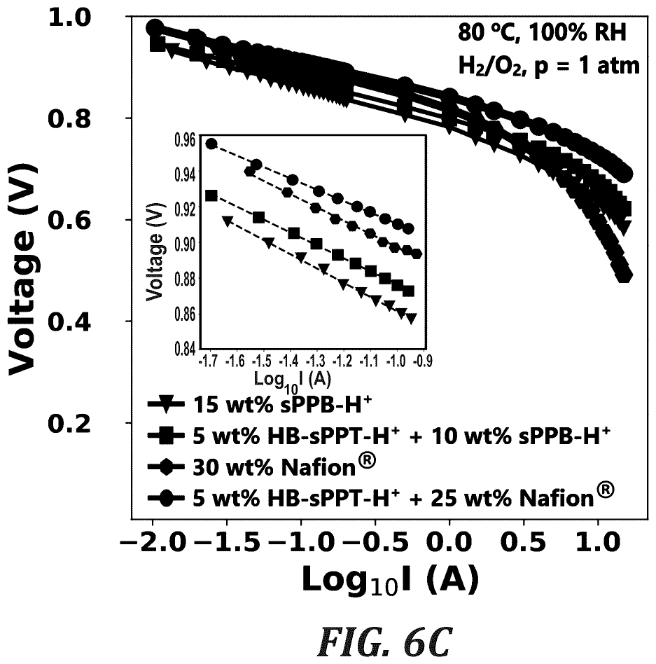

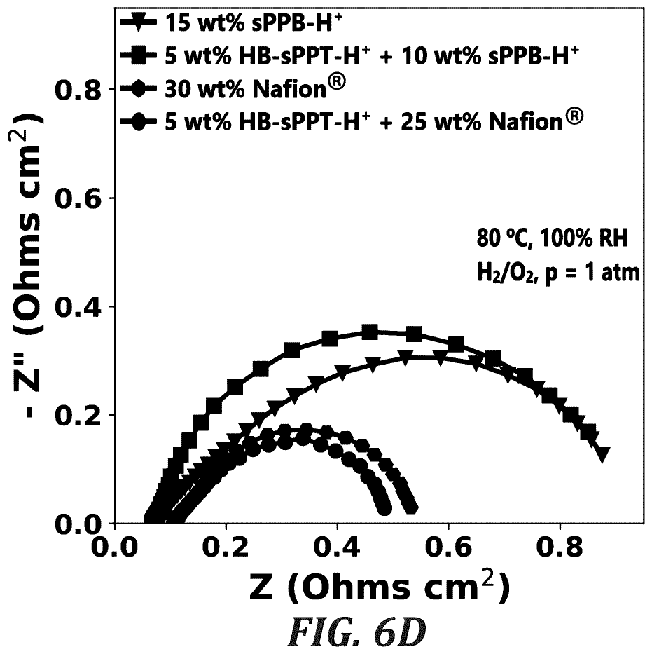

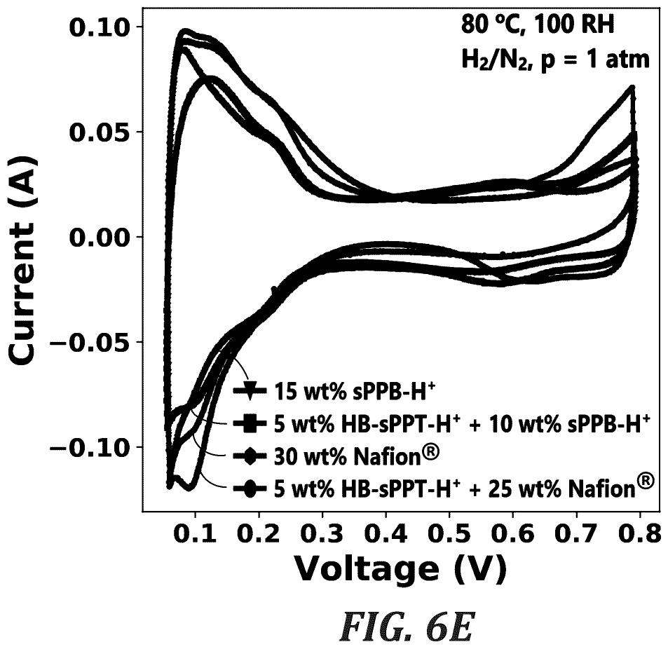

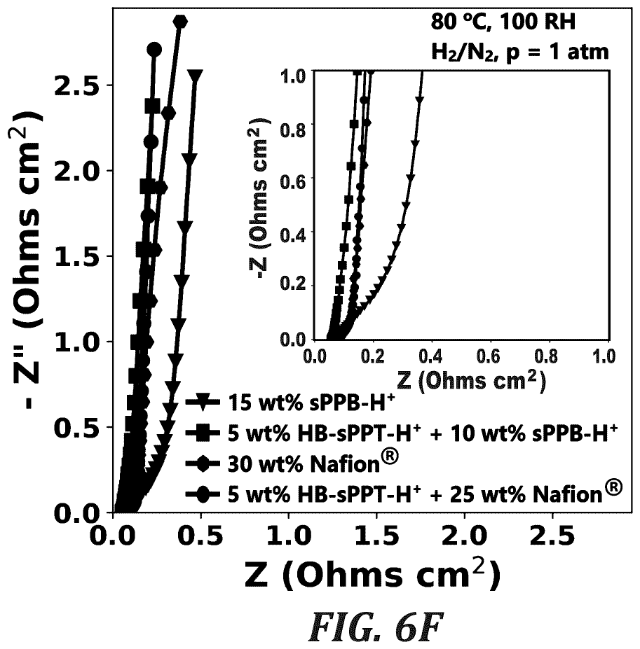

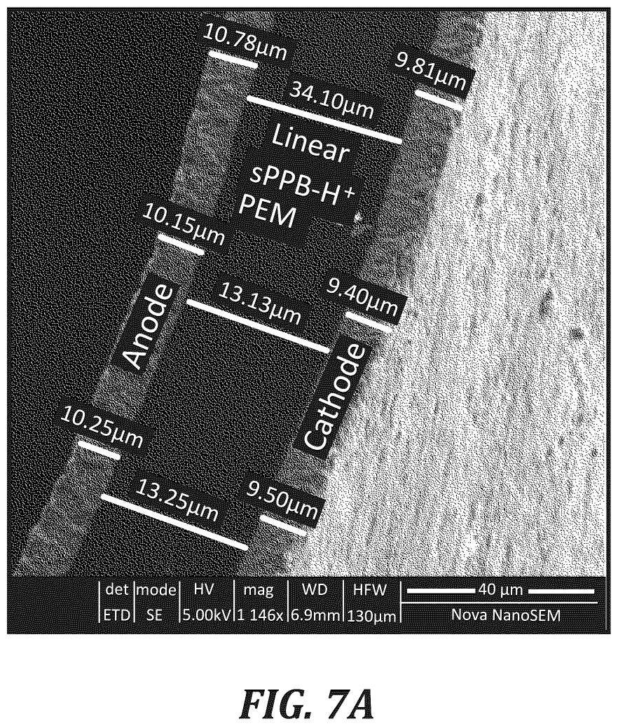

Polarization and power curves under H₂/O₂ operation are shown in FIG. 6A, and the extracted data listed in Table 3 shows that the peak power density of CCM 2 (1430 mW cm⁻²) is 15% greater than CCM 1 (1240 mW cm⁻²), but similar to both PFSA-based CCM 3 (1470 mW cm⁻²) and CCM 4 (1490 mW cm⁻²). Greater improvements in power performance were observed under H₂/air operation (FIG. 6B), i.e., CCM 2 (876 mW cm⁻²) achieved a peak power density that is 34% higher than CCM 1 (655 mW cm⁻²), and a 92% increase in power density at 0.6 V (685 mW cm⁻² for CCM 2 and 356 mW cm⁻² for CCM 1). Under H₂/air operation, the peak power density for CCM 4 is also greater than CCM 3, by 11%.

To better understand differences in the obtained power density curves, the low current density region was investigated further by Tafel analysis. Ohmic losses and H₂ crossover were corrected from the H₂/O₂ polarization curves and data replotted in FIG. 6C, from which the mass activity and specific activities of the CCMs were calculated (Tables 3-4). The Tafel slopes for all CCMs are observed to be within range of each other with an average of −73 mV dec⁻¹, and similar to that previously reported for sPPB-H⁺ ionomers expected values for ORR catalysis on Pt. The extracted values for mass activity (I_{m (0.9 V)}), as shown in Tables 3-4, are 17 and 29 mA mg⁻¹_{Pt}, for CCM 1 and CCM 2, while 54 and 70 mA mg⁻¹_{Pt} for CCM 3 and CCM 4, respectively. Similarly, the specific activities (I_{s (0.9 V)}) are reported to be 159 (CCM 1), 283 (CCM 2), 350 (CCM 3), and 424 μA cm⁻² Pt (CCM 4). It is noted that the presence of HB-sPPT-H⁺ ionomer within the CL increases the specific activities of the hydrocarbon-based CCM by 78%, and the PFSA-based CL by 21%. The calculated activities coincide with a reduced charge transfer resistance at 0.8 V, R_{ct (0.8 V)}, illustrated by the Nyquist plots in FIG. 6D and shown in Tables 3-4. The ECSA values for when HB-sPPT-H⁺ is included in the CL, as calculated from the CVs in FIG. 6E, are approximately equal for both CCM 1 and CCM 2 (43 and 41 m² g⁻¹_{Pt}, respectively), and when comparing CCM 3 (62 m² g⁻¹_{Pt}) to CCM 4 (60 m² g⁻¹_{Pt}). This indicates that the HB-sPPT-H⁺ is contributing to the overall activation of the Pt catalyst, alongside the linear sPPB-H⁺ and Nafion® ionomers, noting lower ECSA values for the lower ionomer contents shown in FIGS. 4-5, likely due to a more disconnected proton conduction pathway that comes with a sub-critical ionomer content. Because of the similar ECSA, changes in I_{m (0.9 V)} and R_{ct (0.8 V)} correspond to changes in the inherent catalytic activity of the Pt surface, which is lower for the sPPB-H⁺ compared to Nafion®, but higher with the inclusion of HB-sPPT-H⁺. The degree of sulfonate and phenyl adsorption from hydrocarbon-ionomers is hypothesized to be a leading cause of decreased specific activity.

From the H₂/O₂ Nyquist plots (FIG. 6D and Tables 3-4), R_{HFR} of the hydrocarbon-based CCMs with a PEM thickness of 33 μm was ˜70 mΩ cm², and ˜60 mΩ cm² for the Nafion® based CCMs with a PEM thickness of 25 μm. As a result, the membrane ohmic losses for each CCM are found to be very similar, and while the substantial increase in power performance for the HB-sPPT-H⁺ under H₂/air operation can be concluded to be partly a result of the observed increase in catalytic activity, reduced concentration resistances at higher current densities must play a greater role.

To investigate this, EIS measurements were performed under an H₂/N₂ environment, where intercept of the second linear region with the real axis corresponds to R_{ionic-CL,3}+R_{HFR}. As shown by FIG. 6F and the values in Tables 3-4, the HB-sPPT-H⁺ containing CCM 2 is measured to have an 8× lower R_{ionic-CL} (73 mΩ cm²) than CCM 1 (598 mΩ cm²), thus indicating significantly higher proton conduction as a result of HB-sPPT-H⁺ ionomer in the CL. The enhancement for HB-sPPT-H⁺ containing PFSA-based CCM 4 (98 mΩ cm²), compared to the all PFSA-based CCM 3 (115 mΩ cm²), is less than that observed for the hydrocarbon-based CCMs, but, likely due to the congruous network that Nafion® ionomer is able to form, the Nafion®-based CCMs demonstrate higher ionic conductivity overall. This congruous network is also the expected reason for the higher ECSA calculated for the PFSA-based, compared to the hydrocarbon-based, CCMs. Nevertheless, HB-sPPT-H⁺ provides much enhanced ionic conductivity, where the lowest ionic resistance across all samples is still found for the 5 wt % HB-sPPT-H⁺+10 wt % linear sPPB-H⁺ CCM 2 (73 mΩ cm²).

TABLE 3
Comparison of fuel cell data of CCMs prepared
with HB-sPPT-H+, Linear sPPB-H+,
and Nafion ® ionomers.

| | CCM | | | |
|---|---|---|---|---|
| | 1 | | 2 | |
| | Membrane | | | |
| | sPPB-H⁺ | | | |
| | 15 wt % Linear | | 5 wt % HB-sPPT-H⁺ + | |
| | sPPB-H⁺ | | 10 wt % sPPB-H⁺ | |
| Ionomer in CL | O₂ | Air | O₂ | Air |
| Max. Power Density | 1240 ± 45 | 655 ± 30 | 1430 ± 60 | 876 ± 29 |
| (mW cm⁻²) ^{a} | | | | |
| Power density | 820 ± 25 | 356 ± 17 | 1050 ± 50 | 685 ± 29 |
| (mW cm⁻²) | | | | |
| at 0.6 V ^{b} | | | | |
| Membrane | 34 ± 4 | | 33 ± 5 | |
| thickness (μm) | | | | |
| OCV/V | 0.986 ± 0.007 | | 0.999 ± 0.005 | |
| Tafel slope | −80 ± 9 | | −74 ± 6 | |
| (mV dec⁻¹) ^{c} | | | | |
| I_{m(0.9 V)} | 17 ± 1 | | 29 ± 5 | |
| (mA mg⁻¹_{Pt}) ^{d} | | | | |
| I_{s(0.9 V)} | 159 ± 45 | | 283 ± 52 | |
| (μA cm⁻²_{Pt}) ^{e} | | | | |
| R_{ionic -CL} | 598 ± 57 | | 73 ± 10 | |
| (mΩ cm²) ^{g} | | | | |
| ECSA | 44 ± 4 | | 41 ± 3 | |
| (m² g⁻¹_{Pt}) ^{h} | | | | |
| R_{HFR} | 74 ± 6 | | 72 ± 5 | |
| (mΩ) ⁱ | | | | |
| R_{ct (0.8 V)} | 885 ± 34 | | 839 ± 19 | |
| (mΩ cm²) ^{j} | | | | |

^{a} = Peak power density on the power density curve,
^{b} = Power density corresponding to 0.6 V on the polarization curve,
^{c} = Tafel slope in mV per decade,
^{d} = Mass activity is derived from the effective current density (corrected for H₂ cross-over and ohmic loss) at 0.9 V and catalyst loading,
^{e} = Specific activity derived from the effective current density (corrected for H₂ cross-over and ohmic loss) at 0.9 V and ECSA,
f = Ionic resistance within the CL derived from the low-frequency resistance linear intercept with the x-axis equal under H₂/N₂,
^{g} = Electrochemical surface area determined by cyclic voltammograms,
^{h} = Intercept of the HFR with the x-axis under H₂/O₂,
ⁱ = Charge transfer resistance, the diameter of the Nyquist plot semi-circle under H₂/O₂.

TABLE 4
Comparison of fuel cell data of CCMs prepared with HB-
sPPT-H+ and Nafion ® ionomers.

| | CCM | | | |
|---|---|---|---|---|
| | 3 | | 4 | |
| | Membrane | | | |
| | NR- 211 | | | |
| | 30 wt % | | 5 wt % HB-sPPT-H⁺ + | |
| | Nafion ® | | 25 wt % Nafion ® | |
| Ionomer in CL | O₂ | Air | O₂ | Air |
| Max. Power Density | 1470 ± 40 | 673 ± 30 | 1490 ± 47 | 748 ± 26 |
| (mW cm⁻²) ^{a} | | | | |
| Power density | 1100 ± 55 | 640 ± 20 | 1215 ± 43 | 698 ± 24 |
| (mW cm⁻²) | | | | |
| at 0.6 V ^{b} | | | | |
| Membrane | 28 ± 2 | | 27 ± 3 | |
| thickness (μm) | | | | |
| OCV/V | 1.01 ± 0.009 | | 1.03 ± 0.006 | |
| Tafel slope | −73 ± 7 | | −63 ± 7 | |
| (mV dec⁻¹) ^{c} | | | | |
| I_{m(0.9 V)} | 57 ± 7 | | 70 ± 5 | |
| (mA mg⁻¹_{Pt}) ^{d} | | | | |
| I_{s(0.9 V)} | 351 ± 68 | | 424 ± 58 | |
| (μA cm⁻²_{Pt}) ^{e} | | | | |
| R_{ionic -CL} | 115 ± 13 | | 98 ± 25 | |
| (mΩ cm²) ^{g} | | | | |
| ECSA | 62 ± 3 | | 60 ± 3 | |
| (m² g⁻¹_{Pt}) ^{h} | | | | |
| R_{HFR} | 64 ± 5 | | 65 ± 5 | |
| (mΩ) ⁱ | | | | |
| R_{ct (0.8 V)} | 455 ± 26 | | 421 ± 23 | |
| (mΩ cm²) ^{j} | | | | |

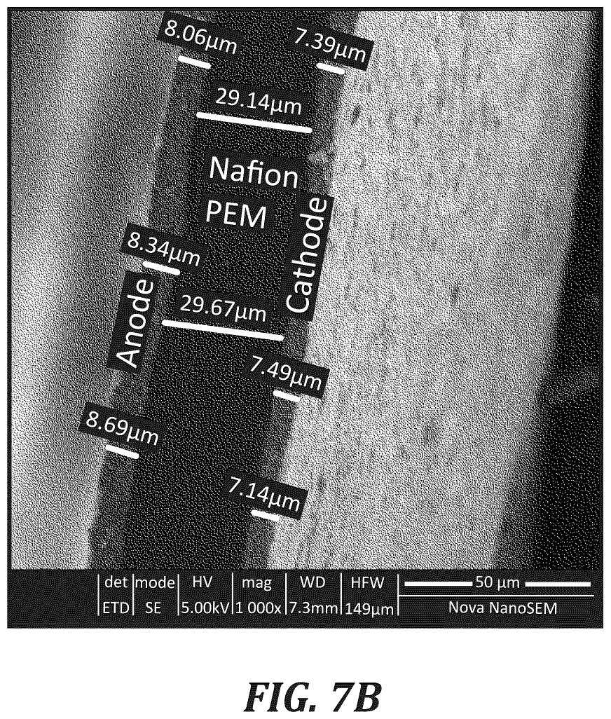

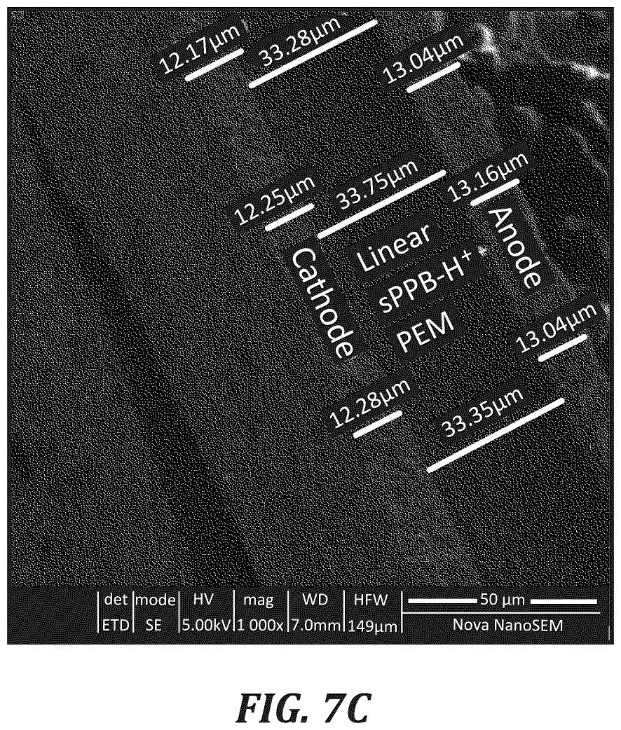

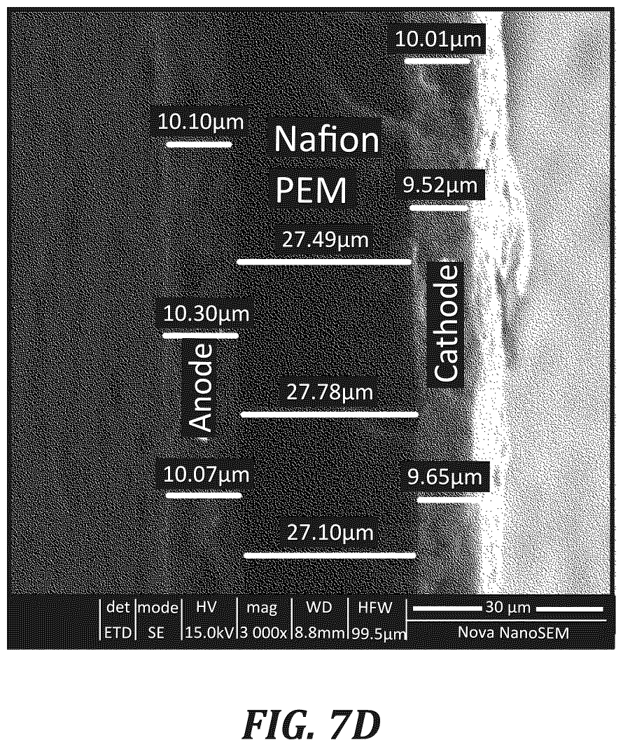

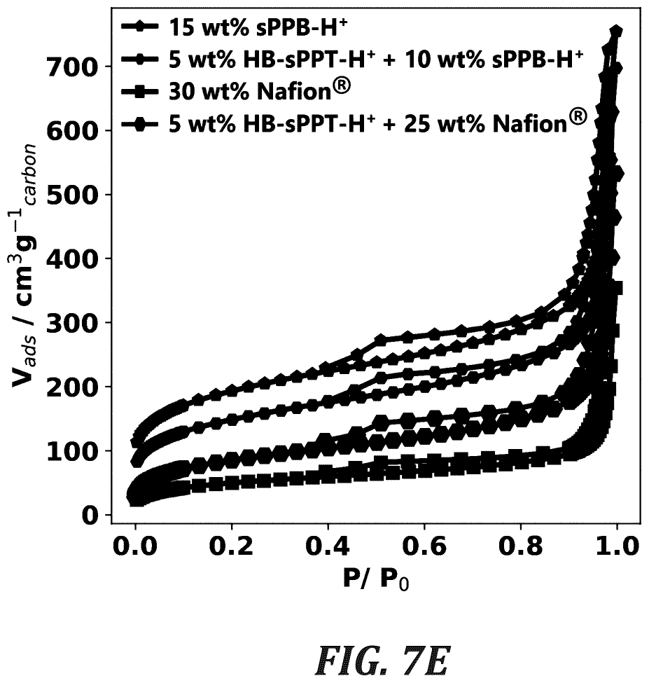

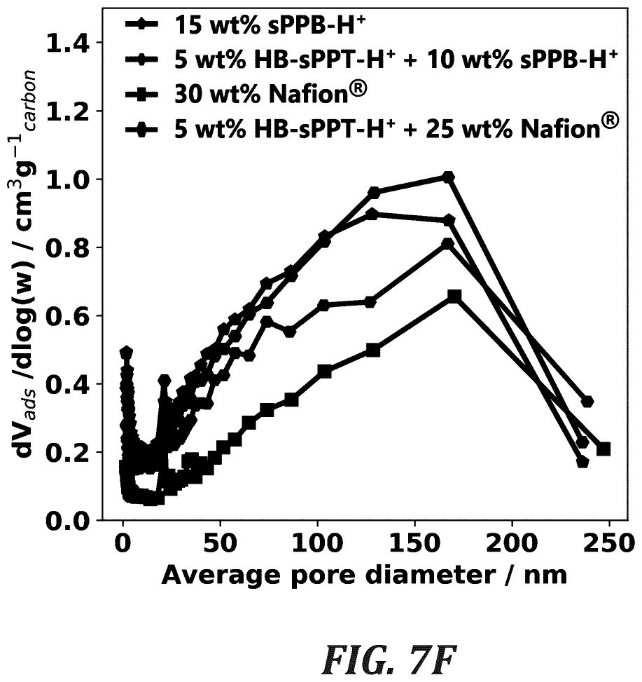

To further elucidate the origin of the enhanced higher power performances at higher current densities, SEM micrographs of the CCMs compared are shown in FIGS. 7A-7D. From these images, it is shown that the addition of the HB-sPPT-H⁺ ionomer particles increased the thickness of the CLs. CCM 1 possessed a CL thickness of ˜10 μm; however, CCM 2, containing 5 wt % HB-sPPT-H⁺ and overall similar 15 wt % ionomer content exhibited CL thicknesses of ˜13 μm. A similar ˜3 μm increase in CL thickness in the presence of HB-sPPT-H⁺ particles was observed for the PFSA-based CCMs, shown in FIGS. 7C-7D. The thicker CLs observed with the HB-sPPT-H⁺ are attributed to the relatively large size of the individual particles which, as shown in FIGS. 1B and 1C, are on the micron scale, potentially acting as a pore-forming material.

TABLE 5
BET analysis of CCMs prepared from 15 wt % linear sPPB-H+
(CCM 1), 5 wt % HB-sPPT-H+ + 10 wt % linear sPPB-H+
(CCM 2), 30 wt % Nafion ® (CCM 3), and 5 wt % HB-sPPT-
H+ + 25 wt % Nafion ® CLs (CCM 4).

| | CCM 1 | CCM 2 | CCM 3 | CCM 4 |
|---|---|---|---|---|
| BET SAₜₒₜₐₗ | 633 ± 43 | 531 ± 44 | 174± 5 | 261 ± 58 |
| (m² g⁻¹_{carbon})ⁱ | | | | |
| SA < 2 nm | 446 ± 33 | 353 ± 39 | 99 ± 4 | 143 ± 46 |
| (m² g⁻¹_{carbon})ⁱⁱ | | | | |
| SA > 2 nm | 186 ± 12 | 177± 2 | 75±1 | 117 ± 39 |
| (m² g⁻¹_{carbon})ⁱⁱⁱ | | | | |
| Vₜₒₜₐₗ | 0.75 ± 0.04 | 0.70 ± 0.01 | 0.25 ± 0.01 | 0.41 ± 0.01 |
| (cm³ g⁻¹_{carbon})^{iv} | | | | |
| V < 2 nm | 0.22 ± 0.02 | 0.17 ± 0.01 | 0.20 ± 0.01 | 0.35±0.01 |
| (cm³ g⁻¹_{carbon})^{v} | | | | |
| V > 2 nm | 0.53 ± 0.02 | | 0.05 ± 0.01 | 0.06 ± 0.01 |
| (cm³ g⁻¹_{carbon}) | | 0.53 ± 0.01 | | |

ⁱ= the BET SA was determined from the range of 0.05-0.2 N₂ partial pressure,
ⁱⁱ= the SA of the mesopore, SA > 2 nm, is calculated from the slope of the t plot,
ⁱⁱⁱ= the SA of the micropores, SA < 2 nm is the difference between SAₜₒₜₐₗ and mesoporous SA > 2 nm,
^{iv}= total pore volume, Vₜₒₜₐₗ, is calculated from the total adsorbed gas amount at 0.98 N₂ partial pressure,
^{v}= volume of the micropores,
V < 2 nm from the intercept of the t plot.

N₂ porosimetry was performed to examine the effect of HB-sPPT-H⁺ on the porosity of the CLs. Adsorption and desorption isotherms of the compared CCMs are shown in FIG. 7E. The observed isotherms are typical type II isotherms, which are known to have a high degree of micro-porosity and a sheer rise in the isotherms when operated at low partial pressure conditions. As shown in Table 5, the BET surface area (BET SA) was calculated to be 633, 531, 174 and 261 m² g⁻¹_{carbon} for CLs prepared from CCM 1, CCM 2, CCM 3, and CCM 4, respectively. The former is similar to that for Pt/C (639 m² g_{carbon}⁻¹, 666 m² g⁻¹_{carbon} in), indicating that the sPPB-H⁺ does not block the carbon pores in the same manner as Nafion®. However, for Nafion®-based CCMs, a dramatic reduction in CL porosity was observed, with the volume of the larger mesopores+macropores being 10× lower than the hydrocarbon-based CCMs. These results suggest that the Nafion® ionomer coats the aggregates of agglomerates of carbon-supported catalyst, blocking the primary pore structure within. Conversely, the hydrocarbon ionomers do not, and therefore gas transport is impeded to a lesser degree, resulting in the much higher power performances at high current density when air is used as the oxidant.

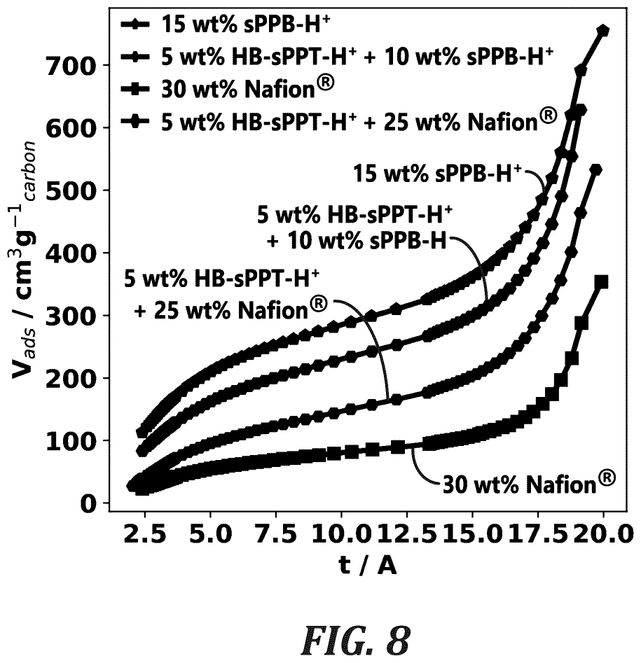

The addition of the HB-sPPT-H⁺ into the hydrocarbon-based CCM results in a ˜16% reduction in the BET SA compared to CCM 1 but shows an identical volume of larger pores (0.53 cm³ g⁻¹_{carbon}), illustrated by similar slopes to the t-plots of FIG. 8 and similarly large areas under the pore size distribution curves shown in FIG. 7F. Also, considering the increased thickness of the CLs, the much-improved power performances at high current density, therefore, cannot be explained by porosimetry alone. Rather, it appears to be linked to the 8× lower ionic resistance in the CL and thus the concentration resistances associated with proton transport. However, for the Nafion®-based CCM, the HB-sPPT-H⁺ ionomer results in a 50% increase in the BET SA compared to CCM 4, likely due to the decrease in the Nafion® component. This is believed to be the cause of the improved high current density region in FIG. 6B, in addition to the improved ionic conductivity through the CL.

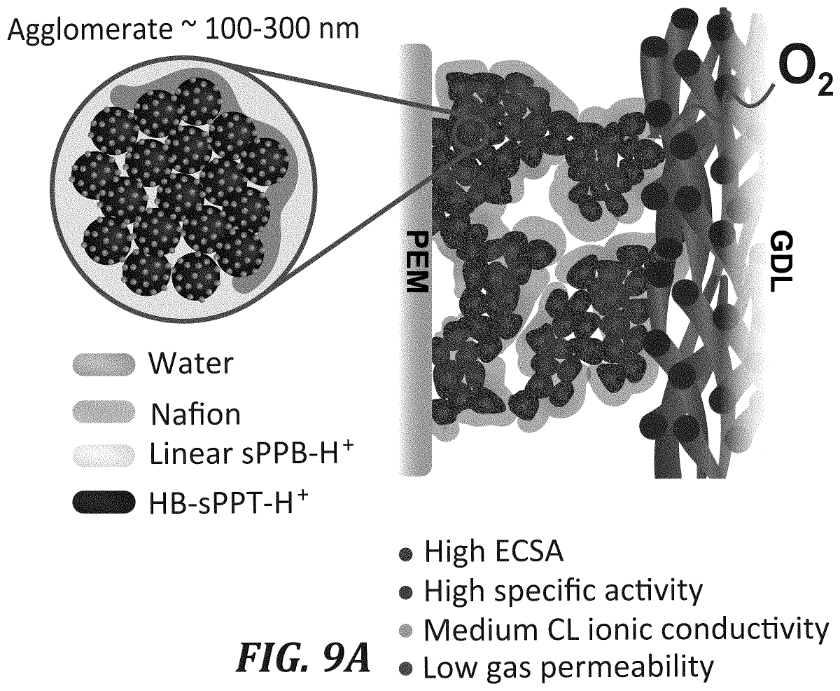

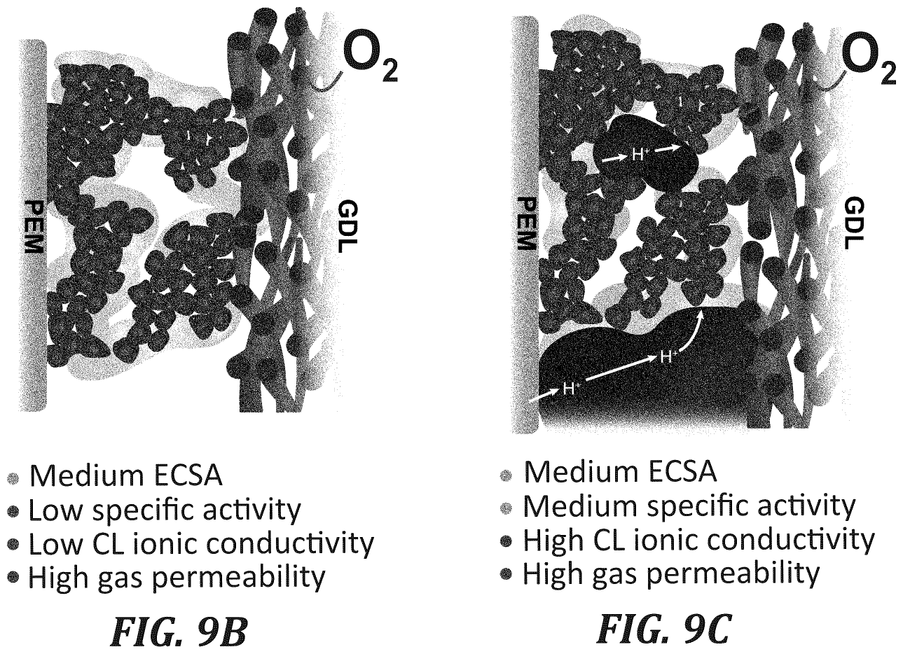

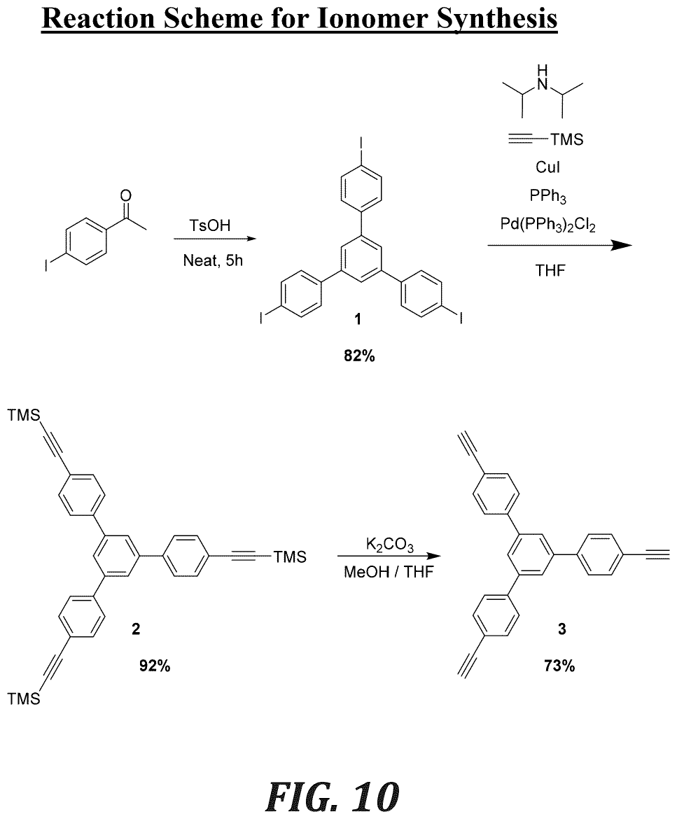

Insoluble particles of hyperbranched sulfonated phenylated poly(phenylene) (HB-sPPT-H⁺) were synthesized. Incorporation of small quantities of HB-sPPT-H⁺ particles into hydrocarbon and PFSA-based CLs does not appear to impede gas transport and was shown to increase the specific activity of the Pt/C catalyst. As illustrated by FIGS. 9A-9C, use of HB-sPPT-H⁺ (5 wt %) can decrease concentration resistances in PEMFCs based at least in part on providing long-range proton conduction pathways to and from ultra-thin ionomer films located near electrochemical reaction sites. When coupled to the high porosity of hydrocarbon-based CLs, much improved power densities for H₂/air operation are shown compared to PFSA-based MEAs. As such, hydrocarbon ionomer design can be considered for its impact in the macropores between catalyst aggregates.

### Example 2

### Methods and Materials for Synthesis of Polymers and Membranes

The reaction scheme for ionomer synthesis is shown in FIG. 10. Linear sulfonated phenylated pol(phenylene) biphenyl (sPPB-H⁺) and hyperbranched sulfonated phenylated poly(phenylene) terphenyl (HB-sPPT-H⁺) ionomer were synthesized using the materials and methods described herein. The synthesis of the linear sPPB-H⁺ involves the use of Diels-Alder (D-A) polymerization reactions. Perfluorosulfonic acid (PFSA) polymers; Nafion® NR-211 membrane (DuPont, TE143904, 25±5 μm thickness), and Nafion® D520 dispersion (Ion Power Inc., lot SGA-12-02CS) were used for the PFSA-based catalyst coated membrane (CCM). Pt/C catalyst powder (TEC10E50E, lot 109-0111, 46.4% Pt) and PTFE-treated gas diffusion layers (GDL) were purchased from FuelCellStore. Methanol (MeOH reagent grade ≥99.8%) was purchased from Fischer Scientific.

### 1,3,5-Tris-(4-iodophenyl)-benzene (1)

Iodoacetophenone (15 g, 61 mmol) was reacted neat with paratoluenesulfonic acid (343 mg, 2.03 mmol) and stirred at 130° C. in a pressure vessel for 5 hours. After completion, the product was dissolved in dichloromethane (20 mL) and precipitated in ethanol 95%. The precipitate was filtered and washed with ethanol to afford 1,3,5-Tris-(4-iodo-phenyl)-benzene as a yellow powder with 82% yield.

¹H NMR (400 MHz, CDCl₃) δ=7.84-7.79 (m, 5H), 7.68 (s, 3H), 7.43-7.38 (m, 6H).

Spectral data in accordance with literature.

### 1,3,5-Tris-(4-trimethylsilylethynyl-phenyl)-benzene (2)

1,3,5-Tris-(4-iodo-phenyl)-benzene (5 g, 7.31 mmol), triphenylphosphine (19 mg, 0.73 mmol), bis(triphenylphosphine)palladium(II)dichloride (46 mg, 0.73 mmol) and trimethylsilylacetylene (3.43 mL, 24 mmol) were dissolved under inert atmosphere in a mixture of THF (150 mL) and diisopropylamine (25 mL). Copper(I)iodide (14 mg, 0.73 mmol) was then slowly added to the reaction mixture and was stirred for 5 hours at 50° C. Et₂O was poured into the solution and the precipitate was filtered. The filtrate was evaporated, 200 mL of Et₂O were added and washed with 1 M hydrochloric acid (200 mL). The organic phase was separated, washed with saturated ammonium chloride solution, water, dried over magnesium sulfate, and concentrated in vacuo. The product was collected as a light orange powder (92% yield) and was used later on without further purification.

¹H NMR (400 MHz, Acetone) 6=7.99 (s, 3H), 7.92-7.88 (m, 6H), 7.64-7.57 (m, 6H), 0.26 (s, 27H). Spectral data in accordance with literature.

### 1,3,5-Tris-(4-ethynyl-phenyl)-benzene (3)

1,3,5-Tris-(4-trimethylsilylethynyl-phenyl)-benzene (2 g, 3.3 mmol) was dissolved in THF (20 mL) and methanol (80 mL). Potassium carbonate (2.79 g, 20 mmol) was added to the reaction and was stirred for 5 hours at room temperature and covered with aluminum foil to prevent daylight. After completion, 300 mL of dichloromethane were added and the organic phase was washed with water, dried over magnesium sulfate, and concentrated in vacuo. The crude product was purified by a plug of silica gel with a mixture of hexane/dichloromethane 7:3 to give 1,3,5-Tris-(4-ethynyl-phenyl)-benzene (460 mg, 73%) as a light-yellow powder.

¹H NMR (400 MHz, Acetone) δ=8.00 (s, 3H), 7.95-7.87 (m, 6H), 7.67-7.60 (m, 6H), 3.74 (s, 3H). Spectral data in accordance with literature.

HB-sPPT-H⁺

In a 50 mL round bottom flask, nitrobenzene (14 mL) was degassed under argon for 1 hour. TEAsBTC (700 mg, 0.497 mmol) and 1,3,5-Tris-(4-ethynyl-phenyl)-benzene (127 mg, 0.335 eq.) were added, the round bottom flask was covered with aluminum foil and stirred at 170° C. for 4 days. The polymer precipitate was washed with ethyl acetate (200 mL) to give an off-white powder. The polymer was then dispersed in MeOH (100 mL) and then exchanged in sodium form by the addition of a 2 M NaOH (40 mL). The polymer was then filtered as a beige powder and was found to be insoluble in MeOH, EtOH, iPrOH, DMAc, DMF, DMSO, NMP, and boiling water. The acidification of the polymer was carried out by dispersion in deionized water (60 mL) and 2 M HCl (60 mL) and filtered off to obtain the acidified polymer (503 mg) with an 87% yield.

Catalyst Coated Membrane Fabrication

sPPB-H⁺ Membranes: The acidified polymer sPPB-H⁺ was cast into a solid polymer electrolyte (SPE) membrane from DMSO solutions (7.5 wt %) at 85° C. The fabrication process is preceded by dissolving and continuous stirring of 10 g of sPPB-H⁺ in 133 g of DMSO at 80° C. in a round bottom flask. The resulting polymer solution was vacuum filtered through a glass fibre filter at room temperature into a round bottom flask. The polymer solution was cast into a membrane with the aid of an acid (1 M HCl solution) washed, distilled water cleansed, and MeOH dried leveled glass plate disposed on the casting table (K202 Control Coater casting table equipped with a doctor blade RK PrintCoat Instrument Ltd). The cast membrane was peeled off by immersing the glass plate into distilled water. Residual DMSO was removed from the cast membrane by soaking it in 1 M H₂SO₄ solution for 24 h, with the acidified solution extracted and replaced 3 times at an 8 h interval. The DMSO-free membrane was then dried under vacuum overnight at 80° C. These membranes were then used directly for coating with a catalyst to fabricate CCMs, or dissolved in a solvent (e.g., MeOH) and used to prepare catalyst inks as per the procedures herein. sPPB-H⁺ membranes exhibit proton conductivities of 129 mS cm⁻¹ and 172 mS cm⁻¹ at 30° C. and 80° C. respectively, which is larger than that of NR-211, at relatively moderate water content. Characterizations of the sPPB-H⁺ membranes produced by the foregoing method are shown in FIGS. 2A, 2B, 4A-4F, 11B-11F, 12A, and 12B.

Catalyst Ink Fabrication

The following method was undertaken to make catalyst inks, which were utilized in making catalyst coated membranes for fuel cell characterizations, the data for which can be seen in FIGS. 2A, 2B, 3A, 3B, 4A-4F, 5A-5F. The catalyst coated membranes were designed from pristine solid sulfonated phenylated-poly(phenylene) biphenyl (sPPB-H⁺) polymer electrolyte membranes and catalyst inks prepared by using individual or a combination of the hyperbranched sulfonated phenylated-poly(phenylene) terphenyl (HB-sPPT-H⁺), sPPB-H⁺, and Nafion® D520 ionomer. Both the linear sPPB-H⁺ and Nafion® D520 are soluble in alcohol solvents such as MeOH. However, the HB-sPPT-H⁺ ionomer is insoluble in MeOH, hence the need to use a different method of preparing its catalyst ink.

Catalyst inks (1% solids by weight in 1:3 v/v water/methanol) were initially prepared using Pt/C and a homogeneous solution of linear sPPB-H⁺ ionomer (3 wt % ionomer in MeOH) or Nafion® D520. A third of the required water was added initially to the Pt/C solid, and the slurry solution was sonicated for 10 min to ensure that the Pt/C particles were well wetted. The slurry solution was then placed on a stir plate in a fume hood, and a third of the required methanol was added dropwise and stirred for 15 min. To the resulting mixture was added the linear sPPB-H⁺ ionomer or the Nafion® D520 ionomer solution dropwise, and the resulting ink was stirred for 10 min. The remaining quantity of methanol and water was then added dropwise, respectively to form the catalyst ink.

HB-sPPT-H⁺ ionomer-based catalyst ink was made by grinding the appropriate solid HB-sPPT-H⁺ ionomer in the presence of MeOH. Dried, ground HB-sPPT-H⁺ ionomer was added to the preformed catalyst ink containing either the linear sPPB-H⁺ or the Nafion® D520 ionomer. The resulting HB-sPPT-H⁺ based catalyst ink was sonicated for 2 hours.

Catalyst Coated Membranes

The following method was undertaken to make catalyst coated membranes, which were used for fuel cell characterizations, the data for which can be seen in FIGS. 2A, 2B, 3A, 3B, 4A-4F, 5A-5F, 6, 7A-7D, 8, 11, 12A, and 12B. Hydrocarbon-based electrodes were applied onto pristine sPPB-H⁺ membranes via spray coating using a spray coater (Sono-tak ExactaCoat). The inks were sprayed via an ultrasonic accumist nozzle at 120 kHz and 2-6 mm diameter, with a path speed of 75 mm s⁻¹ on a 2D path from left to right, then from bottom to top. The reverse process was conducted to complete each spray cycle. The shaping air was set at 0.8, the idle and run generator power was set at 0.5 W and 2 W respectively, while the flow rate was set at 0.3 ml min⁻¹. The catalyst loading was set at 0.4 mgPt cm⁻² over an area of 5 cm² (2.24×2.24 cm). Using this methodology, PFSA-based reference catalyst coated membranes (CCMs) were also prepared with a Nafion© D520 dispersion as a binder (ionomer) in the catalyst ink and thereafter coated on a Nafion® NR-211 membrane as a reference. The resulting catalyst coated membrane (CCM) was sandwiched between two 7.6 cm² (2.76×2.76 cm) PTFE treated gas diffusion layers (Sigracet 29BC, FuelCellStore) and compressed in fuel cell hardware (AHNS Co.). Three samples were made for each setup.

Electrochemical Characterization

The following method was undertaken for fuel cell characterizations, the data for which can be seen in FIGS. 2A, 2B, 3A, 3B, 4A-4F, 5A-5F, 6, 12A, 12B, and 13. MEAs were compressed between two single serpentine flow fields in fuel cell hardware (AHNS Co.) using a torque wrench. A Fuji pre-scale pressure paper was used to ascertain the adequacy of compression. We conducted tests on an eight bolt fixture fuel cell hardware at different applied torque values, from 0.5 to 6.0 Nm with an increment of 0.5 Nm to ensure equal pressure distribution across the edges. Optimal compression was obtained at 5.7 Nm (50 in-lbs) using a 130 μm thick glass-fiber-reinforced PTFE gasket (Hightechflon GbR) and a 50 μm silicone sub gasket. The resulting MEA was conditioned using a custom-designed accelerated conditioning procedure, with the fuel cell operating conditions set at 80° C. and 100% relative humidity (RH); inlet gas flows of 0.5 slpm H₂ and 1.0 slpm O₂ at the anode and cathode respectively. Before beginning electrochemical characterization, the cells were equilibrated at an open-circuit voltage (OCV). Electrochemical characterization was initiated by running polarization curves, electrochemical impedance spectroscopy (EIS), and cyclic voltammetry (CV) analyses. Tafel analysis of the MEAs was performed to determine the Tafel slope and the exchange current density. The voltage and current densities used for the Tafel plots were corrected for high-frequency resistance and H₂ crossover losses, respectively. The mass activity (I_{m(0.9 V)}) and specific activity (I_{s(0.9 V)}) were determined from the effective current density at 0.9 V_{HFR-free}, the electrochemical surface area, and the Pt loading of each of the samples. For each electrochemical analysis performed, three samples were tested and the accuracy of each electrochemical analysis performed is indicated by an accompanying standard deviation, and error bars where appropriate.

Physical Characterization

Ion Exchange Capacity (IEC) allows the determination of exchangeable protons within the polymeric material. Prior to measurements, the polymer powder was dried under vacuum at 80° C. for 48 hours. The IEC measurement was carried out in triplicate by immersing the powder in a 1M NaCl solution for 48 hours, then the solution was titrated using a 0.01 M NaOH (Sigma Aldrich) by an automatic titrator Metrohm 848 Titrino Plus. The experimental IEC is calculated according to equation (1).

$${IEC}_{Exp} ( m mol {g}^{- 1} ) = \frac{{C}_{t} ( mol {dm}^{- 3} ) \times {V}_{t} ( {cm}^{3} )}{{m}_{dry} ( g )} \qquad ( 1 )$$

Water uptake of the HB-sPPT-H⁺ powder was conducted by a gravimetric method between the wet and the dry sample and has been carried out in triplicate. Prior to the water uptake measurement, samples were dried under a vacuum oven at 80° C. for 48 hours and the dry mass of the polymer was measured. The powder was then immersed in deionized water and stirred for 48 hours. The wet polymer was then filtered on a wet frit and its wet mass was measured before the end. The water uptake and the number of water molecules per sulfonic group were then calculated using equations (2) and (3).

$$WU ( \% ) = \frac{{m}_{w e t} - {m}_{dry}}{{m}_{dry}} \times 100 \% \qquad ( 2 )$$

$$λ = \frac{10 \times W U}{I E C \times 18 ( g {mol}^{- 1} )} \qquad ( 3 )$$

Prior to DVS measurements, samples were dried under vacuum at 80° C. Isothermal water uptakes/loss of sPPB-H⁺ and HB-sPPT-H⁺ both in powder form were measured using a Water Vapor Sorption Analyzer (DVS-1000 Adventure) at 80° C. with varying relative humidity (RH) from 0% to 75% by step increment of 10% (FIG. 1D). Each step was equilibrated for 2 hours.

The sizes of the insoluble HB-sPPT particles were investigated using a Nikon Eclipse 50i equipped with a high-pressure mercury lamp and a Qimaging camera. The resulting images were calibrated using a 0.01 mm dot crosshair ruler for microscopy calibration, and particles sizes were determined using ImageJ software (developed by the National Institutes of Health). Details of the CL morphology such as roughness and thickness were investigated using an FEI Nova NanoSEM 430 Scanning electron microscope (SEM). For thickness measurement, the CCM samples were prepared by freezing each sample in liquid nitrogen followed by fracturing. Samples were typically imaged at an accelerating voltage of 15 kV. Images of the samples' cross-section were taken to determine the thickness of the CLs, and a high magnification image of the sample's surface was taken to determine the morphology and roughness of the CCMs (FIG. 1B).

N₂ porosimetry analysis detailing the pore spaces within the CL was conducted using a Micrometrics ASAP2020 Accelerated Surface Area and Porosimetry System equipped with liquid N₂. For this analysis, ultra-pure N₂ gas was used (99.999%). Each CCMs (50 cm²) studied were fabricated using the previously detailed method with an N211 substrate (the magnitude of N₂ physisorption was measured to be negligible). The Pt loading on both electrodes was 0.4 mg cm⁻². The CCMs were cut into equal thin strips and degassed for 1 hour at 90° C., followed by 12 hours at 105° C. Adsorption and desorption isotherms were immediately measured after degassing, and are replotted as a function of the volume and mass of carbon. Brunauer-Emmett-Teller Surface Areas (BET SAs) were determined in the range of 0.05-0.2 N₂ partial pressure. A t plot, which was made by plotting the adsorption isotherms against the adsorbed layer thickness on the pore wall, was used to determine the degree of micro-porosity within the CLs. This thickness, t, was calculated using the Harkins-Jura equation and the volume of micropores is estimated from the intercept of the linear region with the y axis. Data from the foregoing are shown in FIGS. 7E, 7F, and 8.

### Example 3

### Improvement of Polymer Composition for Membrane and Catalyst Ink

Unlike linear sPPB-H⁺, the HB-sPPT-H⁺ ionomer is non-soluble in low boiling point protic alcohols such as MeOH. Therefore, the resulting HB-sPPT-H⁺— Pt/C catalyst inks were in granular rather than in dispersion form, indicating that the HB-sPPT-H⁺ ionomer alone does not form a binding network with the Pt/C catalyst. The resulting CCMs made from these HB-sPPT-H⁺— Pt/C catalyst inks were observed to show significant mechanical degradation with large pinholes formed at different parts of the CCMs making them unsuitable for fuel cell operation. However, when linear sPPB-H⁺ ionomer was added in varying proportion to the HB-sPPT-H⁺ ionomer, dispersion inks were formed and binding with the Pt/C on the membrane was possible and hence, making in-situ fuel cell characterization feasible.

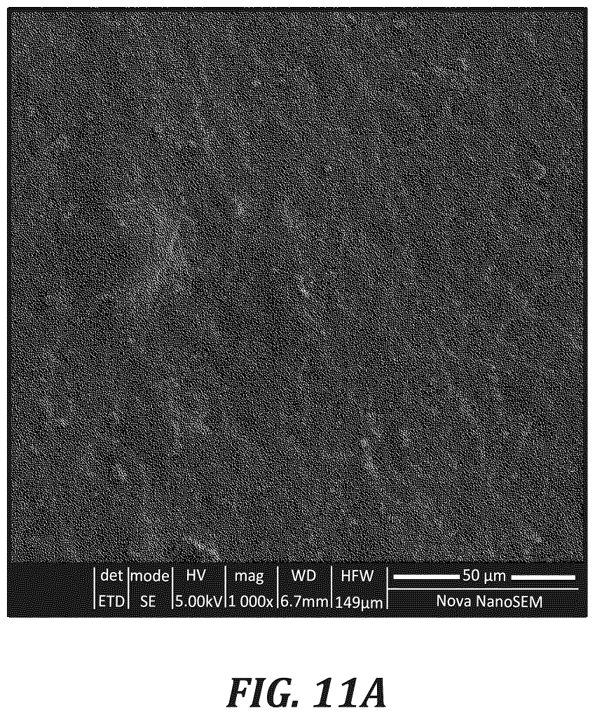

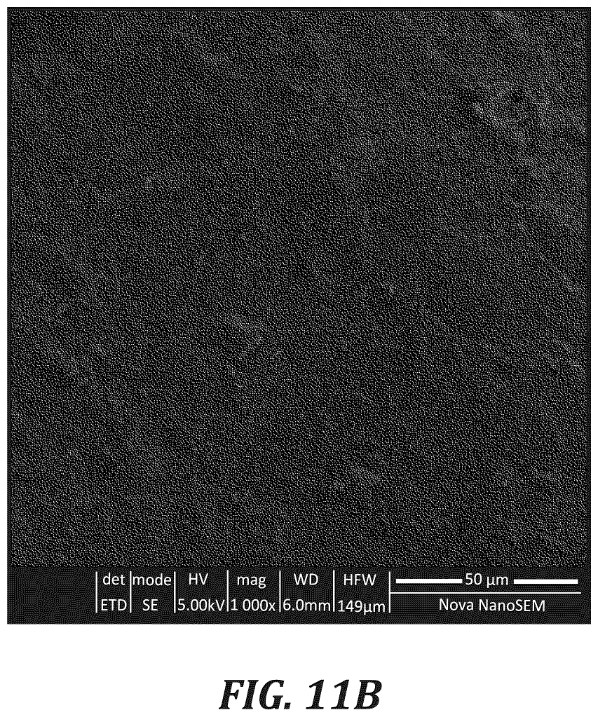

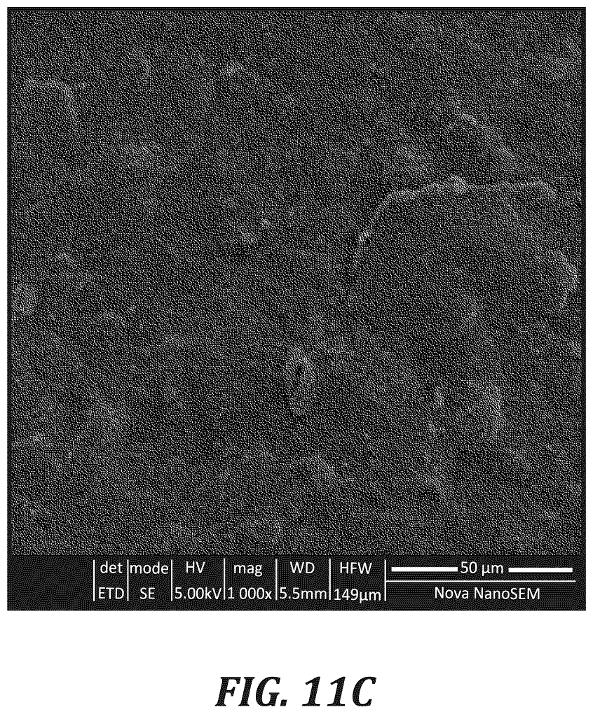

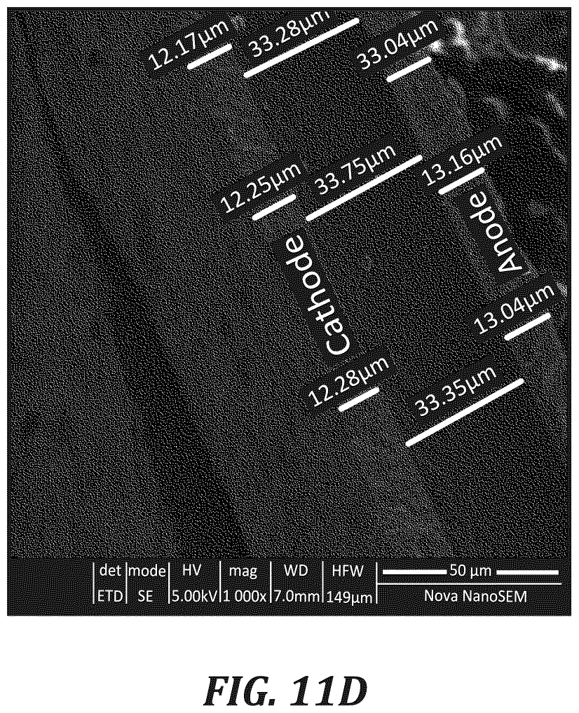

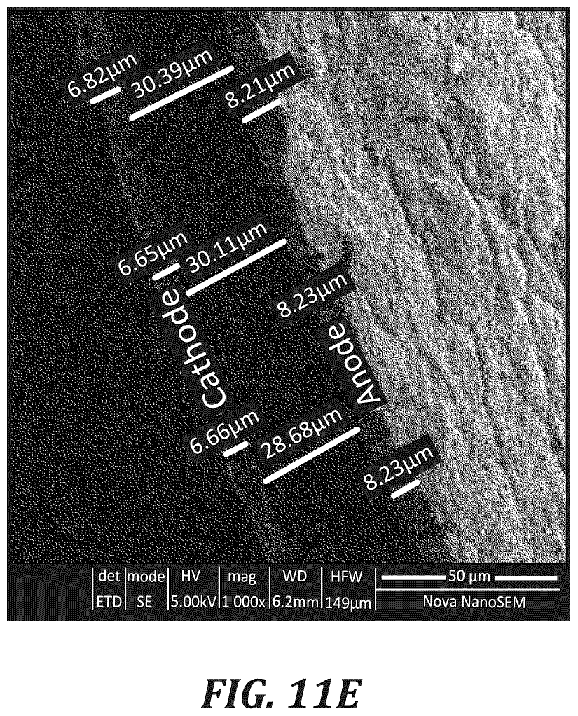

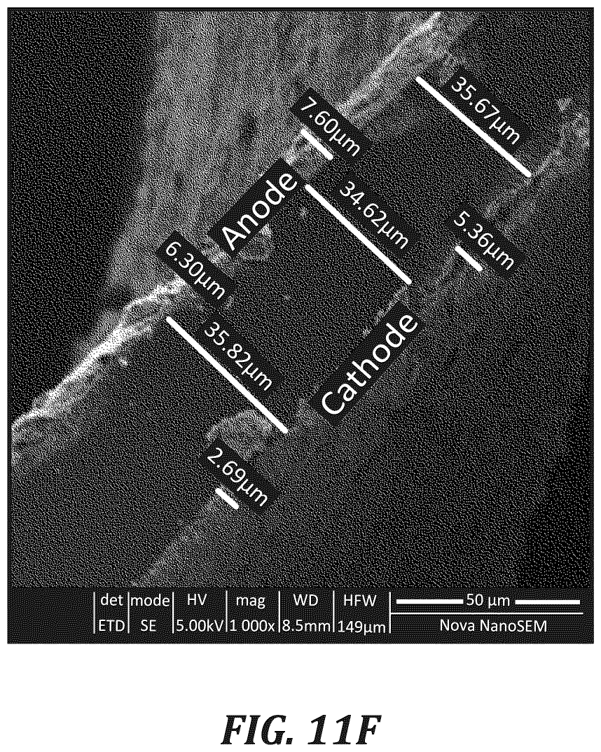

To determine the improved combination of linear sPPB-H⁺ and HB-sPPT-H⁺ ionomer in the CL, varying combinations of 15 wt % ionomer content of both types of HB-sPPT-H⁺ and linear sPPB-H⁺ ionomers were tested as shown in FIGS. 6A-6F. From the physical characterization of the resulting CCMs in FIG. 11A, it is observed from the SEM micrographs that the roughness of the CCM's surface increases with increasing HB-sPPT-H⁺ content. It is shown that CCMs containing 5 wt % HB-sPPT-H⁺ and 10 wt % HB-sPPT-H⁺ had the smoothest and roughest CL surface respectively. FIGS. 11D-11F show the thickness of the CCMs, where it is noted that both the anode and cathode catalyst layer thickness decreases with increasing HB-sPPT-H⁺ ionomer content. At 10 wt % HB-sPPT-H⁺ ionomer content, it is observed that CLs experience a lot of delamination, with shrinking CL size.

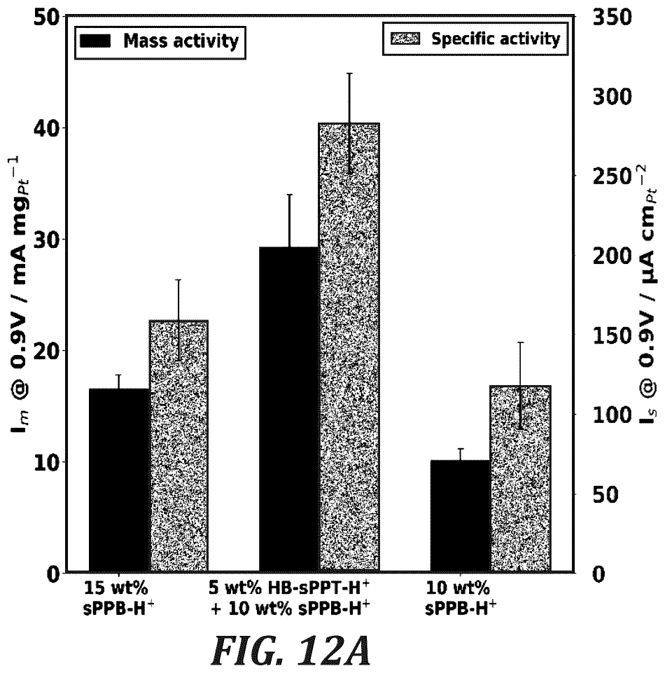

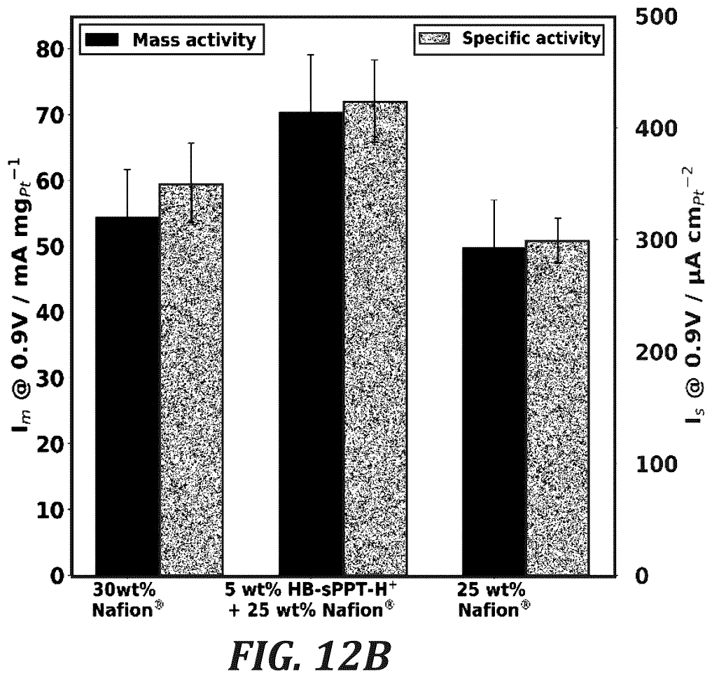

Finally, polarization curve analysis shown in FIGS. 7A-7F confirms that 5 wt % HB-sPPT+10 wt % linear sPPB-H⁺ ionomer is an advantageous combination to obtain improved performing hydrocarbon-based PEMFCs. Similarly, for Nafion® based CCM, the polarization curve analysis shown in FIGS. 12A-12B demonstrates that 5 wt % HB+25 wt % Nafion® ionomer is an advantageous combination to obtain improved performing Nafion®-based PEMFCs.

The Impact of Lower Ionomer Loadings

In-situ electrochemical data shown in FIGS. 4A-4C and 5A-5C, and Tables 1-2, help in understanding the impact the HB-sPPT-H⁺ ionomer has in the CLs and verifies that the enhanced performance reported is not because of reduced linear ionomer content in the CL. For both hydrocarbon and PFSA based CLs, polarization and power curves under both H₂/O₂ (FIG. 4A and FIG. 5A) and H₂/air (FIG. 4B and FIG. 4B) are presented, with extracted data listed in Tables 1-2. It is shown for hydrocarbon CCMs, under H₂/O₂ (H₂/air) operation, the peak power density with 5 wt % HB-sPPT-H⁺+10 wt % sPPB-H⁺ was 67% (53%) higher than CCMs with 10 wt % sPPB-H⁺ ionomer in their CL. Similarly for PFSA CCMs, under H₂/O₂ (H₂/air) operation, the peak power density with 5 wt % HB-sPPT-H⁺+25 wt % Nafion® was 10% (18%) higher than CLs with 25 wt % Nafion® ionomer. Thus, from the I-V data shown, it is noted that the HB-sPPT-H⁺ plays an active role in the PEMFC performances despite the hypothesis that the particle sizes are on the same order of magnitude as the catalyst layer thickness shown in FIGS. 11D-11F.

Similarly, from the extracted values for mass activity (I_{m (0.9 V)}) and specific activities (I_{s (0.9 V)}), as shown in Tables 1-2, FIG. 12A (hydrocarbon), and FIG. 12B (PFSA), it is noted that the presence of HB-sPPT-H⁺ ionomer within the CL increases the traditionally low mass and specific activities of the hydrocarbon-based CCM by >80%. For the Nafion® based CCM, more than 40% increase in specific activity was reported when 5 wt % HB-sPPT-H⁺ ionomer was included in the CL. This coincides with a reduced charge transfer resistance at 0.8 V, R_{ct (0.8 V)}, for the CCM with 5 wt % HB-sPPT-H⁺+10 wt % HB-sPPB-H⁺ ionomer (839 mΩ cm²), which compares well to both the CCM with 15 wt % sPPB-H⁺ ionomer (885 mΩ cm²) and the CCM with just 10 wt % sPPT-H⁺ ionomer (1297 mΩ cm²), illustrated by the Nyquist plots in FIG. 4D. A similar trend is observed for the R_{ct (0.8 V)}, the response of the Nafion® based CCM (FIG. 5D) with 5 wt % HB-sPPT-H⁺+25 wt % Nafion® showing the lowest charge transfer resistance compared to both CCMs with 30 wt % Nafion® and 25 wt % Nafion® ionomer in the CL.

As shown in FIG. 4E and FIG. 5E, lower ECSA values were reported for CCMs with lower linear ionomer content i.e., CCMs with 10 wt % HB-sPPB-H⁺ (FIG. 4E) and 25 wt % Nafion® (FIG. 5E). The lower ECSA values reported are likely due to a more disconnected proton conduction pathway that comes with a sub-critical ionomer content. These assertions are supported by EIS measurements under an H₂/N₂ environment (FIGS. 4F and 5F), where a reduced ionomer content results in a low ionic conductivity of the catalyst layer (R_{ionic-CL}=598 mΩ cm² for 15 wt % HB-sPPB-H⁺ and 1421 mΩ cm² for 10 wt % HB-sPPB-H⁺), as shown in Tables 1-2. The HB-sPPT-H⁺ containing CCM is measured to have a significantly lower R_{ionic-CL} than both the 15 wt % HB-sPPB-H⁺ and 10 wt % HB-sPPB-H⁺ based CCM (8× and 20× lower, respectively), thus indicating higher proton conduction as a result of HB-sPPT-H⁺ ionomer in the CL. For the Nafion® based CCMs, the presence of HB-sPPT-H⁺ also results in higher proton conductivity in Nafion® based CLs. However, the enhancement is less than that observed for the hydrocarbon-based CCM, but, likely due to the congruous network that Nafion® ionomer is able to form, the Nafion®-based CCMs demonstrate higher ionic conductivity overall.

### Example 4

### Hyperbranched Ionomer Use

Hyperbranched ionomers were used in conjunction with a 3^{rd} type of ionomer used typically in a catalyst layer, and an additional commercial proton exchange membrane.

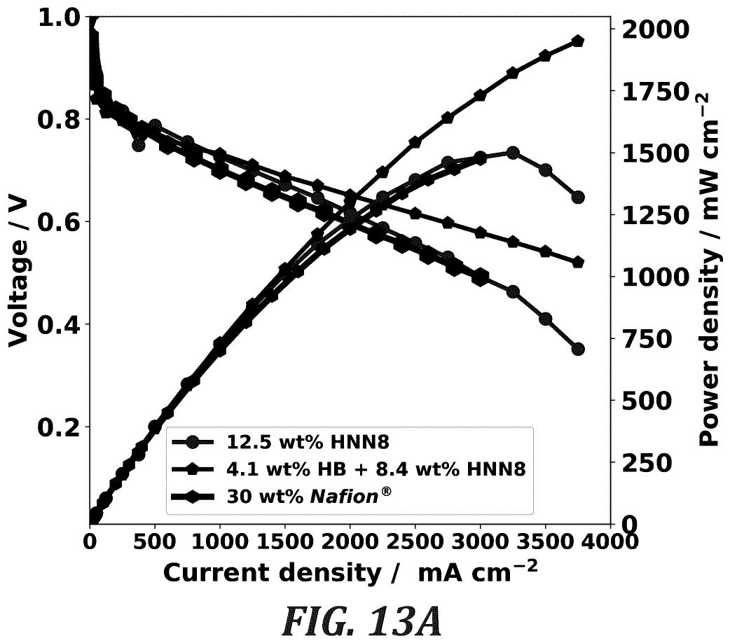

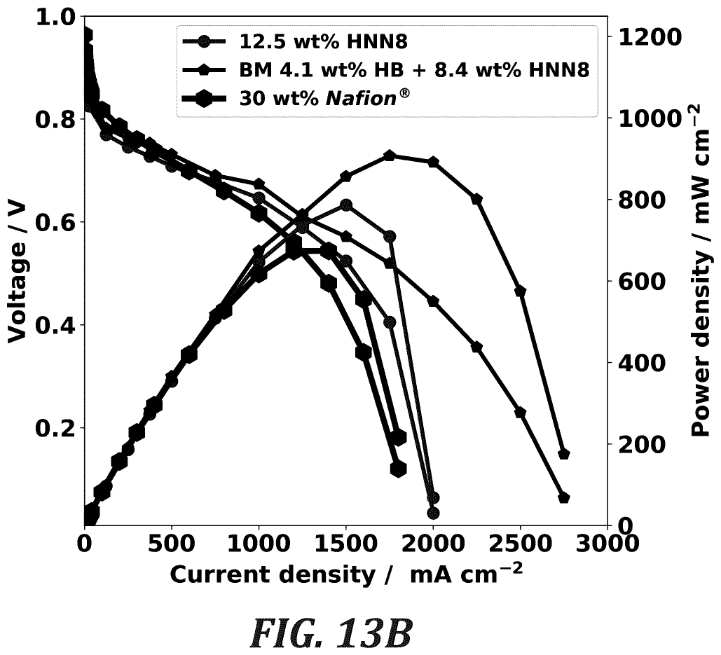

Experiments were conducted as described herein, and performance plots of MEAs were generated, which indicated the polarization and power curves under H₂/O₂ with the Pt catalyst loading on the anode and cathode at 0.4 mgPt/cm² and operating conditions at 80° C., 100% RH, and 1 atm pressure (FIG. 13A), and additionally the polarization and power curves under H₂/air operation with the Pt catalyst loading on the anode and cathode at 0.4 mgPt/cm² and operating conditions at 80° C., 100% RH, and 1 atm pressure (FIG. 13B). The data in FIGS. 13A and 13B was acquired from a membrane comprising PF1-HLF8-15-X Pemion®, and a catalyst layer comprising 15 wt % PP1-HNN8-00-X, as shown by the data represented by circles; from a membrane comprising PF1-HLF8-15-X Pemion®, and a catalyst layer comprising 4.1 wt % HB-sPPT plus 8.4 wt % PP1-HNN8-00-X ionomer, as shown by the data represented by pentagons; and from a membrane comprising Nafion® N211 from DuPont, and a catalyst layer comprising 30 wt % Nafion® D520 from DuPont, as shown by the data represented by hexagons. The resulting peak power density, and power density at 0.6V, is shown in Table 6.

The results demonstrate state of the art performances concerning hydrogen PEM fuel cells operating under ambient conditions (either air or oxygen).

TABLE 6
peak power density and power density at 0.6 V
for PEM fuel cell operation for ionomers used in combination
with a 3^{rd} type of ionomer.

| | | 12.5 wt % | 4.1 HB + | |
|---|---|---|---|---|
| | | PP1- | 8.4 wt % PP1- | |
| | | HNN8-00-X | HNN8-00-X | |
| | | CL based MEA | CL based MEA | Nafion ® |
| Peak Power | H₂/O₂ | 1500 | 1950 | 1470 |
| Density | H₂/Air | 786 | 907 | 673 |
| Power | H₂/O₂ | 1200 | 1605 | 1193 |
| Density @ | H₂/Air | 680 | 750 | 640 |
| 0.6 V | | | | |

1. A branched or hyperbranched ionomeric polymer, comprising a repeating unit of Formula (I): 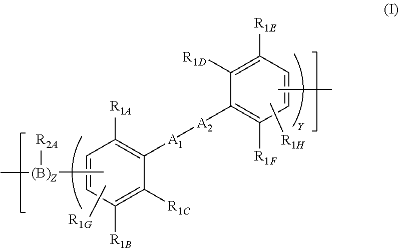
comprising an anionic comonomer and a branching comonomer (B),
wherein:
R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation;
A₁ is arylene, heteroarylene, aralkylene, or heteroaralkylene, each optionally substituted with 1, 2, 3, or 4 substituents independently selected from halo, nitro, cyano, aryl, and heteroaryl; and
A₂ is absent, arylene, or heteroarylene, wherein said arylene and heteroarylene are each optionally substituted with 1, 2, 3, or 4 substituents independently selected from halo, nitro, cyano, aryl, and heteroaryl;
B is a branching comonomer;
R_{2A} is a bond; and
wherein a first repeating unit of Formula (I) is bound to a second repeating unit of Formula (I) at R_{2A} to form a branched structure.

2. The branched or hyperbranched ionomeric polymer of claim 1, wherein the polymer is insoluble in a polar solvent.

3. The branched or hyperbranched ionomeric polymer of claim 1, wherein a molar ratio of Z:Y in the polymer is from 1:3 to 1:2.

4. The branched or hyperbranched ionomeric polymer of claim 1, wherein the branching comonomer (B) comprises a structure of Formula (II): 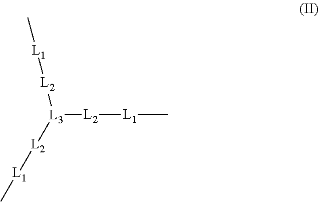
wherein:
L₃, at each occurrence, is an optionally substituted multivalent heteroatom (e.g., N, P, B), multivalent aryl, multivalent heteroaryl, multivalent aralkyl, or multivalent heteroaralkyl, wherein said multivalent aryl, multivalent heteroaryl, multivalent aralkyl, and multivalent heteroaralkyl are each optionally substituted with 1, 2, or 3 substituents independently selected from C₁₋₆ alkyl, halo, nitro, cyano, aryl, and heteroaryl;
L₂ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl; and
L₁ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl.

5. The branched or hyperbranched ionomeric polymer of claim 1, wherein the branching comonomer (B) comprises a structure of Formula (III):

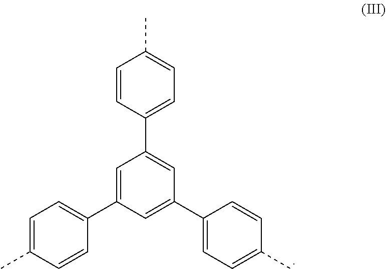

6. The branched or hyperbranched ionomeric polymer of claim 1, wherein the anionic comonomer comprises a structure of Formula (VII):

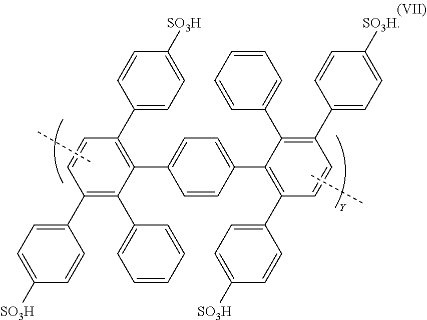

7. The branched or hyperbranched ionomeric polymer of claim 1, wherein the repeating unit comprises a structure of Formula (IV):

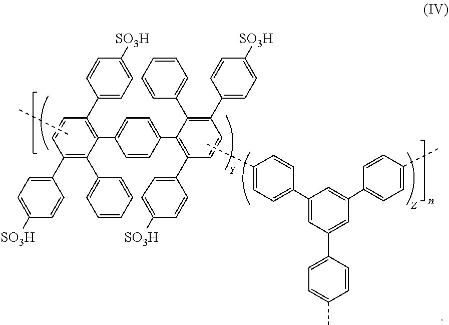

8. The branched or hyperbranched ionomeric polymer of claim 1, wherein the branched or hyperbranched ionomeric polymer is formed by polymerization of a functionalized branching comonomer (B) with a functionalized anionic comonomer, wherein the molar ratio of the functionalized branching comonomer (B) to the functionalized anionic comonomer is greater than 0.2.

9. The polymer of claim 8, wherein the molar ratio of the functionalized branching comonomer (B) to the functionalized anionic comonomer is approximately 0.667.

10. The branched or hyperbranched ionomeric polymer of claim 1, further comprising a bifunctional monomer C.

11. A catalyst ink formulation comprising:
a branched or hyperbranched ionomeric polymer having a structure according to claim 1;
a linear ionomeric polymer;
a polar solvent; and
a catalyst,
wherein the linear ionomeric polymer is dispersed in the polar solvent, and an amount of the linear ionomeric polymer is used which enables the branched or hyperbranched ionomeric polymer to disperse in the polar solvent.

12. The catalyst ink formulation of claim 11, wherein the polar solvent comprises an alcohol having a boiling point of less than 120° C.

13. The catalyst ink formulation of claim 11, wherein the alcohol is methanol.

14. The catalyst ink formulation of claim 11, wherein the polar solvent further comprises water, and wherein a volume-to-volume amount of water to the alcohol is from about 1:3 to about 3:1.

15. The catalyst ink formulation of claim 11, wherein the branched or hyperbranched ionomeric polymer is present in the formulation at an amount of from about 0.01 wt % to about 10 wt % of total solids content.

16. The catalyst ink formulation of claim 11, wherein the linear ionomeric polymer is a linear sulfonated phenylated poly(phenylene) biphenyl (sPPB-H⁺) ionomer, a random copolymer comprising sPPB-H⁺ and a hydrophobic unit, a PFSA material, or a combination thereof.

17. The catalyst ink formulation of claim 11, wherein the amount of the linear ionomeric polymer is about equal to or greater than the amount of the branched or hyperbranched ionomeric polymer.

18. The catalyst ink formulation of claim 11, wherein the formulation comprises an amount of branched or hyperbranched ionomeric polymer, and an amount of linear ionomeric polymer, wherein the total amount of the branched, hyperbranched, and linear ionomeric polymer dispersed in the polar solvent is from about 0.1% w/v to about 25% w/v.

19. The catalyst ink formulation of claim 11, wherein the catalyst is Pt/C, PtCo/C, M-N—C catalyst, or a combination thereof.

20. The catalyst ink formulation of claim 11, comprising a catalyst amount of between about 0.1% w/v to about 25% w/v.

21. An ionomeric polymer membrane comprising:
a mechanical reinforcement; and
an ionomeric binder coupled to the mechanical reinforcement, wherein the ionomeric binder comprises:
a linear ionomeric polymer,
a branched or a hyperbranched ionomeric polymer according to claim 1,
or a combination thereof.

22. A catalyst-coated ionomeric polymer membrane comprising:
the ionomeric polymer membrane of claim 21; and
a catalyst layer in contact with the ionomeric polymer membrane.

23. The catalyst-coated ionomeric polymer membrane of claim 22, wherein the catalyst layer is formed from a catalyst ink formulation comprising:
a branched or hyperbranched ionomeric polymer, comprising a repeating unit of Formula (I);
a linear ionomeric polymer;
a polar solvent; and
a catalyst,
wherein the linear ionomeric polymer is dispersed in the polar solvent, and an amount of the linear ionomeric polymer is used which enables the branched or hyperbranched ionomeric polymer to disperse in the polar solvent, and
wherein Formula (I) has the structure: 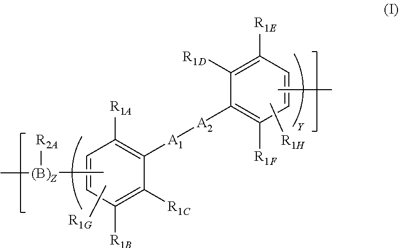
comprising an anionic comonomer and a branching comonomer (B),
wherein:
R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation;
A₁ is arylene, heteroarylene, aralkylene, or heteroaralkylene, each optionally substituted with 1, 2, 3, or 4 substituents independently selected from halo, nitro, cyano, aryl, and heteroaryl; and
A₂ is absent, arylene, or heteroarylene, wherein said arylene and heteroarylene are each optionally substituted with 1, 2, 3, or 4 substituents independently selected from halo, nitro, cyano, aryl, and heteroaryl;
B is a branching comonomer; and
R_{2A} is a bond, and
wherein a first repeating unit of Formula (I) is bound to a second repeating unit of Formula (I) at R_{2A} to form a branched structure.

24. The catalyst-coated ionomeric polymer membrane of claim 22, wherein the catalyst layer comprises Pt/C, PtCo/C, M-N—C catalyst, or a combination thereof.

25. The catalyst-coated ionomeric polymer membrane of claim 22, wherein the ionomeric polymer membrane has a top surface and a bottom surface, and wherein the catalyst layer is in contact with only the ionomeric polymer top surface, only the ionomeric polymer bottom surface, or both the ionomeric polymer top surface and the bottom surface,
wherein when the catalyst layer is in contact with only the top surface or only the bottom surface of the ionomeric polymer membrane, a bi-layer is formed, and
wherein when the catalyst layer is in contact with both the top surface and the bottom surface of the ionomeric polymer membrane, a tri-layer is formed.

26. The catalyst-coated ionomeric polymer membrane of claim 25, wherein the catalyst layer of the top surface of the ionomeric polymer membrane and the catalyst layer of the bottom surface of the ionomeric polymer membrane are either an anode or a cathode,
wherein when only one surface of the ionomeric polymer is in contact with the catalyst layer, the catalyst layer is either an anode or a cathode, and
wherein when both surfaces of the ionomeric polymer are in contact with the catalyst layer, one catalyst layer is an anode and the other catalyst layer is a cathode.

27. The ionomeric polymer membrane of claim 21, wherein the mechanical reinforcement comprises a porous polymeric material.

28. The ionomeric polymer membrane of claim 21, wherein the linear ionomeric polymer of the ionomeric binder is a linear sulfonated phenylated poly(phenylene) biphenyl (sPPB-H⁺) ionomer, a random copolymer comprising sPPB-H⁺ and a hydrophobic unit, a PFSA material, or a combination thereof.

29. The catalyst-coated ionomeric polymer membrane of claim 22, wherein the catalyst layer comprises an ionomeric polymer, and wherein the ionomeric polymer comprises:
a linear ionomeric polymer;
a branched or hyperbranched ionomeric polymer comprising a repeating unit of Formula (I);
or a combination thereof,
wherein Formula (I) has the structure: 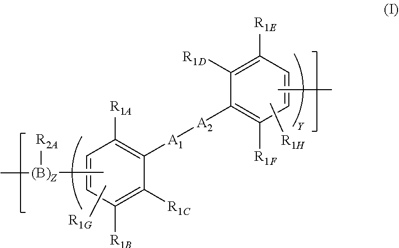
comprising an anionic comonomer and a branching comonomer (B),
wherein:
R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation;
A₁ is arylene, heteroarylene, aralkylene, or heteroaralkylene, each optionally substituted with 1, 2, 3, or 4 substituents independently selected from halo, nitro, cyano, aryl, and heteroaryl; and
A₂ is absent, arylene, or heteroarylene, wherein said arylene and heteroarylene are each optionally substituted with 1, 2, 3, or 4 substituents independently selected from halo, nitro, cyano, aryl, and heteroaryl;
B is a branching comonomer; and
R_{2A} is a bond, and
wherein a first repeating unit of Formula (I) is bound to a second repeating unit of Formula (I) at R_{2A} to form a branched structure.

30. The catalyst-coated ionomeric polymer membrane of claim 29, wherein:
the branched or hyperbranched ionomeric polymer of the catalyst layer is present in an amount of from about 0.5 wt % to about 25 wt % of the weight of the catalyst layer; and
the linear ionomeric polymer of the catalyst layer is present in an amount of about equal to or greater than the amount of the branched or hyperbranched ionomeric polymer of the catalyst layer.

31. The ionomeric polymer membrane of claim 22, wherein the mechanical reinforcement, the ionomeric binder, and the catalyst layer are essentially free of halogens.

32. A method for synthesizing a branched or hyperbranched ionomeric polymer, the method comprising:
polymerizing Zₘ moles of a functionalized branching comonomer (B) with Yₘ moles of a functionalized anionic comonomer by a Diels-Alder addition reaction,
wherein:
the functionalized branching comonomer (B) is a dienophile;
the functionalized anionic comonomer is a diene; and
a molar ratio of Zₘ:Yₘ is greater than 0.2.

33. The method of claim 32, wherein the molar ratio of Zₘ:Yₘ is approximately 0.67.

34. The method of claim 32, wherein the functionalized branching comonomer (B) has a structure according to Formula (V): 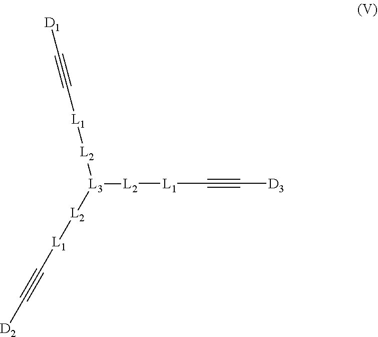
wherein:
L₃ at each occurrence, is an optionally substituted multivalent heteroatom (e.g., N, P, B), multivalent aryl, multivalent heteroaryl, multivalent aralkyl, or multivalent heteroaralkyl, wherein said multivalent aryl, multivalent heteroaryl, multivalent aralkyl, and multivalent heteroaralkyl are each optionally substituted with 1, 2, or 3 substituents independently selected from C₁₋₆ alkyl, halo, nitro, cyano, aryl, and heteroaryl;
L₂ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl;
L₁ is absent, arylene, or heteroarylene, wherein said arylene and heteroarylene are each optionally substituted with 1, 2, 3, or 4 substituents independently selected from C₁₋₆ alkyl, halo, nitro, cyano, aryl, and heteroaryl; and
D₁, D₂, and D₃ are independently H, R_{1G}, R_{1H}, R_{3G}, R_{3H}, or a protecting group (e.g., silyl protecting group, substituted silyl protecting group, trialkylsilyl protecting group, silyl ether protecting group, trialkyl silyl ether protecting group, trimethyl silyl ether),
wherein R_{1G} and R_{1H} are independently H, aryl, or heteroaryl, wherein said aryl and heteroaryl are each optionally substituted with 1, 2, 3, 4, or 5 substituents independently selected from C₁₋₆ alkyl, halo, nitro, cyano, SO₃⁻X⁺, PO₃²⁻X⁺₂, and COO⁻X⁺, wherein X⁺ is H⁺ or a cation, and
wherein R_{3G} and R_{3H} are independently alkyl, aryl, or aralkyl.

35. The method of claim 32, wherein the functionalized branching comonomer (B) has a structure according to Formula (VIII):

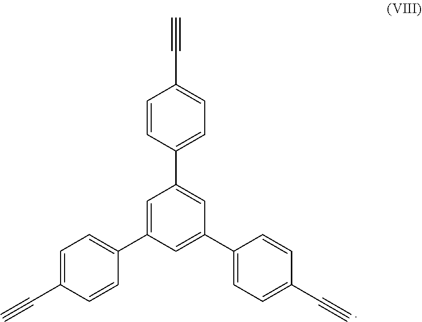 [SMILES: C#Cc1ccc(-c2cc(-c3ccc(C#C)cc3)cc(-c3ccc(C#C)cc3)c2)cc1]

36. The method of claim 32, wherein the functionalized anionic comonomer has a structure according to Formula (VI): 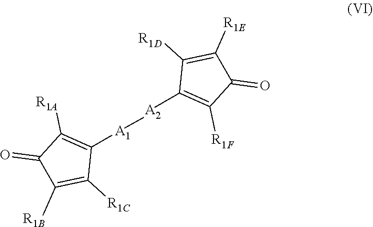
wherein:
R_{1A}, R_{1B}, R_{1C}, R_{1D}, R_{1E}, and R_{1F} are independently aryl or heteroaryl, each optionally substituted with 1, 2, 3, 4, or 5 substituents independently selected from C₁₋₆ alkyl, halo, SO₃⁻X⁺, PO₃²⁻X⁺₂, and COO⁻X⁺, wherein X⁺ is H⁺ or a cation, and provided that at least two of R_{1A}, R_{1B}, R_{1C}, R_{1D}, R_{1E}, and R_{1F} are independently aryl or heteroaryl substituted with 1, 2, 3, 4, or 5 substituents independently selected from SO₃⁻X⁺, PO₃²⁻X⁺₂, and COO⁻X⁺, wherein X⁺ is H⁺ or a cation;
A₁ is arylene, heteroarylene, aralkylene, or heteroaralkylene, each optionally substituted with 1, 2, 3, or 4 substituents independently selected from halo, nitro, cyano, aryl, and heteroaryl; and
A₂ is absent, arylene, or heteroarylene, wherein said arylene and heteroarylene are each optionally substituted with 1, 2, 3, or 4 substituents independently selected from halo, nitro, cyano, aryl, and heteroaryl.

37. The method of claim 32, wherein the functionalized anionic comonomer is:

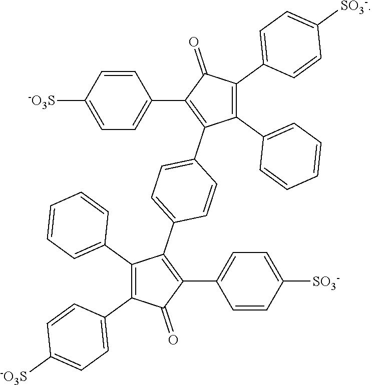

38. The catalyst-coated ionomeric polymer membrane of claim 22, wherein the mechanical reinforcement comprises a porous polymeric material.

39. The catalyst-coated ionomeric polymer membrane of claim 22, wherein the linear ionomeric polymer of the ionomeric binder is a linear sulfonated phenylated poly(phenylene) biphenyl (sPPB-H⁺) ionomer, a random copolymer comprising sPPB-H⁺ and a hydrophobic unit, a PFSA material, or a combination thereof.
